(19) United States
(12) Patent Application Publication
(10) Pub. No.: US 2008/0003553 A1
(43) Pub. Date: Jan. 3, 2008

(54) Cognitive learning video game

(76) Inventors: Roger Stark, Chicago, IL (US); Tony Gibbens, Greenwood, IN (US); Donald Helms, Naperville, IL (US); Peter Kline, Wheaton, MD (US); Malcolm Neumeyer, West Lafayette, IN (US); Ken Scales, Indianapolis, IN (US); Gary Vogal, Belleville, IL (US)

Correspondence Address: Paul E Schaafsma;NovusIP, LLC, Suite 221, 521 West Superior Street, Chicago, IL, 60610-3135, US

(21) Appl. No.: 11/453,048

(22) Filed: Jun. 14, 2006

(51) Int. Cl. G09B 19/00

(52) U.S. Cl. 434/236

(57) ABSTRACT

In accordance with the principles of the present invention, a video game is provided having multimedia graphics in an interactive interface. The video game is a cognitive development program made up of a sequence of challenges that address a range of cognitive strengths and weaknesses to provide appropriate levels of challenge and intensity whereby the ability of the mind to assimilate and process information quickly and accurately is enhanced. Hierarchical nature human learning is utilized, with the challenges progressing from simpler to more complex neurological processes. The cognitive skills that are developed include cognitive attention skills, cognitive visual processing skills, cognitive sensory integration skills, cognitive auditory processing skills, cognitive memory skills, and cognitive thinking skills.

### FIELD OF THE INVENTION

The present invention relates to computer learning.

### BACKGROUND OF THE INVENTION

When skills that an individual brings to learning are deficient, these deficiencies must be addressed in order for other tactics to be effective. Often underlying learning skills are not addressed, unless they are specifically diagnosed in a clinical environment. Even when deficits in underlying learning skills are diagnosed, treatment is frequently insufficient. Prior art help for individuals with learning challenges has typically focused on one of four methods: sensory therapy, motor therapy, psychotherapy, and academic remediation. Sensory therapy includes specific vision and auditory therapy. Motor therapy is typified by the Work of speech pathologies and occupational therapists. Psychotherapy attempts to address the problem via motivation rather than treatment of specific learning difficulties. Academic remediation includes remedial reading, learning disabled programs, and tutoring. While each of these methods may be effective in correcting or alleviating a specific sensory, motor or academic problem, these methods generally do not address the underlying skills that support the ability to take in, process, understand, and apply information.

One problem is that cognitive skills are not accessible to teaching because they operate below the level of consciousness, so that they are either automatically present or not present at all. When used herein, the term “cognitive skills” refers to the basic mental skills that enable learning. The ability to perform intellectually and professionally in large part is determined by the strength or weakness of these underlying skills—skills such as thinking, logic and reasoning, memory, visualization and comprehension, etc. Short- and long-term memory, attention, thinking, pattern recognition, planning, reasoning, and making decisions quickly are examples of cognitive skills. These cognitive skills enable us effectively to take in, process, understand, and apply information in the world around us—whether in school, driving a car, following a recipe or preparing taxes.

Unlike thinking and memory skills, cognitive skills are not normally open to revision as a result of choices made by the learner. They are part of the hardware of the brain, rather than part of its software. Thus, cognitive skills are not taught in school. Rather, education focuses on what can be referred to as “closed systems” of learning. An algebra book provides an example of such a closed system. A student is instructed to do the problems in the book. If the student makes mistakes, that is because the student was either careless or does not remember the process or processes that were supposed to have been learned that will guide the student through the particular problem. Almost all education of a pragmatic nature presents closed systems to the learner.

In an open system, the learner can make choices about the development of the subject itself. Such systems are implied in methods like accelerated learning, inquiry learning, project learning, and other forms of learning in which learners are free to initiate aspects of the learning process itself. These methods resemble the methods children use while in the nursery to initiate their own learning about the world they are trying to navigate. They also operate in the assimilation of the native language and the development of a basic repertory of kinesthetic and negotiation skills.

Closed systems produce competent performers in a given field who can operate with expertise within that field, but are often completely unable to look beyond the parameters within which they operate. Open systems produce learners who may have to fill in competency blanks in their performance in certain areas, because they have not specifically learned the systems or operations connected with those areas, but who are nevertheless free to explore other fields of knowledge, modifications in the paradigms of their expertise, and even initiate the openings of new paradigms.

Prior art education uses closed systems and expects students to perform in ways that replicated one another. This was appropriate for areas of expertise that were developing relatively slowly. With the information explosion of the twenty-first century such forms of education are increasingly a liability instead of an asset. As new ways of doing things replace old ways, as whole new fields of knowledge open up rapidly, and as people jump around not just in jobs, but even in careers, open field education becomes more crucial—particularly as access to automated computer assisted learning devices can quickly bring people up to speed on particular areas that may function best as closed systems.

What is thus needed is a method to address the underlying skills that support the ability to take in, process, understand, and apply information. The method should provide an enjoyable and entertaining experience. The method should be comprehensive, affordable, and accessible.

### SUMMARY OF THE INVENTION

A cognitive learning video game in accordance with the principles of the present invention addresses the underlying skills that support the ability to take in, process, understand, and apply information. A cognitive learning video game in accordance with the principles of the present invention provides an enjoyable and entertaining experience. A cognitive learning video game in accordance with the principles of the present invention is comprehensive, affordable, and accessible.

In accordance with the principles of the present invention, a video game is provided having multimedia graphics in an interactive interface. The video game is a cognitive development program made up of a sequence of challenges that address a range of cognitive strengths and weaknesses to provide appropriate levels of challenge and intensity whereby the ability of the mind to assimilate and process information quickly and accurately is enhanced. The system of the present invention responds to the hierarchical nature of human learning, with the challenges progressing from simpler to more complex neurological processes. The cognitive skills that are developed include cognitive attention skills, cognitive visual processing skills, cognitive sensory integration skills, cognitive auditory processing skills, cognitive memory skills, and cognitive thinking skills.

### BRIEF DESCRIPTION OF THE DRAWINGS

FIG. 1 shows a graphical model of the mental processing model that is the bases for the cognitive learning video game of the present invention.

FIG. 2 is a non-limiting example of a hardware infrastructure that can be used to run the cognitive learning video game of the present invention.

FIG. 3 shows a log-in screen for the cognitive learning video game of the present invention.

FIG. 4 shows a homepage for the cognitive learning video game of the present invention.

FIG. 5 shows a character selection page for the cognitive learning video game of the present invention.

FIG. 6 shows a “Billy Bear” character of the character selection page of FIG. 5.

FIG. 7 shows a “Jackie Jaguar” character of the character selection page of FIG. 5.

FIG. 8 shows a character choice confirmation page of the character selection page of FIG. 5.

FIG. 9 shows the progressive growth stages of the “Jackie Jaguar” character of FIG. 7.

FIG. 10 shows a second view of the homepage of FIG. 4.

FIG. 11 shows a play screen for the cognitive learning video game of the present invention.

FIGS. 12-19 show the “Web Weaving” themed cognitive exercise for the cognitive learning video game of the present invention.

FIGS. 21-25 show the “Tree Tic Tac Toe” themed cognitive exercise for the cognitive learning video game of the present invention.

FIGS. 27-32 show the “Whispering Waterfall” themed cognitive exercise for the cognitive learning video game of the present invention.

FIG. 33 shows the homepage of FIG. 4 updated for the number of levels the user has completed.

FIG. 34 shows the scoring information pop-up of FIG. 33.

FIGS. 35-40 show the “Arrow Point Bridge” themed cognitive exercise for the cognitive learning video game of the present invention.

FIGS. 41-43 show the “Memory Mountain” themed cognitive exercise for the cognitive learning video game of the present invention.

FIGS. 44 and 45 show the “Sky Planning” themed cognitive exercise for the cognitive learning video game of the present invention.

FIGS. 46 and 47 show the “Bear Shuffle” themed cognitive exercise for the cognitive learning video game of the present invention.

Referring to FIGS. 48-51 show the “Jumping Jaguar Flash” themed cognitive exercise for the cognitive learning video game of the present invention.

FIGS. 52-55 show the “Turtle Recall” themed cognitive exercise for the cognitive learning video game of the present invention.

FIGS. 56-61 show the “Llama Logic” themed cognitive exercise for the cognitive learning video game of the present invention.

FIGS. 62-66 show the “Crocodile Recollection” themed cognitive exercise for the cognitive learning video game of the present invention.

FIGS. 67-70 show the “Piranha Pass” themed cognitive exercise for the cognitive learning video game of the present invention.

FIGS. 71-73 show the “Cave Comparisons” themed cognitive exercise for the cognitive learning video game of the present invention.

FIGS. 74-78 show the “Slithering Symbols” themed cognitive exercise for the cognitive learning video game of the present invention.

FIGS. 79 and 80 show the “Rhythm Ribbet” themed cognitive exercise for the cognitive learning video game of the present invention.

FIGS. 81 and 82 show the “Parroting Colors” themed cognitive exercise for the cognitive learning video game of the present invention.

FIGS. 83-86 show the “Jungle Labyrinth” themed cognitive exercise for the cognitive learning video game of the present invention.

FIGS. 87-90 show the “Iguana Lookout” themed cognitive exercise for the cognitive learning video game of the present invention.

FIGS. 91-95 show the “Volcanic Patterns” themed cognitive exercise for the cognitive learning video game of the present invention.

FIGS. 96-101 show the “Ancient Logic and Reasoning” themed cognitive exercise for the cognitive learning video game of the present invention.

FIG. 102 shows a log-in screen for an alternative embodiment of the cognitive learning video game of the present invention.

FIG. 103 shows a homepage for an alternative embodiment of the cognitive learning video game of the present invention.

FIG. 104 shows the drop-down menu of FIG. 103.

FIG. 105 shows the scoring information pop-up of FIG. 103.

### DETAILED DESCRIPTION OF THE PREFERRED EMBODIMENTS

In accordance with the principles of the present invention, a cognitive learning video game is provided. The cognitive learning video game of the present invention embodies the following scientific principles:
An individual's learning ability is not genetically predetermined in the way that physical attributes like red hair or blue eyes are determined. While learning ability is guided by an individual's genetic code, learning ability arises in significant part through the process of development.
The plasticity of the brain is greater in children, but the brain exhibits the ability to change and develop throughout life.
Human learning is hierarchical. Skills build in a learning pyramid, in which basic skills provide an underpinning for more advanced skills.
Processing skills are highly integrated in effective brain functioning.
The brain can only perform one skill consciously at a time. When multiple cognitive skills are required, as in most learning situations, all but one have to be performed automatically, at the subconscious level.
Visual processing, visualization, and visual thinking (spatial-temporal reasoning) are vital in learning and thinking.

Stimulation is an important factor in motivating attention and meaningful participation in a learning activity.
Immediate feedback is necessary to enable error correction, and faster, more accurate learning.
Sequenced challenges that address the range of each individual's strengths and weaknesses are required to provide the appropriate levels of challenge and intensity.
Success and self-confidence are vital parts of the feedback loop that increase desire and effort.

Thus, the cognitive learning video game of the present invention embodies the belief that exercising the brain enhances the ability to assimilate and process information more quickly and accurately. The cognitive learning video game of the present invention provides a methodology to achieve improvement within a short time frame.

Based on pioneering research performed in the late 1940's by Dr. Donald Hebb of McGill University (Hebb, “The Organization of Behavior,” Lawrence Erlbaum Associates (2002)), scientists know that human learning follows a hierarchical nature, starting with the simplest of neurological processes. Skills build in a learning pyramid, in which basic skills fan out to more advanced skills. If any fundamental skills are missing or are deficient, higher level skills cannot develop. Learning is a complex process; however, by evaluating mental skills, the real cause of a person's learning difficulties can be determined and those skills needing improvement can be pinpointed to make learning easier and faster.

A report of the Educational Resources Information Clearinghouse on Assessment and Evaluation summarizes this conclusion:
. . . fine-grained cognitive analysis can be used beneficently to uncover individual differences in the information processing profiles of students (e.g. Carpenter, Just & Shell, [“What One Intelligence Test Measures: A Theoretical Account of the Processing in the Raven Progressive matrices Test,” Psychological Review, 97(3) pp. 404-431] 1990). A clear and important implication of this work is that such analyses will eventually lead to dramatic improvement in our ability to assess an individual's current level of intellectual functioning and to prescribe instructional interventions that will maximize each individual's potential.

### Current Issues in Research on Intelligence, ERIC/AE Digest, April 1994.

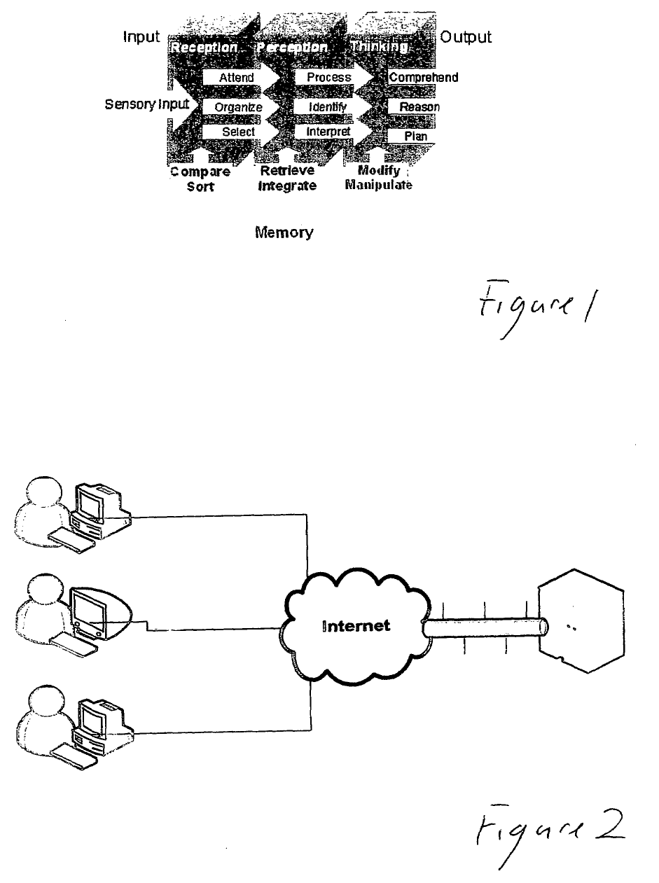

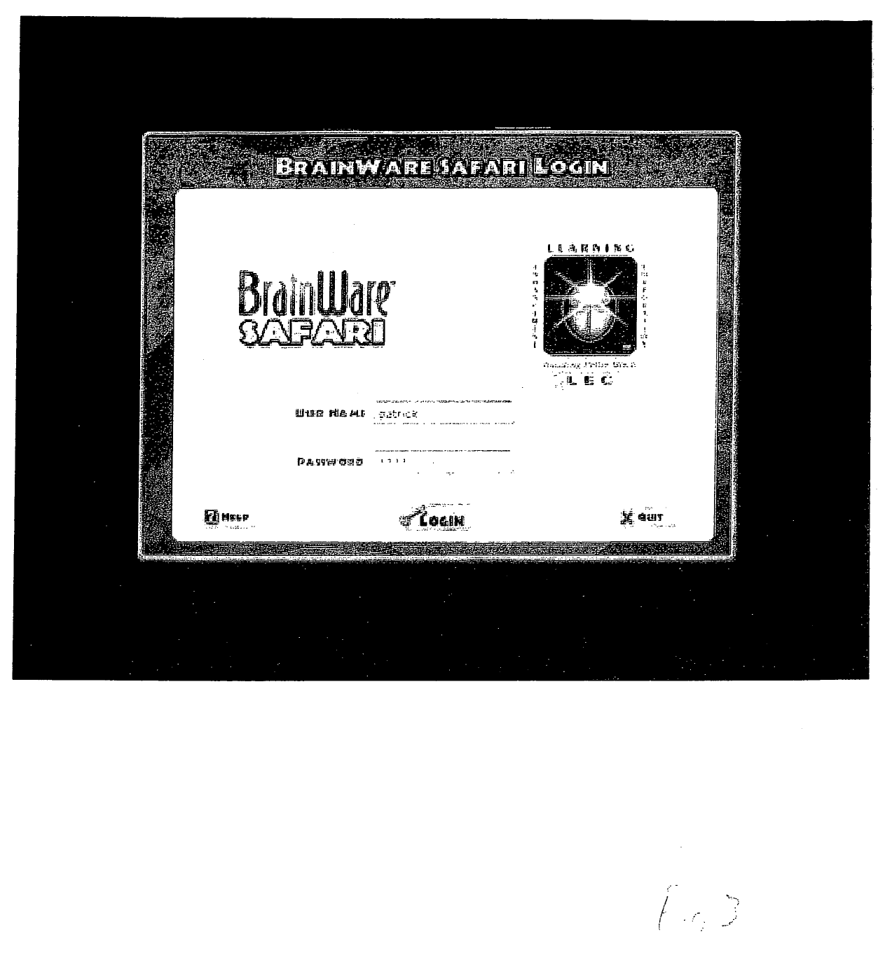

The level and quality of the ability of an individual to acquire knowledge, solve problems, communicate, and carry out appropriate actions can be captured in a model of learning skills as such learning skills contribute to mental performance. Referring to FIG. 1, a graphic of the mental processing model that forms a basis for the cognitive learning video game of the present invention is seen. The three categories of mental processing are reception, processing, and thinking. These categories integrate and depend on each other. In order to start the sequence of mental processing, appropriate information is attended to, identified, and selected. The information is then compared and sorted (processed) to accomplish non-thinking tasks quickly. Finally, information is manipulated and applied in thinking and remembering, mental processes that are not automatic.

Thinking skills are built in layers that combine new demands with past experiences and depend on basic cognitive skills. Enhancing the cognitive skills that drive each of the three categories of mental performance leads to a higher level and quality of knowledge acquisition, the ability to perceive relationships, and even creativity. Improving the underlying learning skills can improve not only the ability and motivation to learn, resulting in improved enjoyment of school or work, but can also enhance self-esteem, lower stress, and ameliorate behavior and performance problems.

Most individuals have the attitude that “I am what I am, and basically nothing can ever change that. To the extent that I am brilliant I will have to demonstrate that all the time or I may turn out to be nothing and worthless.” This is because most individual's experiences persuade them that it is true. They are unlikely to have had many experiences of struggling with something until they mastered it. Therefore, they develop a relatively passive attitude towards life, and when they get into positions of power they tend to bully other people rather than nurture them.

The present invention helps set up the user to change their mindset from “I am what I am, and basically nothing can ever change that” to the mindset “I am capable of becoming anything I really want to become and achieving anything I really want to achieve. All I have to do is stick at it and work hard enough and learn what I need to learn, and I can do it.” The present invention does this by constantly confronting the user with problems that seem too hard at first, but that can eventually be solved. The present invention does so partly by prompting the user with comments like, “Good for you, you did that!” or “Keep trying, you'll get it eventually.” The use of an animated character that grows up as the user progresses through the program reinforces the idea that learning is a growth process.

While there are numerous self esteem building programs in the prior art and other tools for becoming better able to control the process of study, none of them provide the impact that the present invention provides in demonstrating to the student that success is possible if you stick at it long enough and keep working to overcome the barriers that you will, in fact, overcome.

The cognitive learning video game of the present invention provides for scientifically based and clinically grounded methodologies combined with multimedia graphics, characters, and sound into an interactive software program. The cognitive learning video game of the present invention presents a fun and challenging video game format that provides motivation and feedback to drive the development of mental capacity.

Cognitive skills are the basis for the ability to learn, but they are not taught in school. Well-developed cognitive skills are essential to perform well academically or in a work environment because they are necessary for higher-order thinking and knowledge acquisition. Underdeveloped cognitive skills get in the way of processing information and learning. When cognitive skills are deficient, learning is impaired—sometimes seriously so. Improving mental skills helps raise learning potential, leading to gains in intelligence, self-esteem, and the ability to learn subjects like math and reading.

Every individual has some cognitive skills that are strong and some that are weaker. The cognitive learning video game of the present invention is designed to strengthen weak skills and enhance those that are already strong. The cognitive learning video game of the present invention focuses on, but the present invention is not limited to, 41 of these cognitive skills that have proven to have the greatest impact on learning and performance in the shortest period of time.

For example, reading is a complex neurological task. Reading decoding, fluency, focus, comprehension, and retention depend on the fundamental cognitive skills. The cognitive learning video game of the present invention develops and integrates the skills necessary to identify information instantaneously, retrieve information from memory, and link the information with what is currently being learned so comprehension and thinking processes can be improved. The same principles apply for math and other higher thinking skills.

The 41 of these cognitive skills that have proven to have the greatest impact on learning and performance in the shortest period of time comprise visual sustained attention, auditory sustained attention, visual selective attention, auditory selective attention, flexible attention, and divided attention cognitive attention skills; visual discrimination, visual figure ground, visual form consistency, directionality, visual span, visual simultaneous processing, visual sequential processing, visualization, and visual processing speed cognitive visual processing skills; ocular-motor, visual-motor integration, auditory-motor integration, timing-rhythm, visual-auditory integration cognitive sensory integration skills; auditory discrimination, auditory sequential processing, and auditory processing speed cognitive auditory processing skills; visual sensory short-term memory, auditory sensory short-term memory, visual intermediate short-term memory, auditory intermediate short-term memory, working memory, visual spatial memory, long term memory, visual sequential memory, auditory sequential memory, and visual simultaneous memory cognitive memory skills; and logic, reasoning, planning, problem solving, strategic thinking, visual thinking, conceptual thinking, and decision speed cognitive thinking skills.

Of these cognitive skills that have proven to have the greatest impact on learning and performance in the shortest period of time, particular focus is placed upon visual sustained attention, visual selective attention, flexible attention, and divided attention cognitive attention skills; visual discrimination, visual simultaneous processing, visualization, and visual processing speed cognitive visual processing skills; auditory-motor integration and timing-rhythm cognitive sensory integration skills; visual sensory short-term memory, visual intermediate short-term memory, working memory, visual spatial memory, and visual simultaneous memory cognitive memory skills; and visual thinking cognitive thinking skills.

Though the cognitive learning video game of the present invention is designed to look much like a video game, it is, in reality, a form of digital game-based learning. Each exercise has multiple levels that become progressively more challenging as the player advances through the cognitive learning video game. The graphics and software provide an enjoyable and entertaining experience for the player; however, the cognitive learning video game of the present invention is more than a video game. The cognitive learning video game of the present invention is a mental fitness program that helps the player develop his or her cognitive skills. Unlike video games, the cognitive learning video game of the present invention is founded in science and rooted in years of clinical experience.

The present invention differs from most computer games and most textbooks in that the present invention does not have a set pathway. The user may start with any exercise and move to any other one at choice and at random. The layering process occurs regardless, but it occurs differently for each user. Since there is an almost infinite number of possible sequences for doing the present invention it is almost certain that each individual will progress through it differently. The way the brain layers the skills, and uses them to reinforce each other, will therefore be unique for each individual.

Because the developing skills influence each other in random ways, the particular flavor of intellect that develops as a result will vary from one person to another, much as genetic backgrounds and personalities vary; however, because the system of learning is open, not closed, the kind of thinking that is developed is open system. This means that the individual has a far wider range of resources for problem solving than before. Operating from self organizing paradigms in the brain, rather than per-ordered paradigms derived from textbooks, course outlines, and the accidents of individual teacher personality, the learner has a far wider access to new learning in the future.

The present invention accomplishes a free flow that comes from the establishment of a way of solving problems that is learner-initiated rather than imitative. This does not mean that the learner who benefits from the present invention is somehow less comfortable with closed systems; rather, it is likely that the closed system will at some point be transformed into an open system. That is, in the case of an algebra book, the learner will at some point intuit the organizing principles that underlie the particular sequence of problems learned, and will be able to “invent” applications or branches of algebra not directly found in the book.

This distinction is fundamentally different from the distinction between mechanical rote learning and the development of higher order thinking skills. Higher order thinking skills usually do not imply open systems. Higher order thinking skills imply the ability to manipulate abstractions, but not necessarily beyond the limits of the paradigms in which the abstractions were developed. Flexibility of thinking appears to come from the development of neural networks that cross-fertilize each other enough so that the learner becomes comfortable in moving abstractions or concepts from one field of knowledge to another, and using what has been learned in one field to build constructs in another field.

Scientific research has demonstrated that the development of neuron branches within the brain is increased by the practice of mental exercises. This branching effect results in the growth of millions of additional brain cell connections, effectively allowing a person to do more work, quickly, accurately, and efficiently. (Jensen, “Teaching with the Brain in Mind,” Association for Supervision and Curriculum Development, Alexandria, Va. (1988)). The use of targeted training methods can be used to improve efficiencies. The fastest and most efficient way to improve efficiencies is through mental training exercises that target deficient learning skills. A comprehensive approach to the basic skills should have the effect of maximizing an individual's learning potential:
More recently neuroscientists discovered that the environment—things like stimulating experiences or severe stress—affects the performance of genes in ways that can build a super-functioning brain . . . .

### (Kotulak, “Women Just Have Something Extra in their Makeup,” Chicago Tribune, (17 Apr. 2005)).

Surprisingly, it doesn't matter to the brain whether it ever comes up with an answer. The neural growth happens because of the process, not the solution.

### (Jensen). Unlike a video game, the measure of success with the cognitive learning video game of the present invention is not how many levels have been completed, but the intensity the player brings to use of the cognitive learning video game.

The methodology of the cognitive learning video game of the present invention recognizes that skills are interdependent and mutually reinforcing, so the cognitive learning video game of the present invention helps develop skills in concert, creating a well-balanced integrated learning system. Once an individual is equipped with a more efficient and effective learning system, he or she is better able to acquire knowledge at a faster pace. As learning performance gradually improves, so does self-confidence and self-esteem, which in turn can increase the individual's motivation, effort, aspirations and expectations.

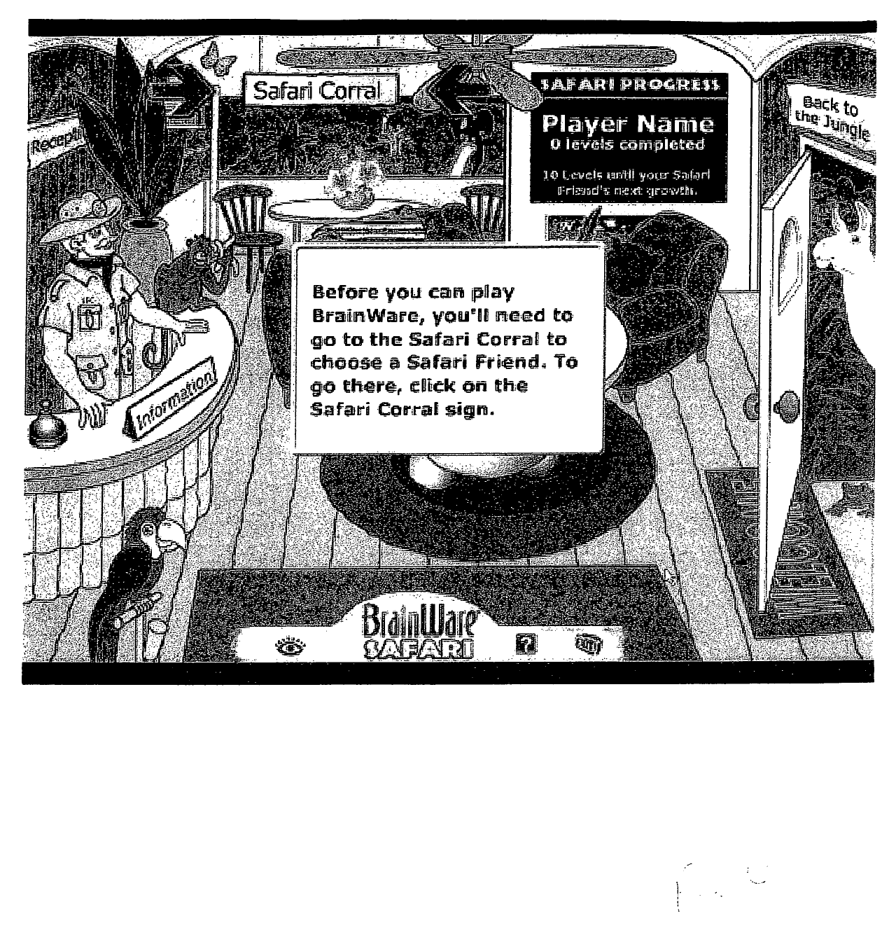

Referring to FIG. 2, a non-limiting example of a hardware infrastructure that can be used to run the cognitive learning video game of the present invention is seen. The infrastructure preferably can include but is not limited to: Internet connectivity; network infrastructure; a standard operating system; load balancer (optional if more than one WEB/APP server running the application); appropriate switches and routers; electrical power (backup power); network backup hardware and software. The cognitive learning video game of the present invention can run with and without the Secure Sockets Layer (SSL) protocol. The cognitive learning video game of the present invention can run on any standard WEB/APP Server and any standard database server.

The cognitive learning video game of the present invention also utilizes a user's personal computer. In one example embodiment, the cognitive learning video game of the present invention can be run on a PC having Windows 98 or higher (e.g., Windows2000 or WindowsXP) available from Microsoft Corporation, Redmond, Wash., the equivalent of a Pentium III processor available from Intel Corporation, 2200 Mission College Boulevard, Santa Clara, Calif. or higher, and a speed of 600 MHz or faster. If the cognitive learning video game of the present invention is run on an Apple computer available from Apple Computer, Inc., 1 Infinite Loop, Cupertino, Calif. 95014, in one example embodiment a MAC having the OSX operation system and a processing speed of 600 MHz or faster can be used. An Internet connection and computer speakers are also used.

While much of the cognitive learning video game functionality can reside on the user's computer, an Internet connection is used for login. Data on progress through the cognitive learning video game is collected through the Internet and stored on central databases. This blended approach and Internet management of the cognitive learning video game provides benefits for the user and allows central regulation of the access and data collection on an ongoing basis. If the computer crashes, a user's program data is not lost: once the computer is restored and the cognitive learning video game reloaded the user simply picks up where he or she left off—processed data is not lost. This approach also enables the user to access the cognitive learning video game and data from more than one computer, at virtually any place and any time.

The cognitive learning video game of the present invention can contain, but the present invention is not limited to 168 progressively challenging levels across an array of jungle-themed exercises with animated characters that grow up as the user progresses through the program. Scientists know that cognitive skills are interdependent. Being able to follow directions, for instance, requires listening skills, being able to understand the steps in sequence, being able to remember the information, and being focused enough to avoid careless errors, etc. Most of the themed cognitive exercises in the cognitive learning video game of the present invention tax multiple skills at once. This creates a well-balanced integrated learning system.

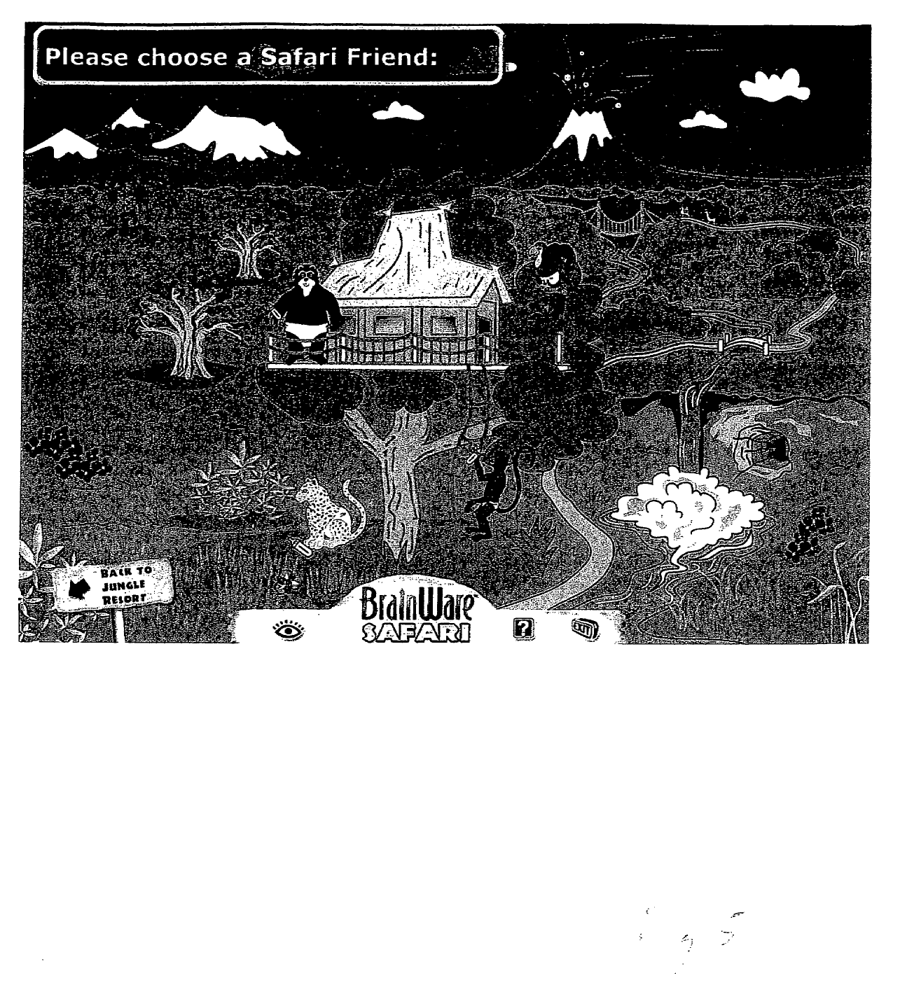

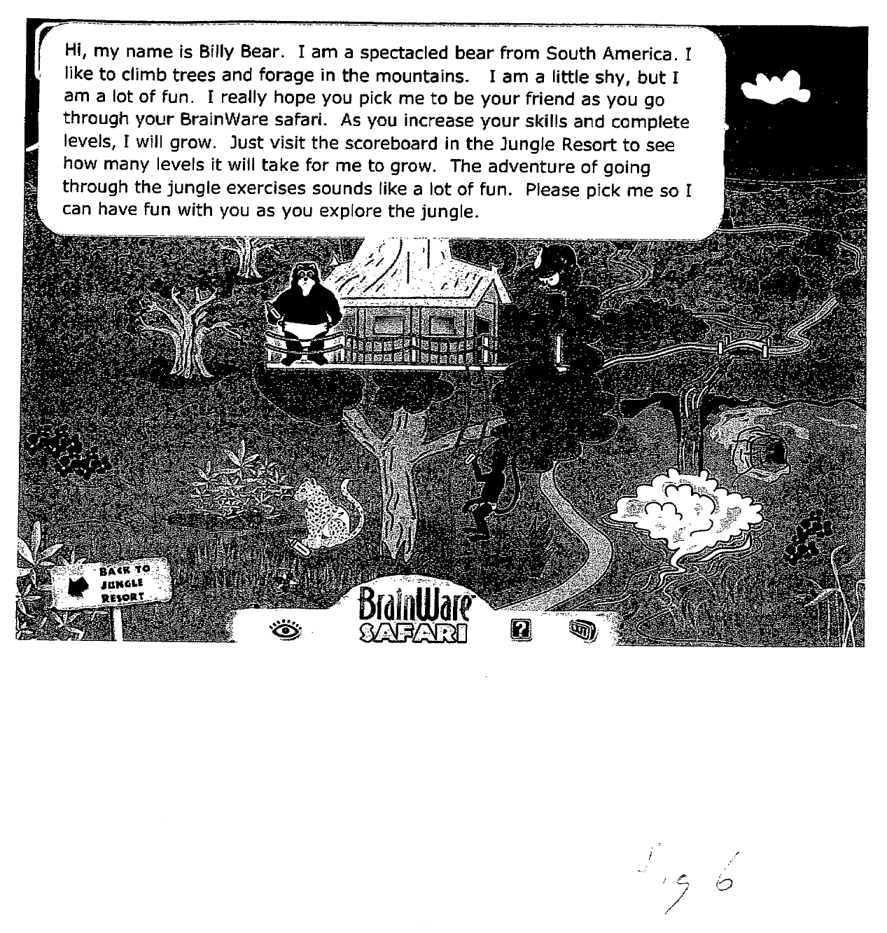

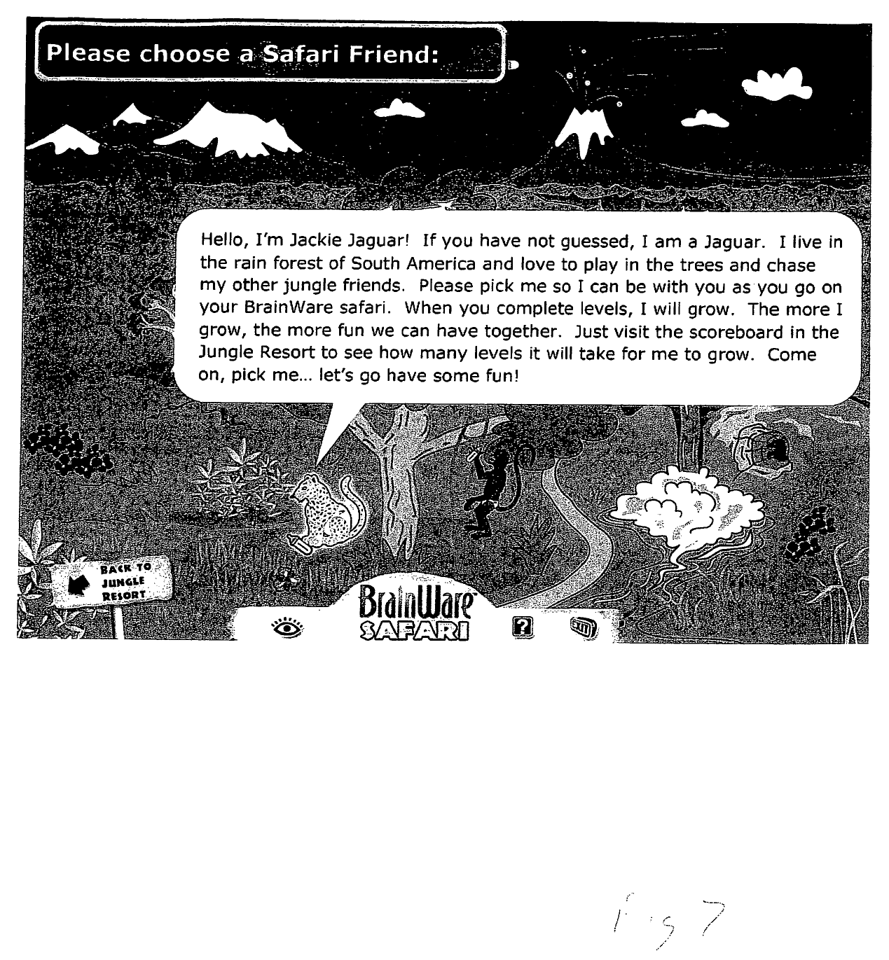

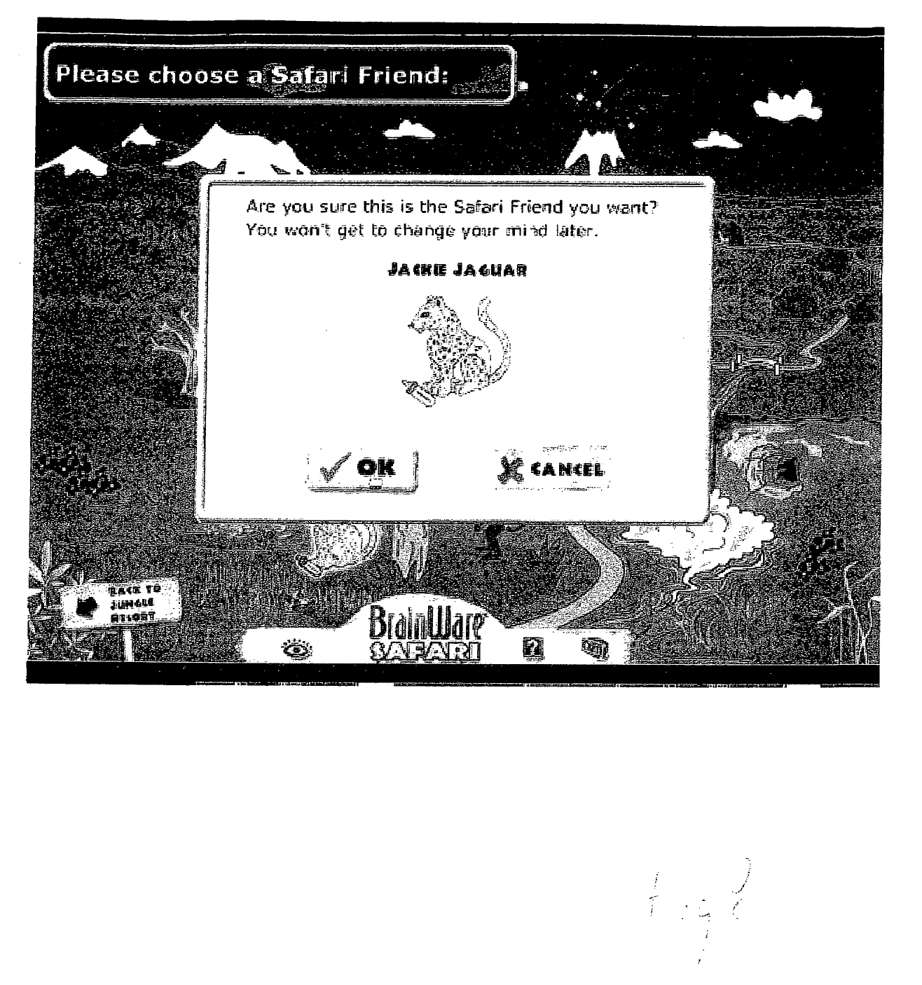

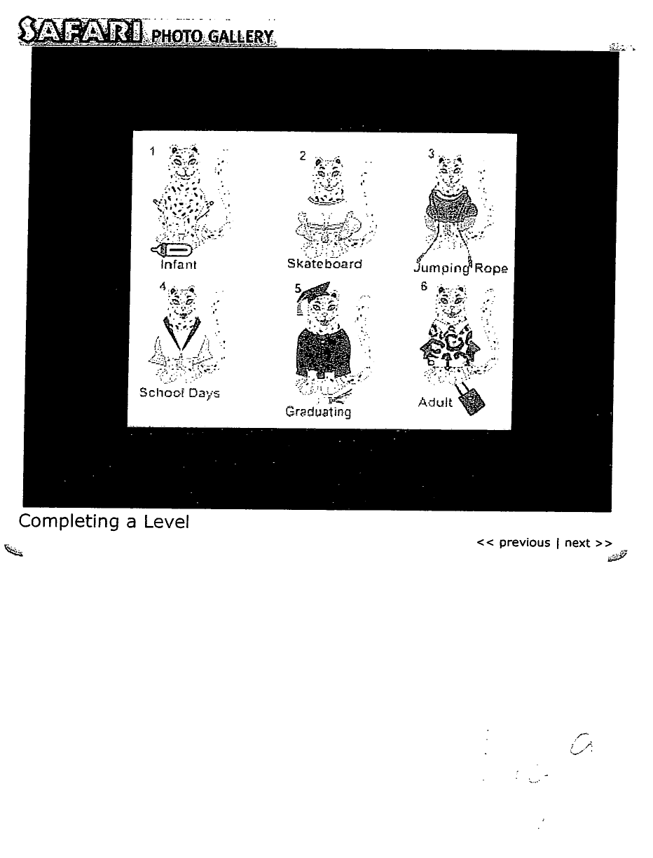

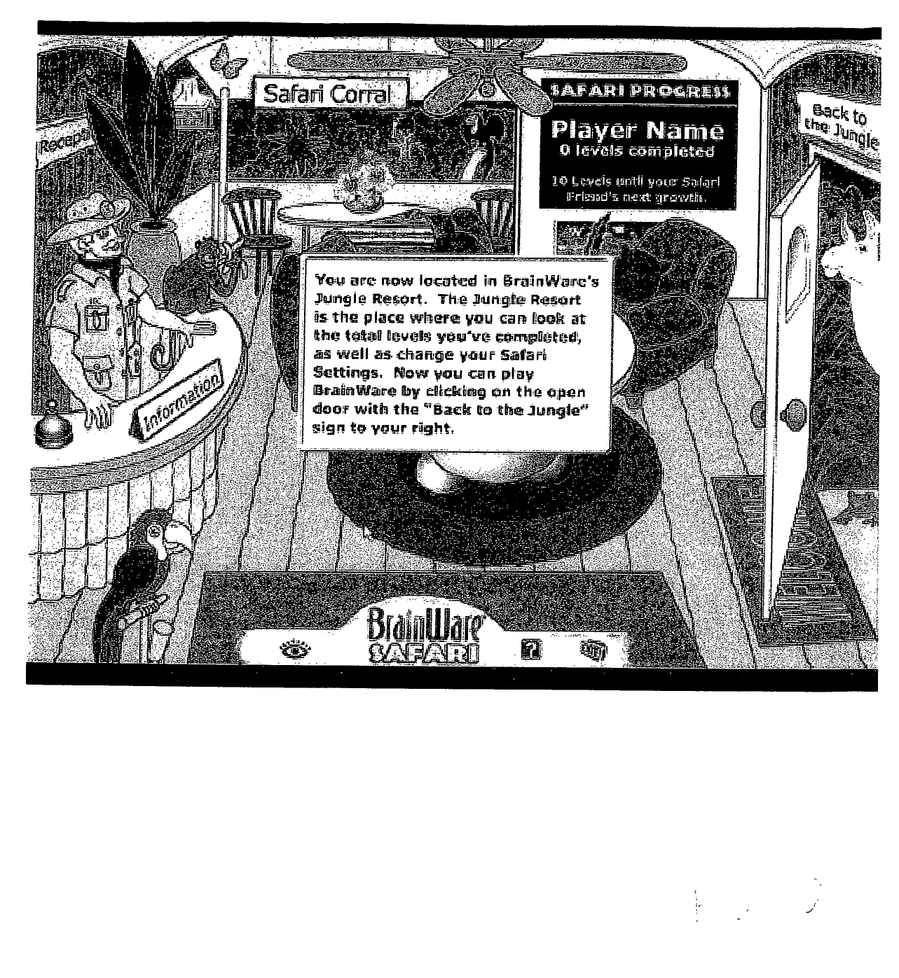

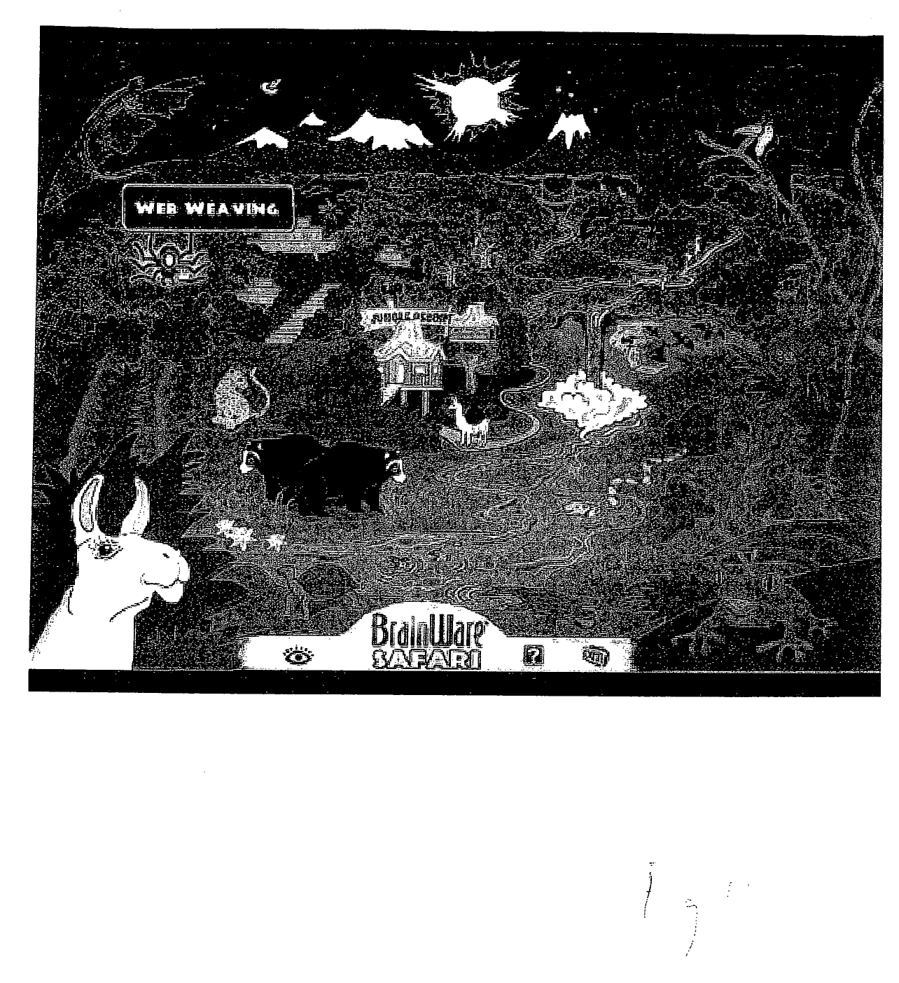

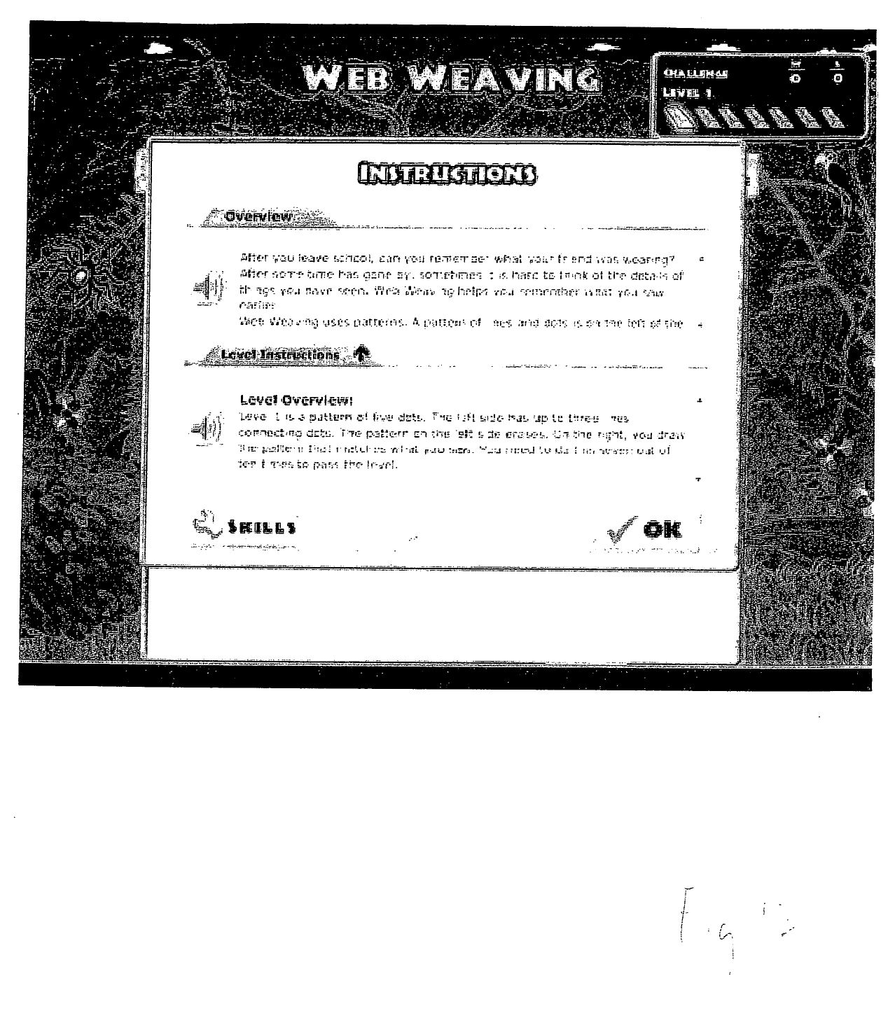

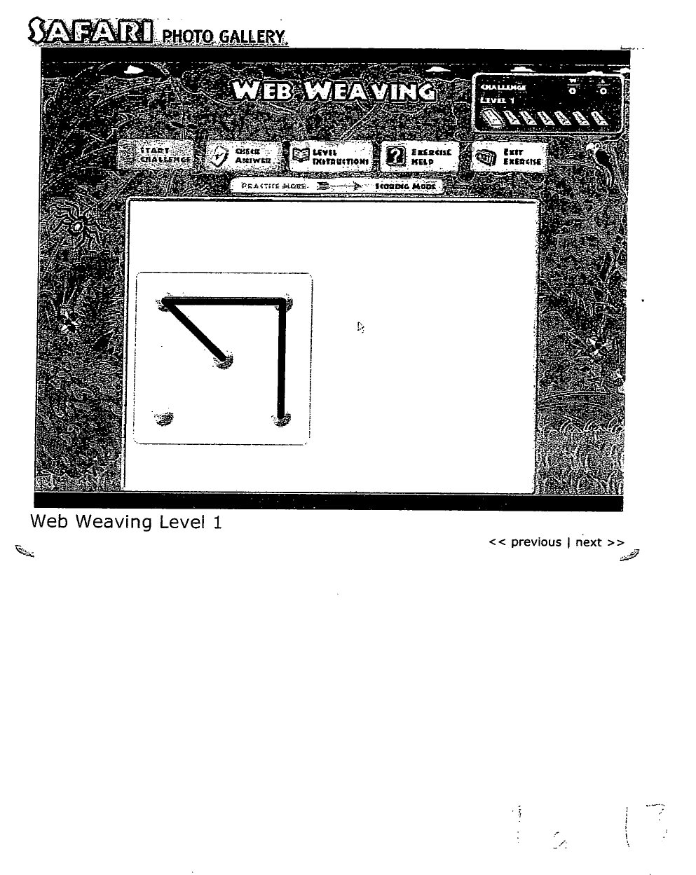

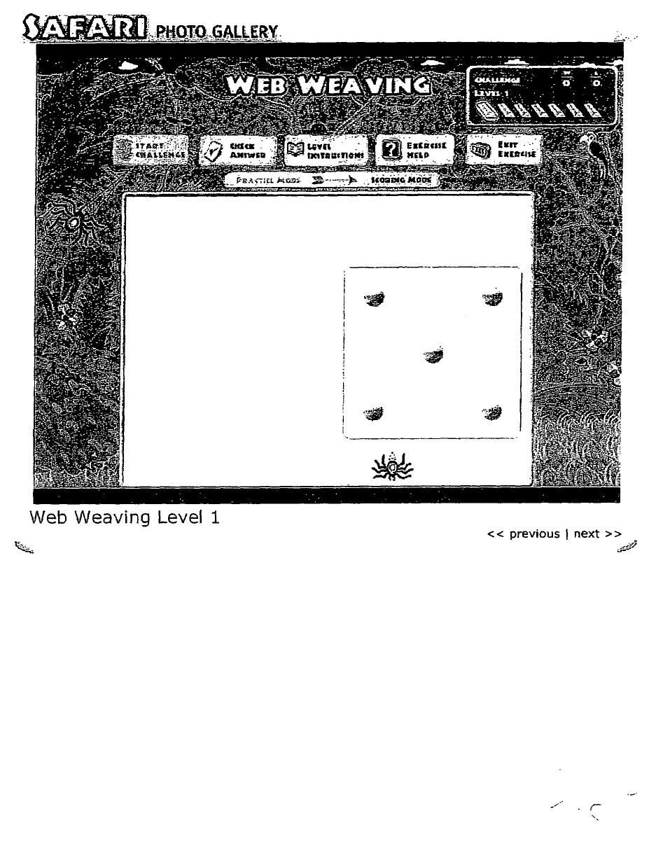

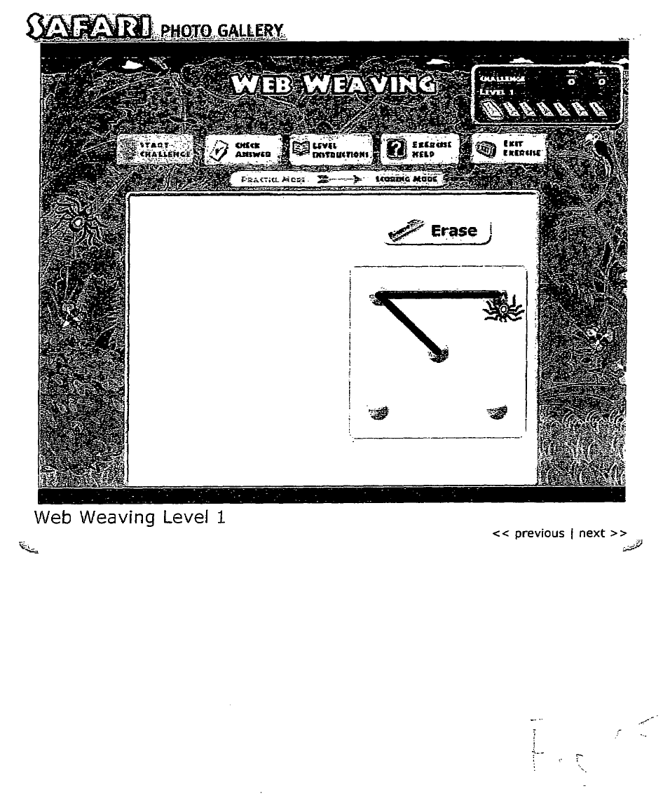

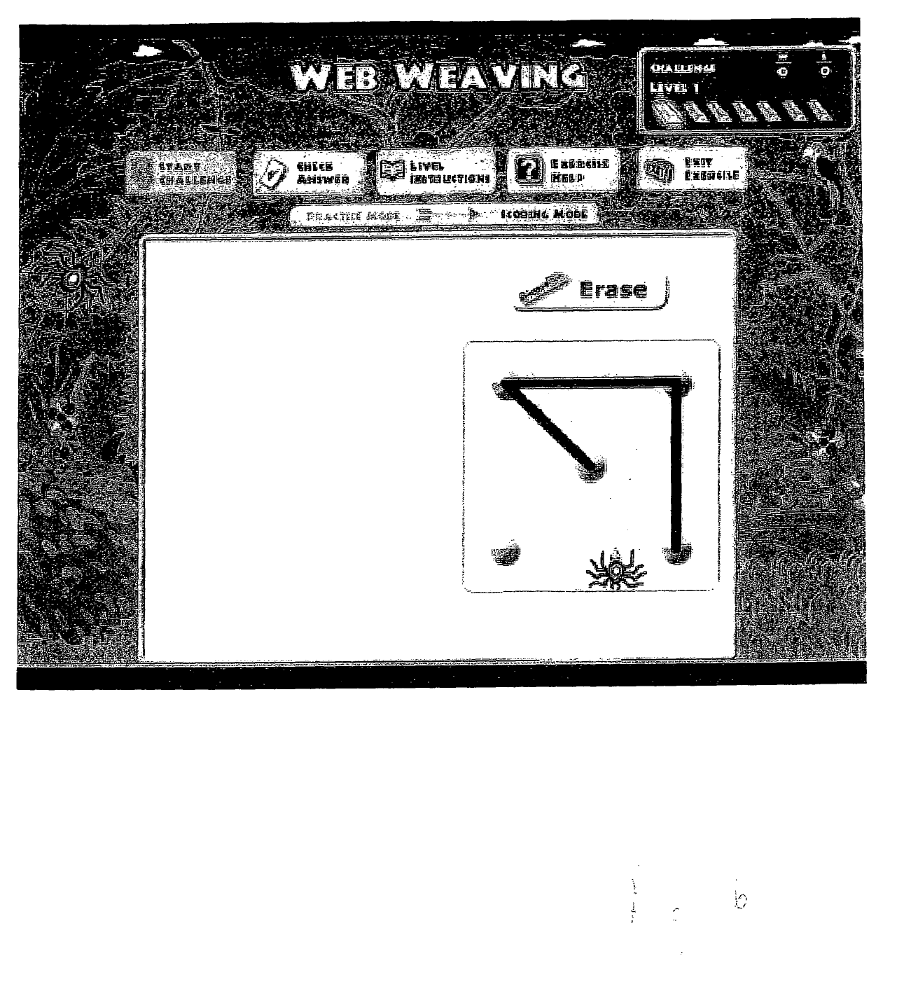

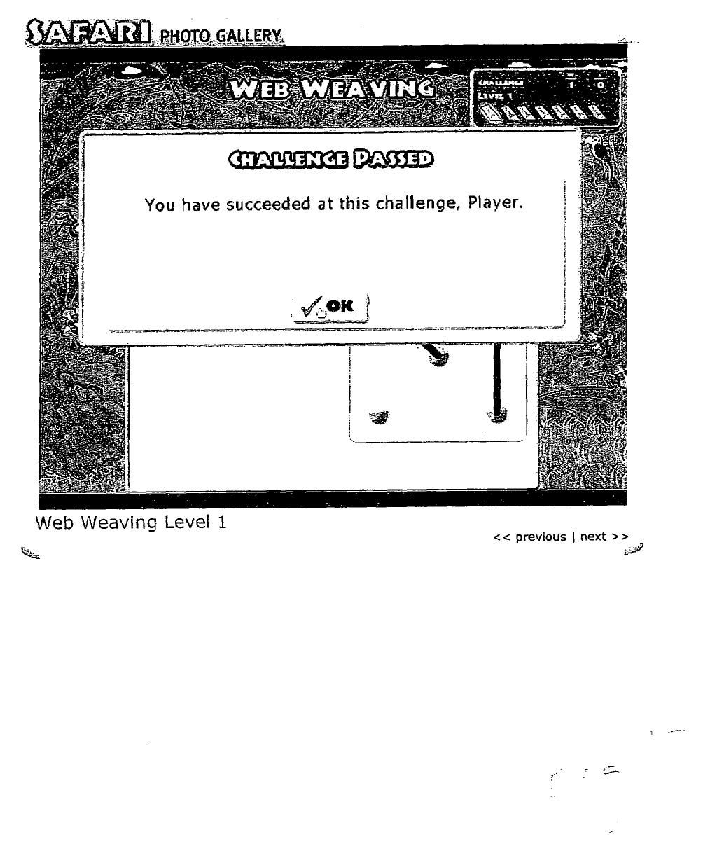

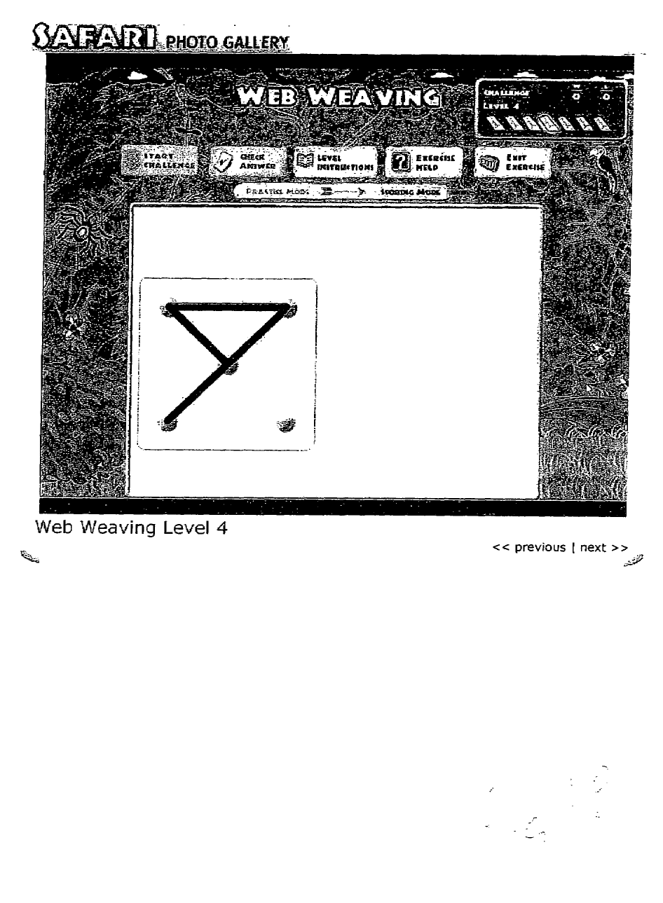

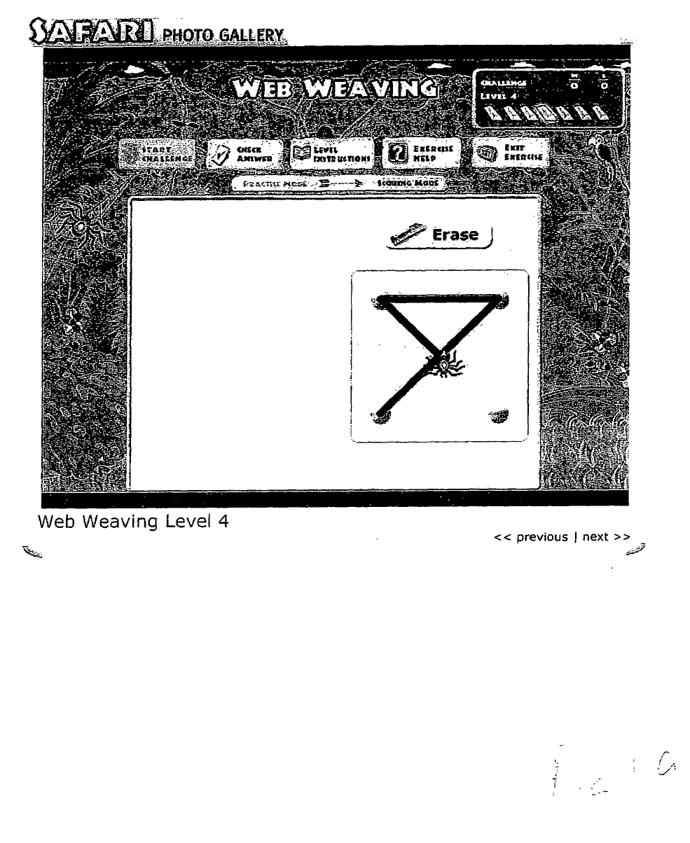

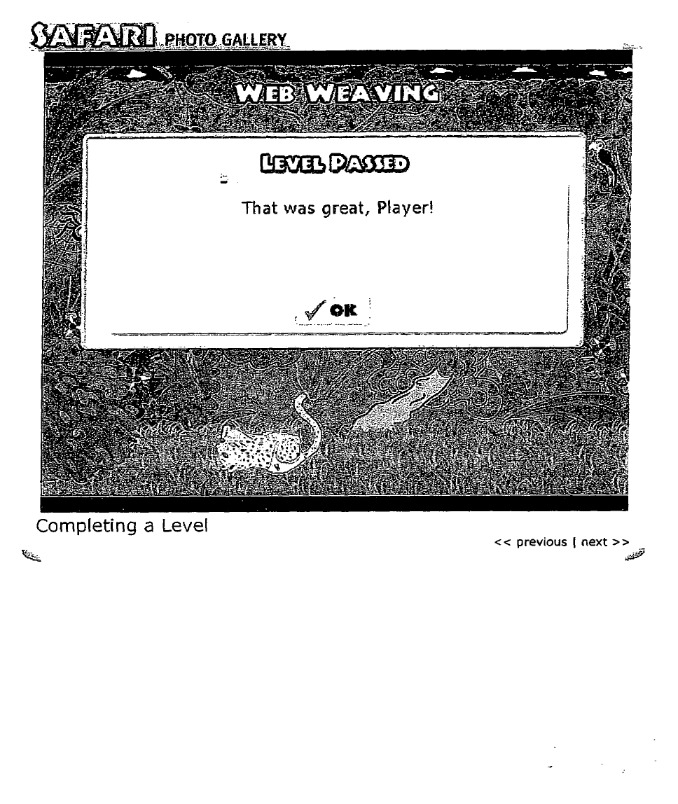

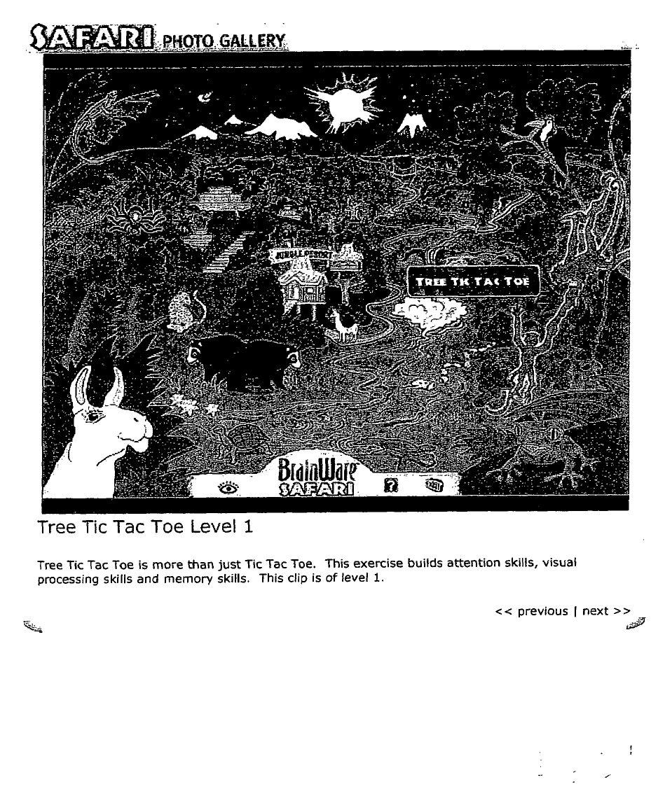

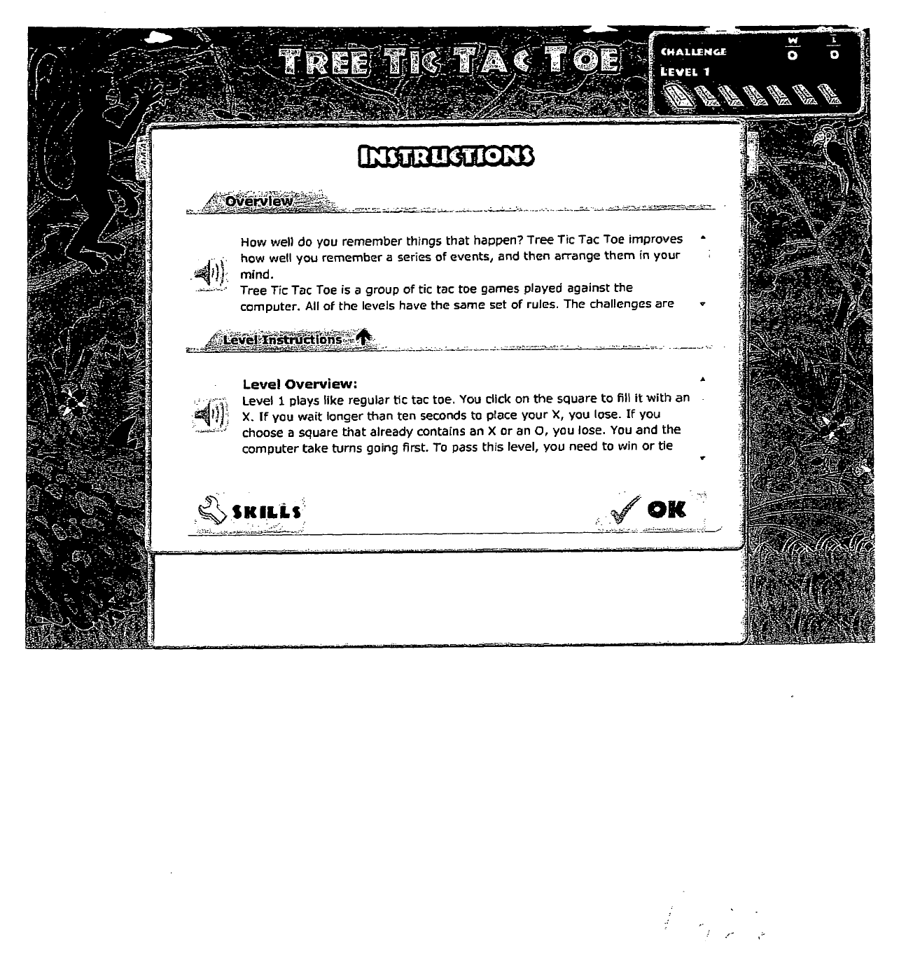

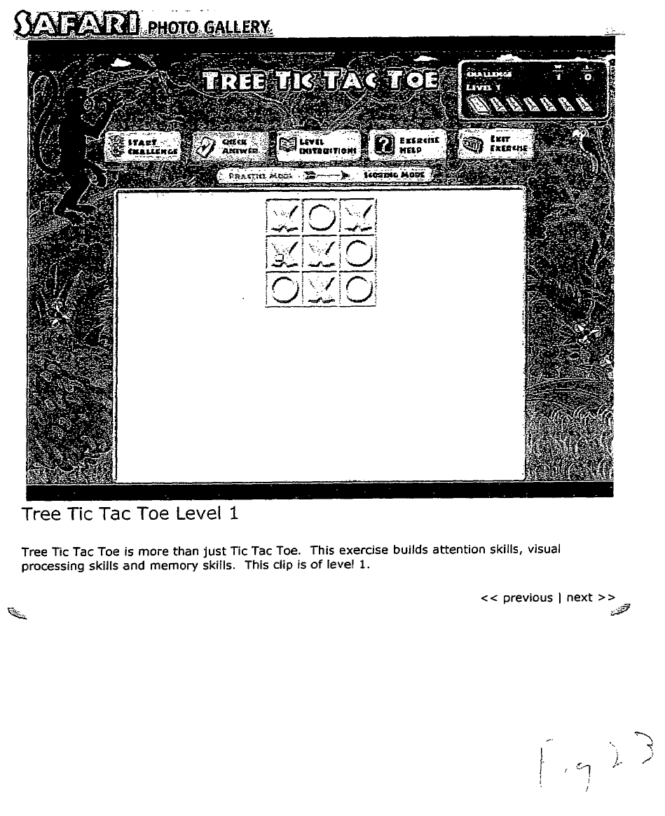

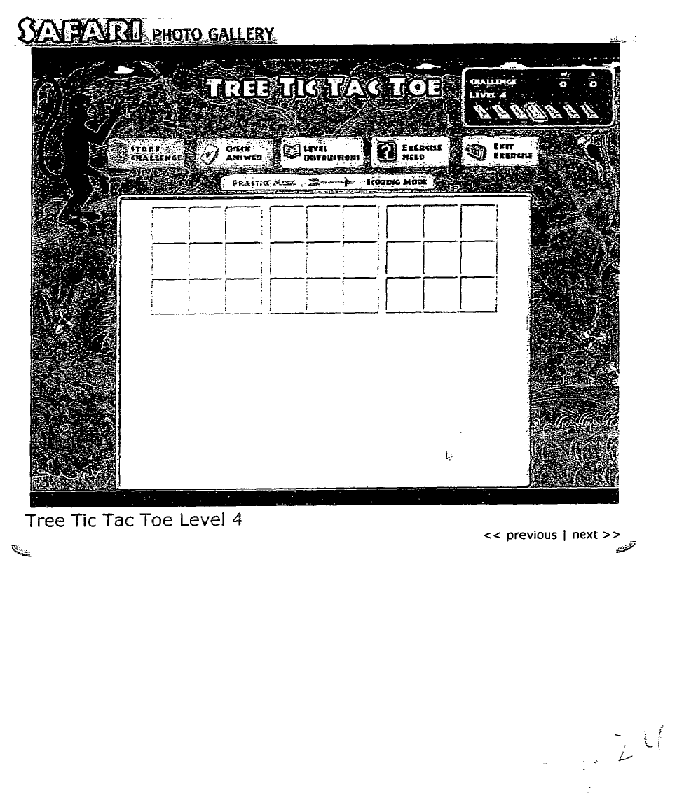

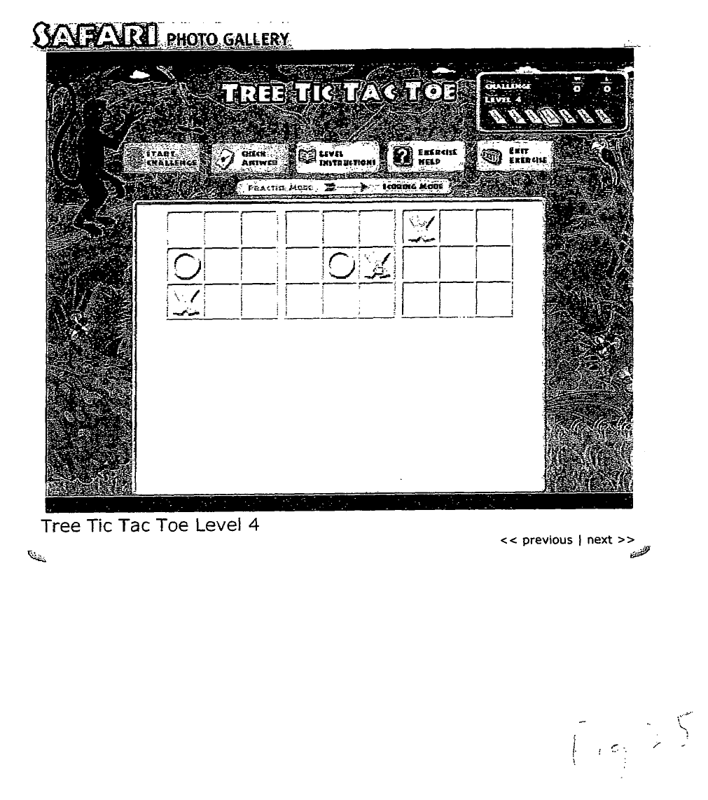

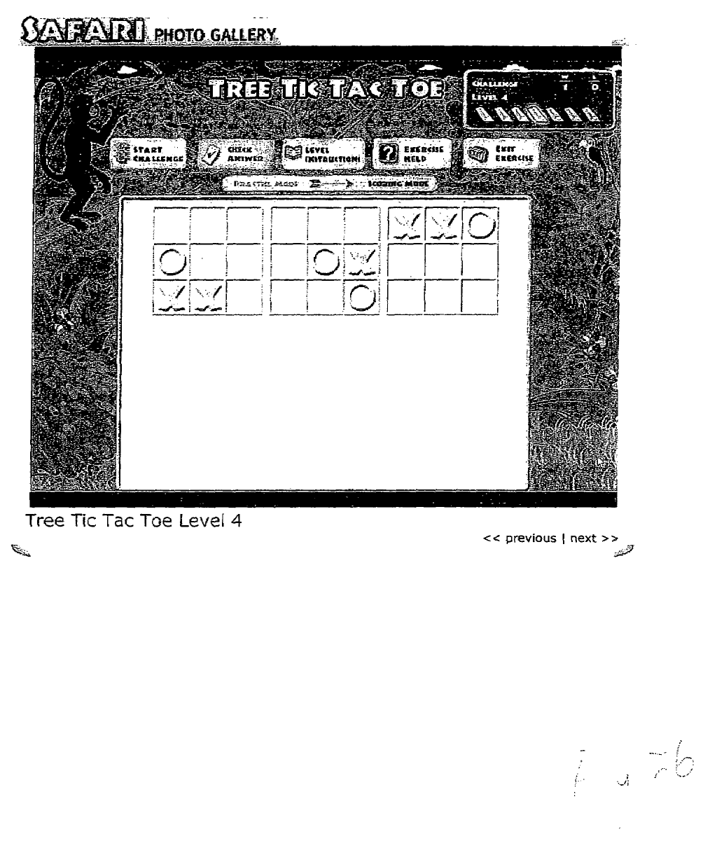

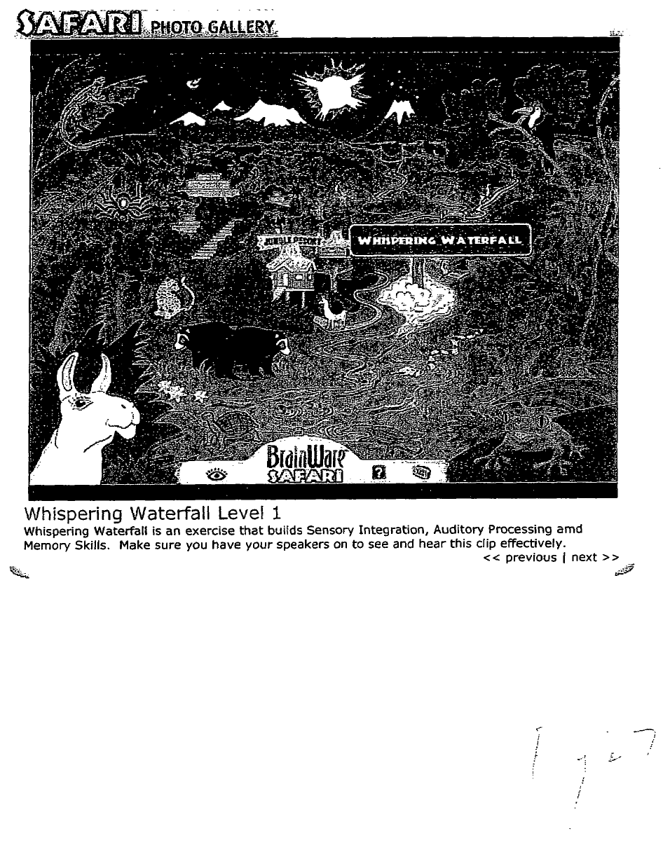

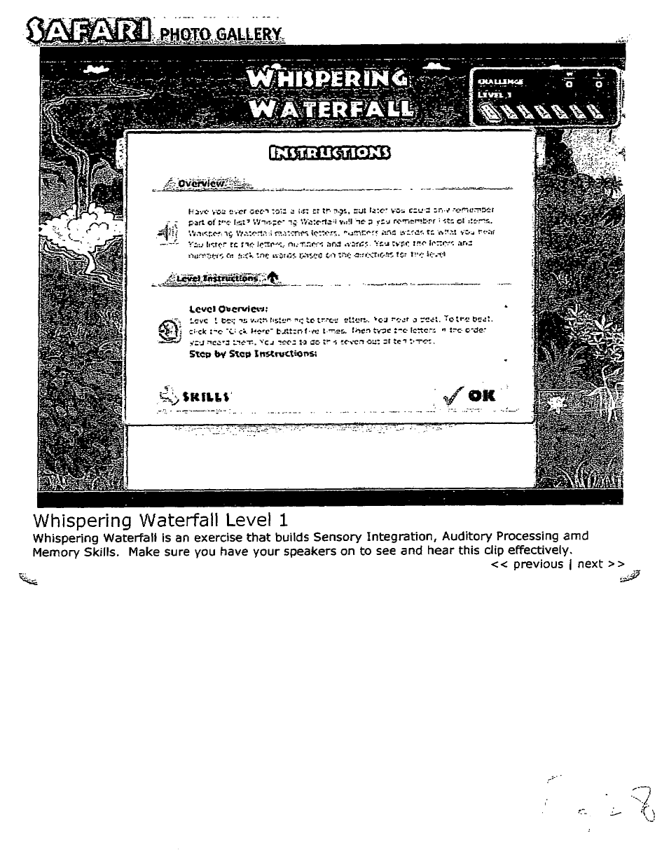

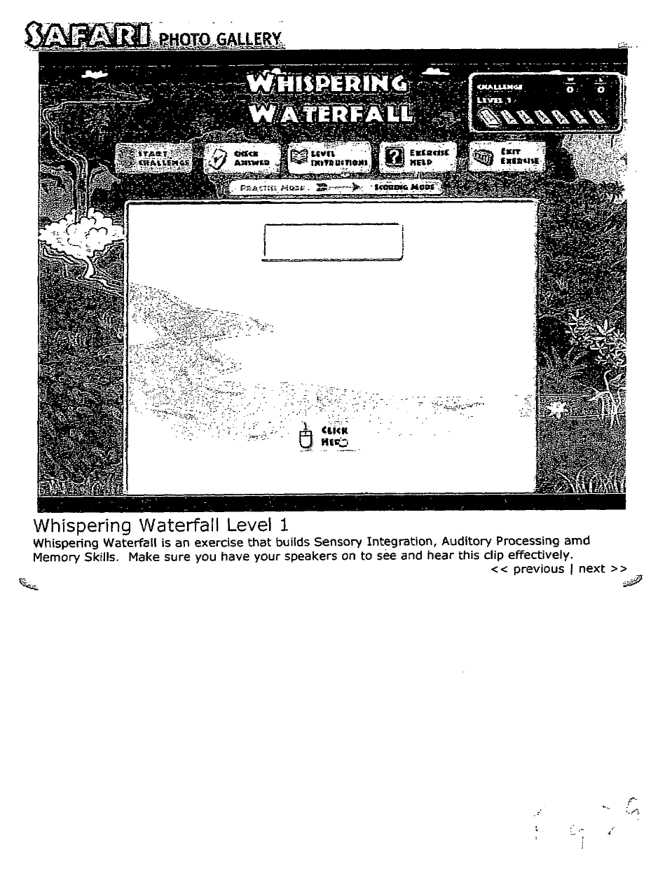

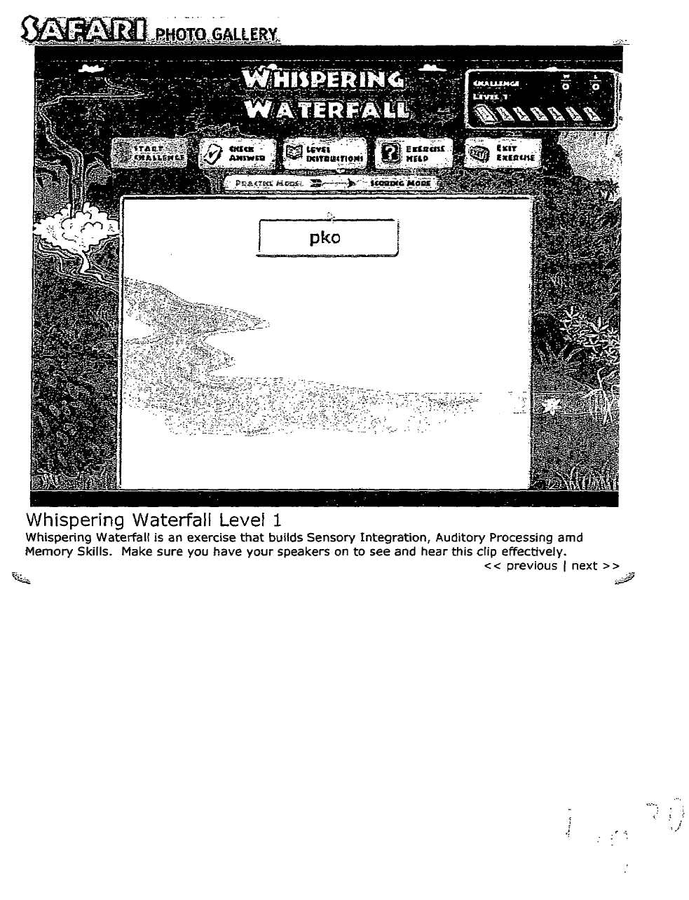

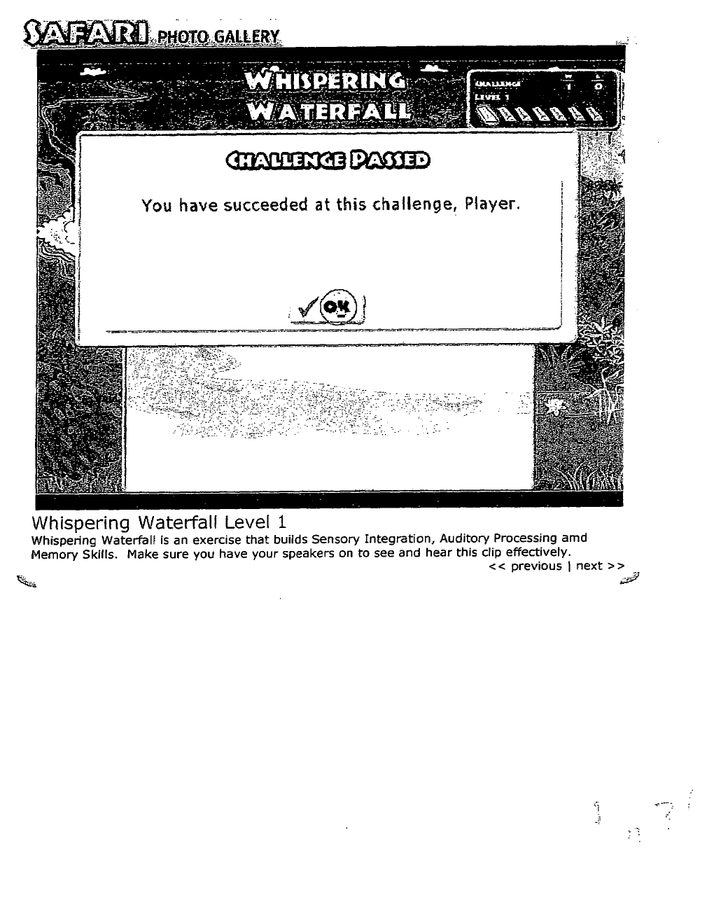

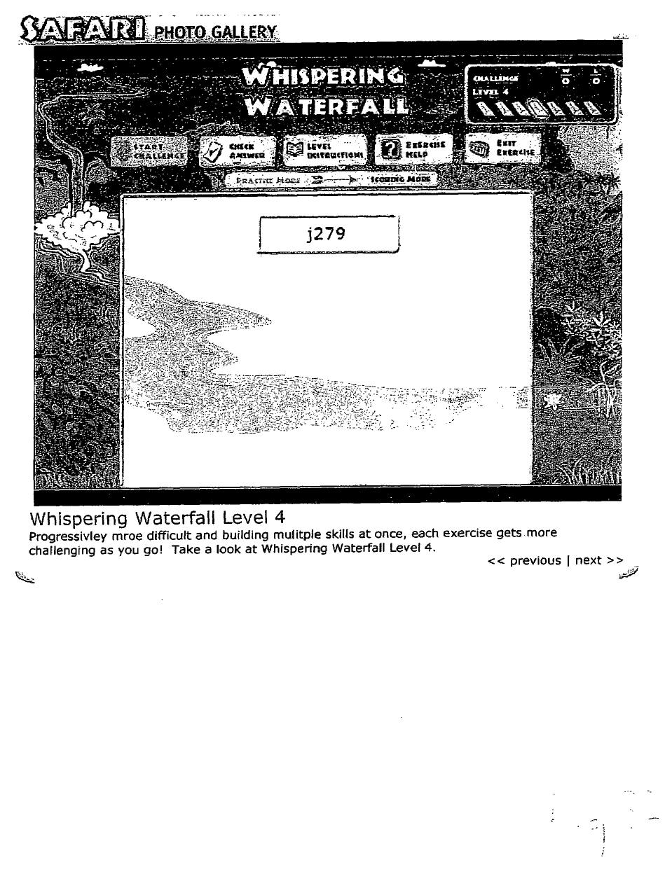

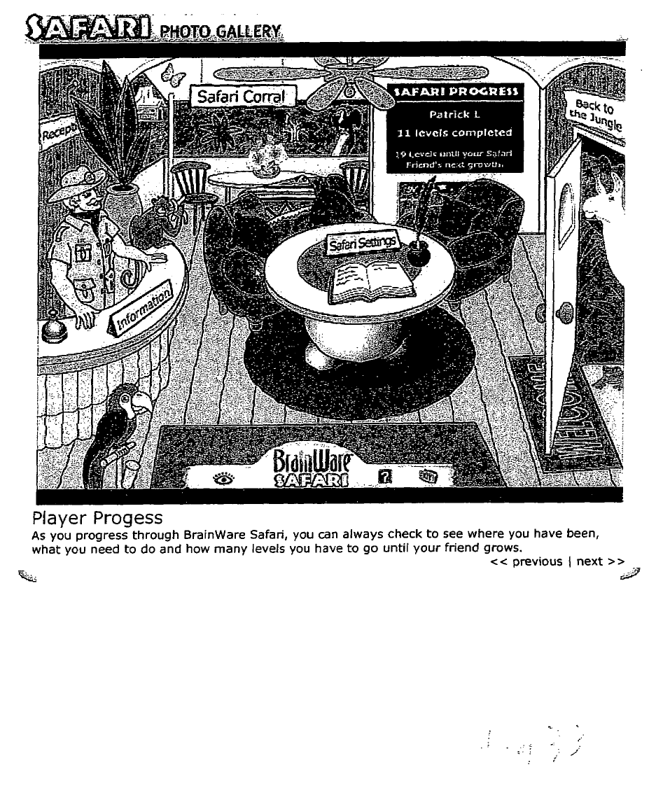

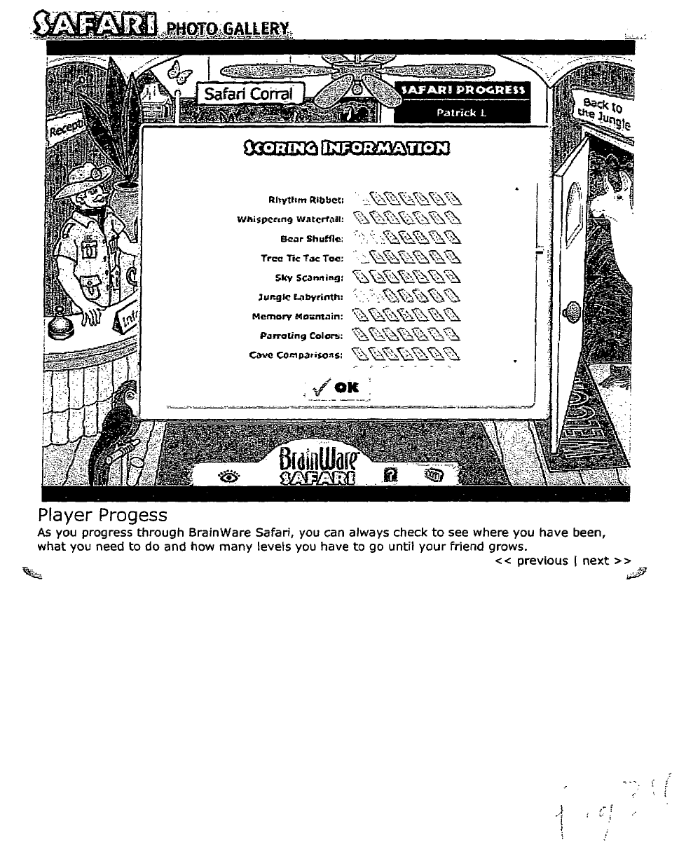

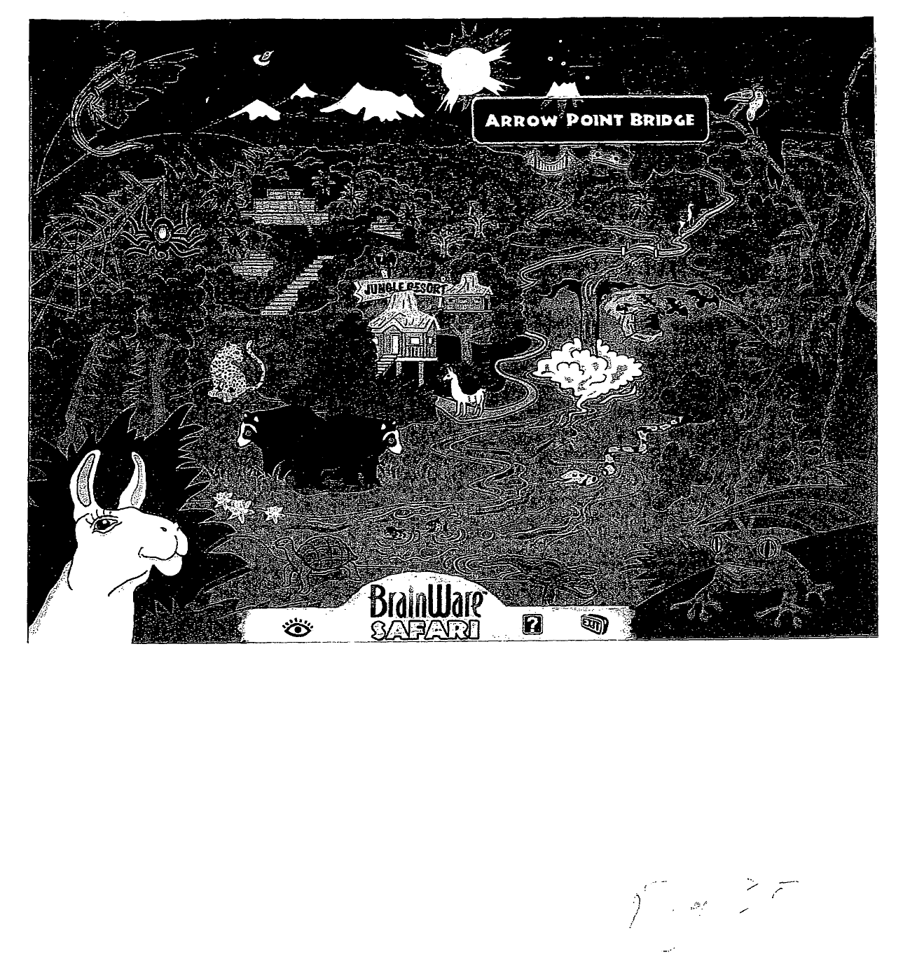

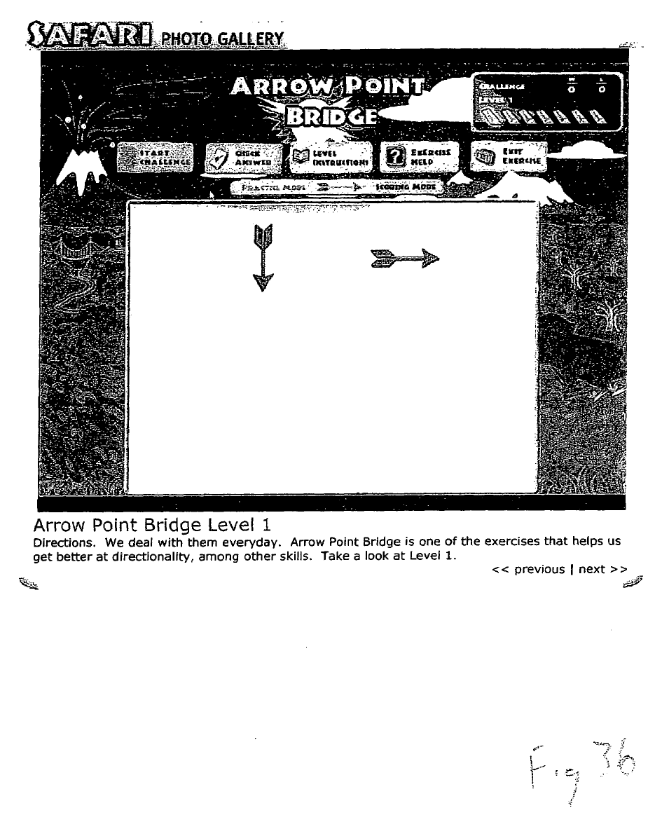

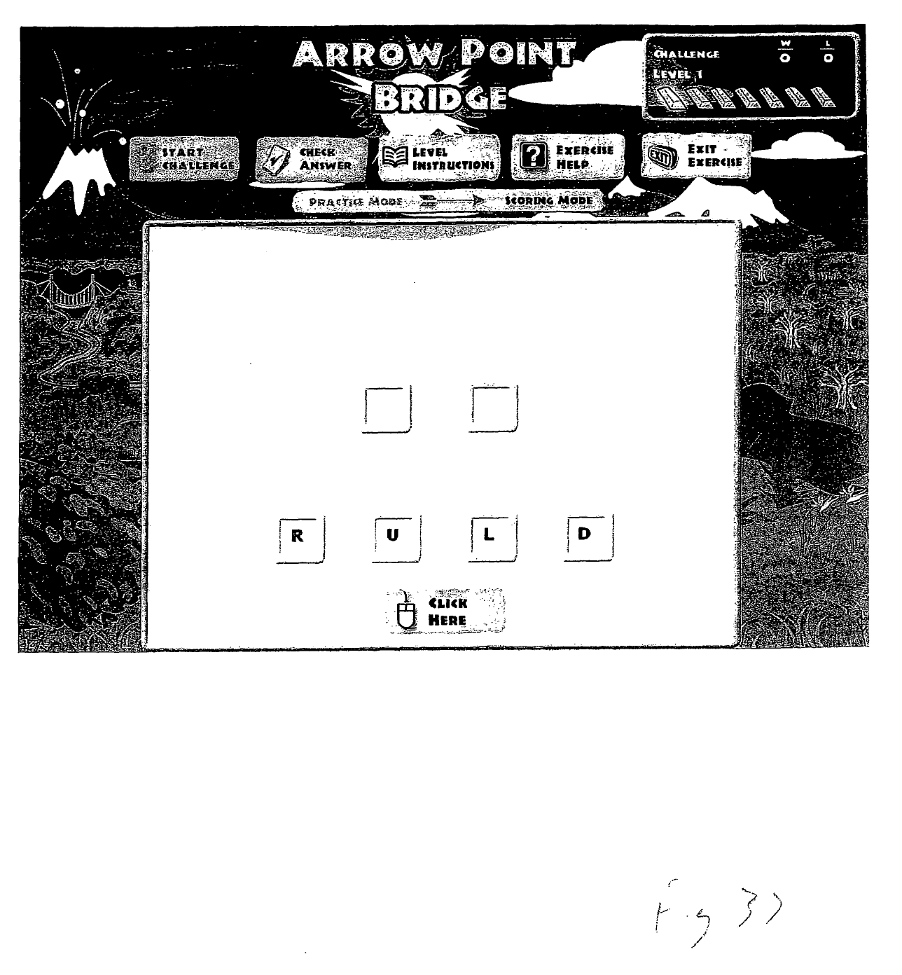

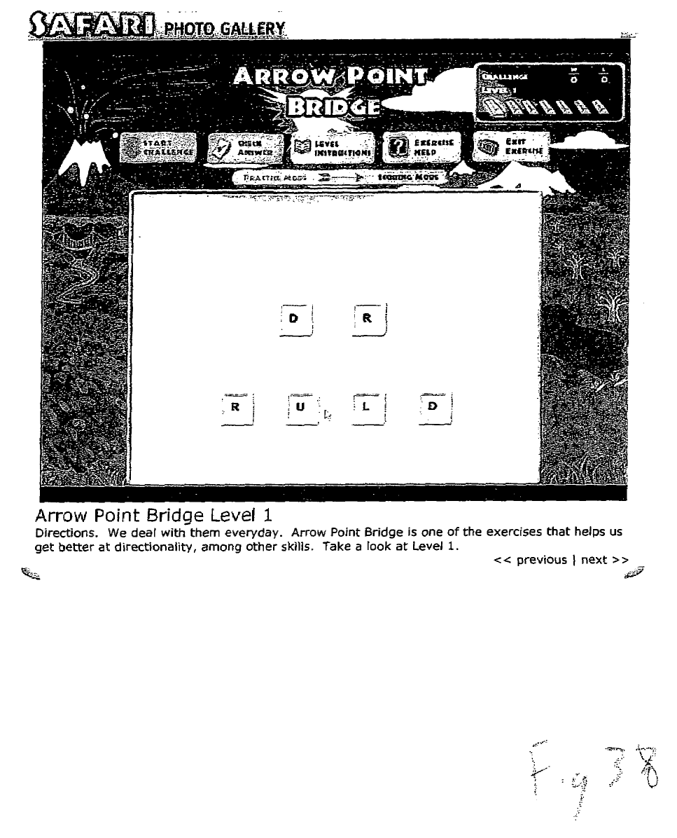

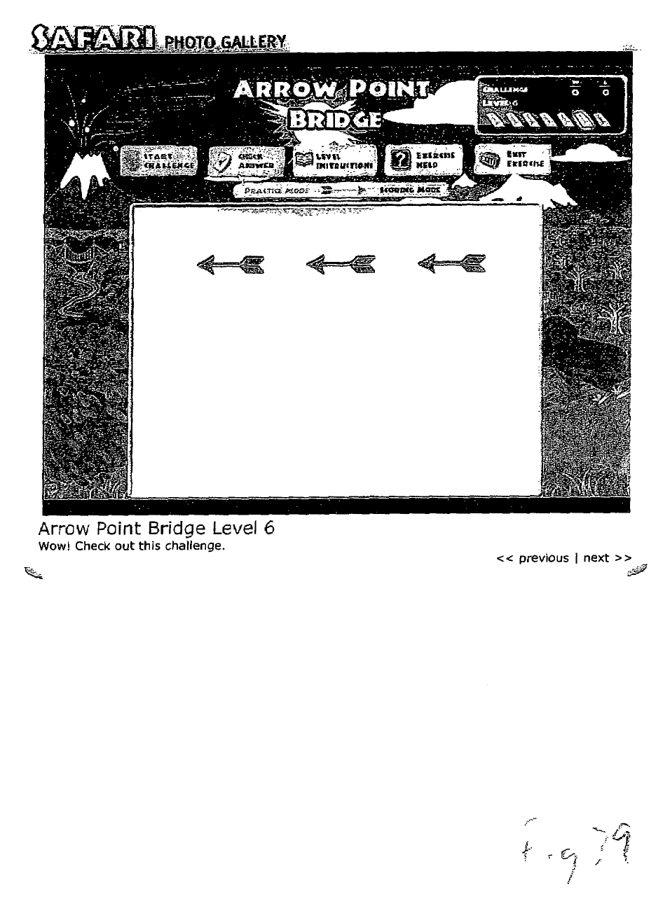

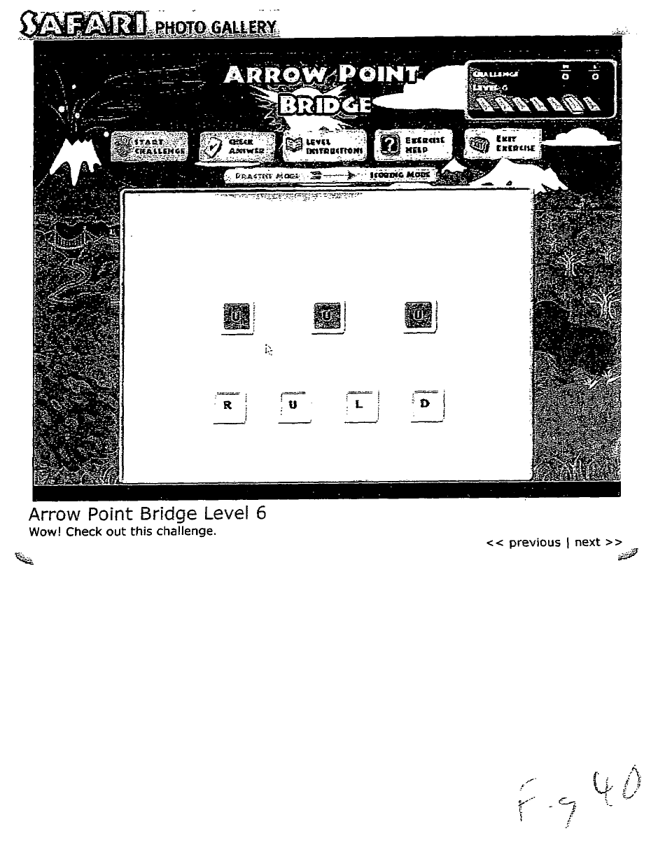

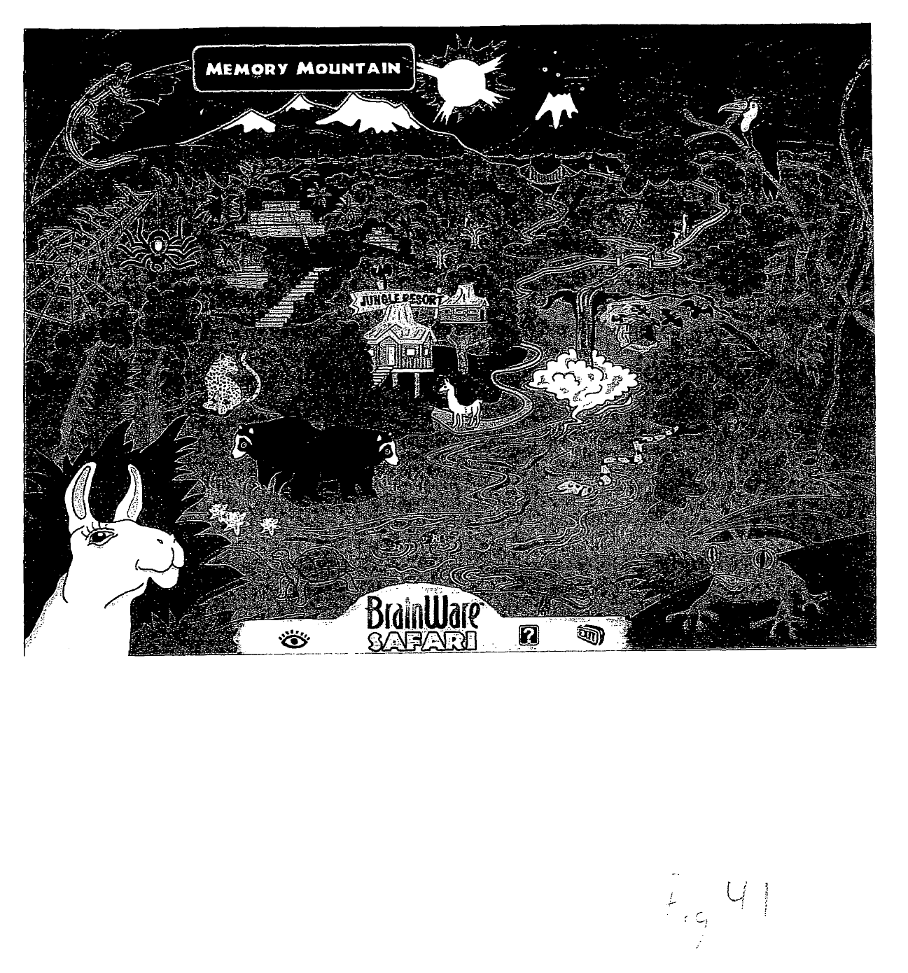

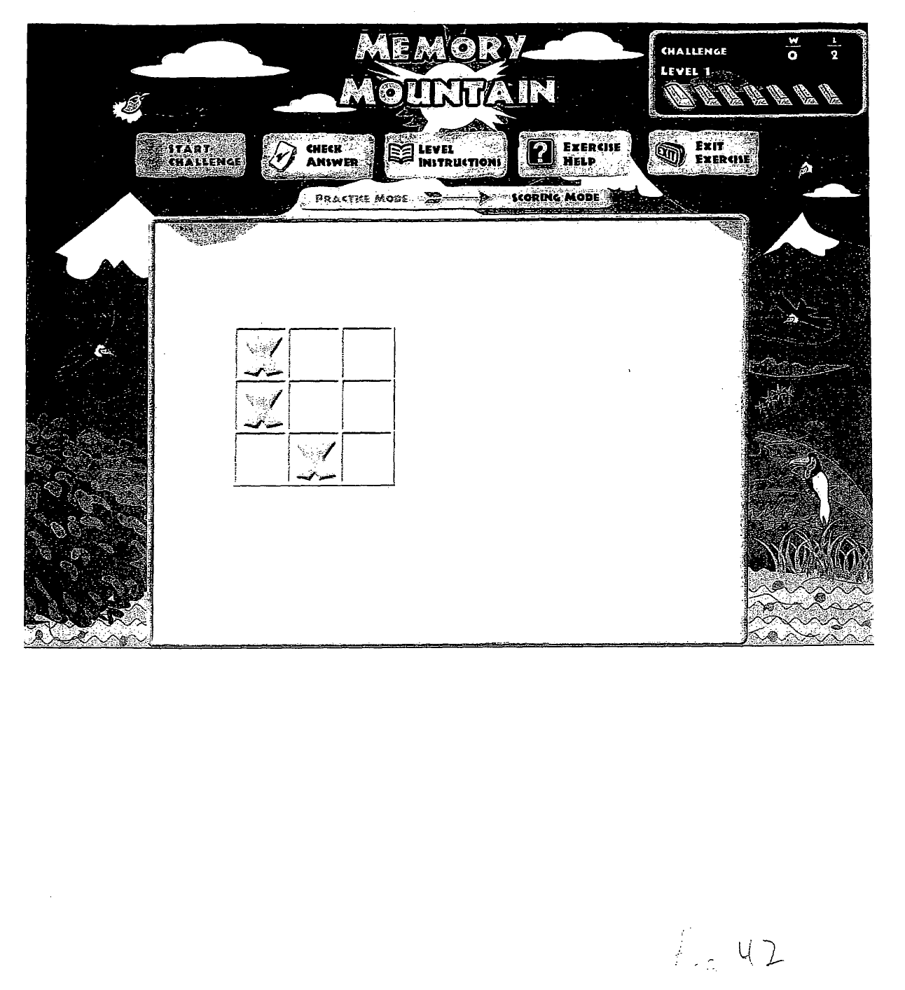

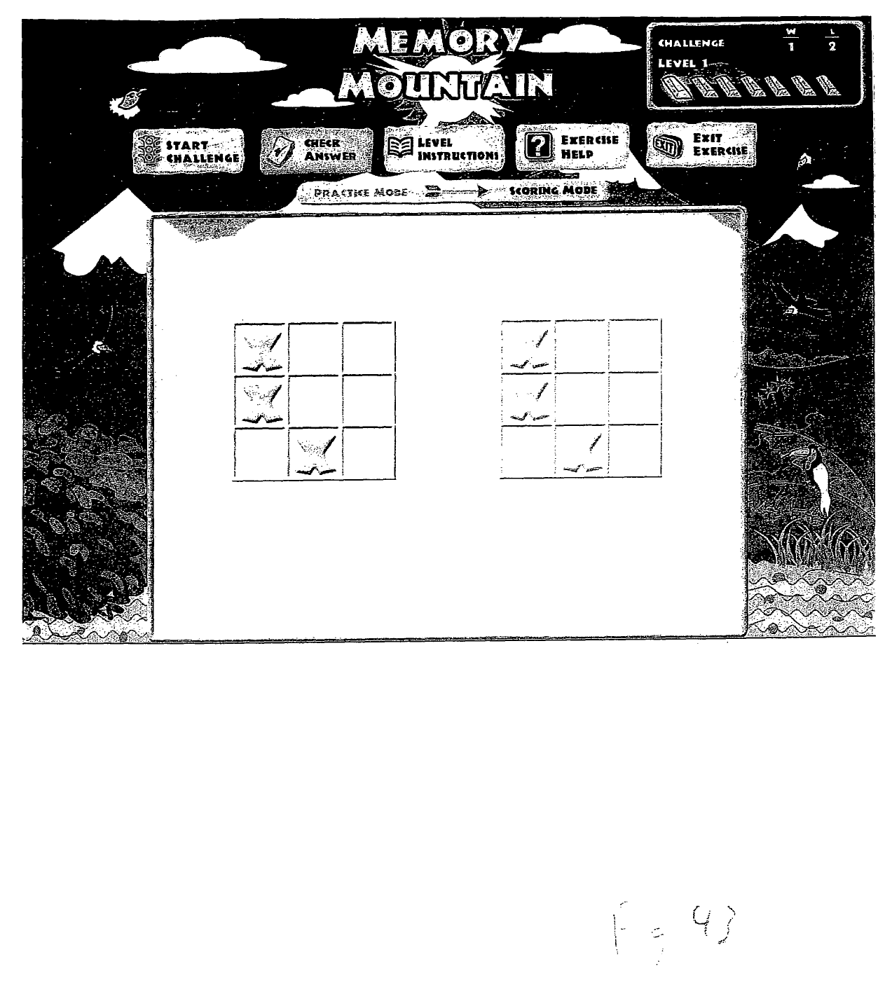

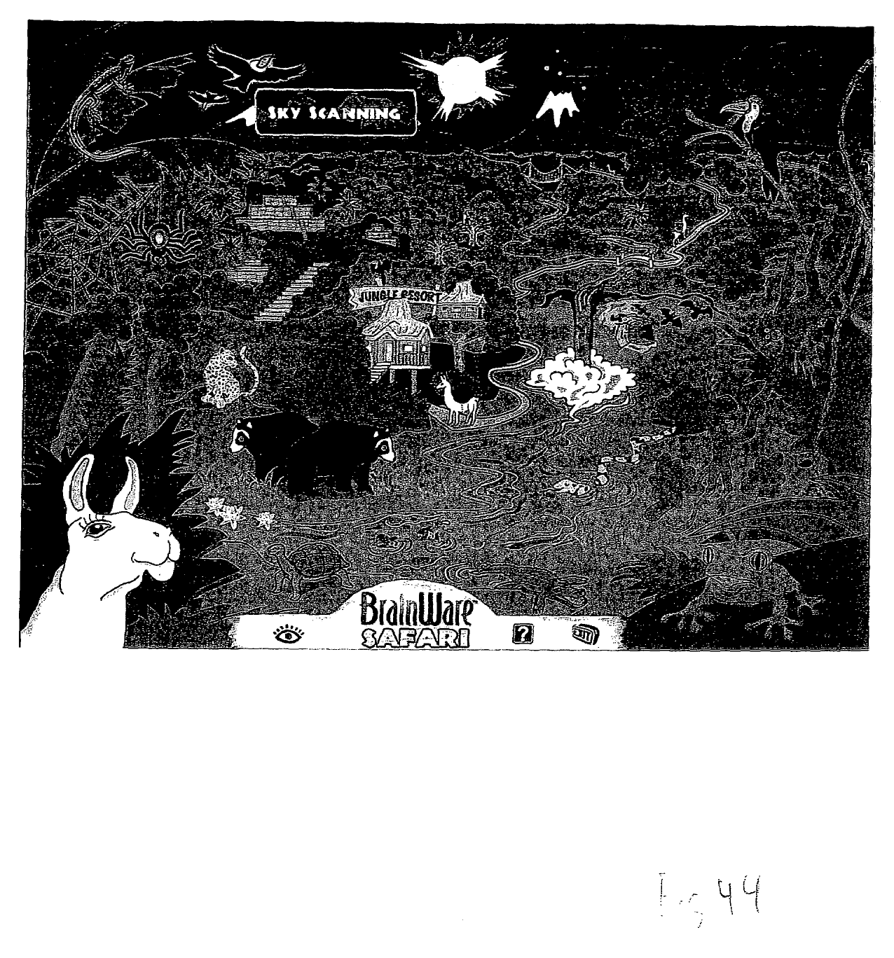

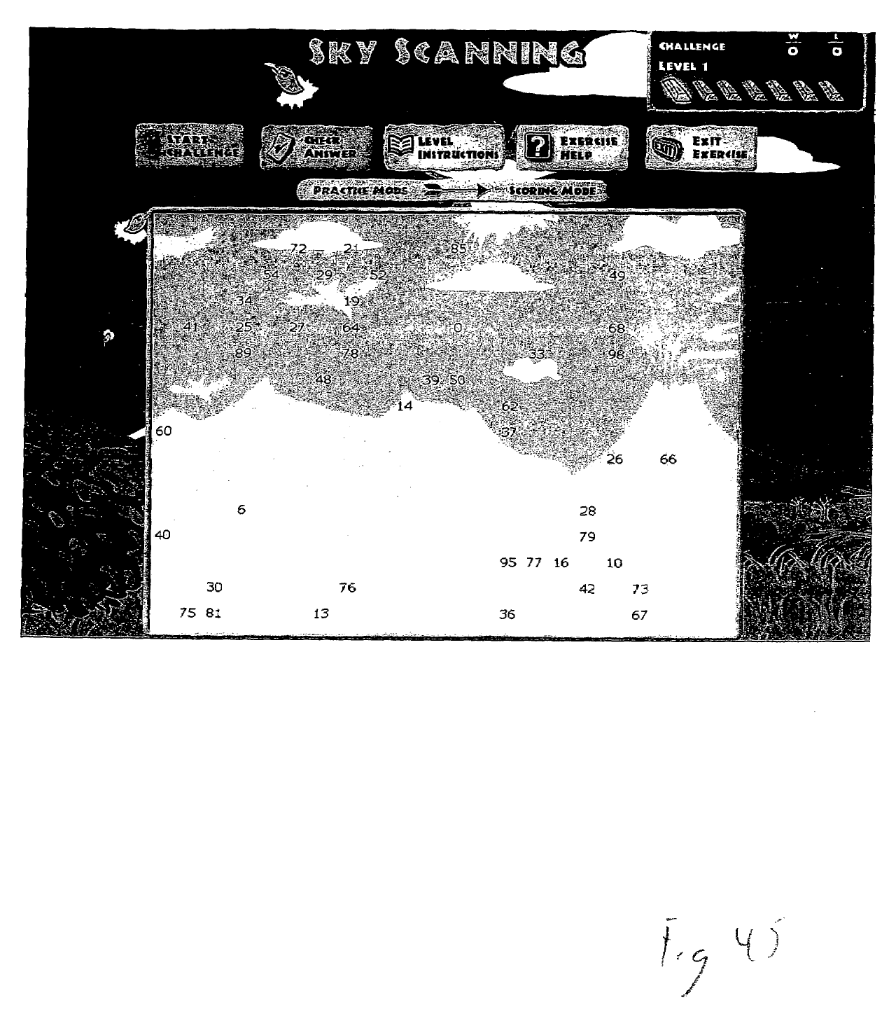

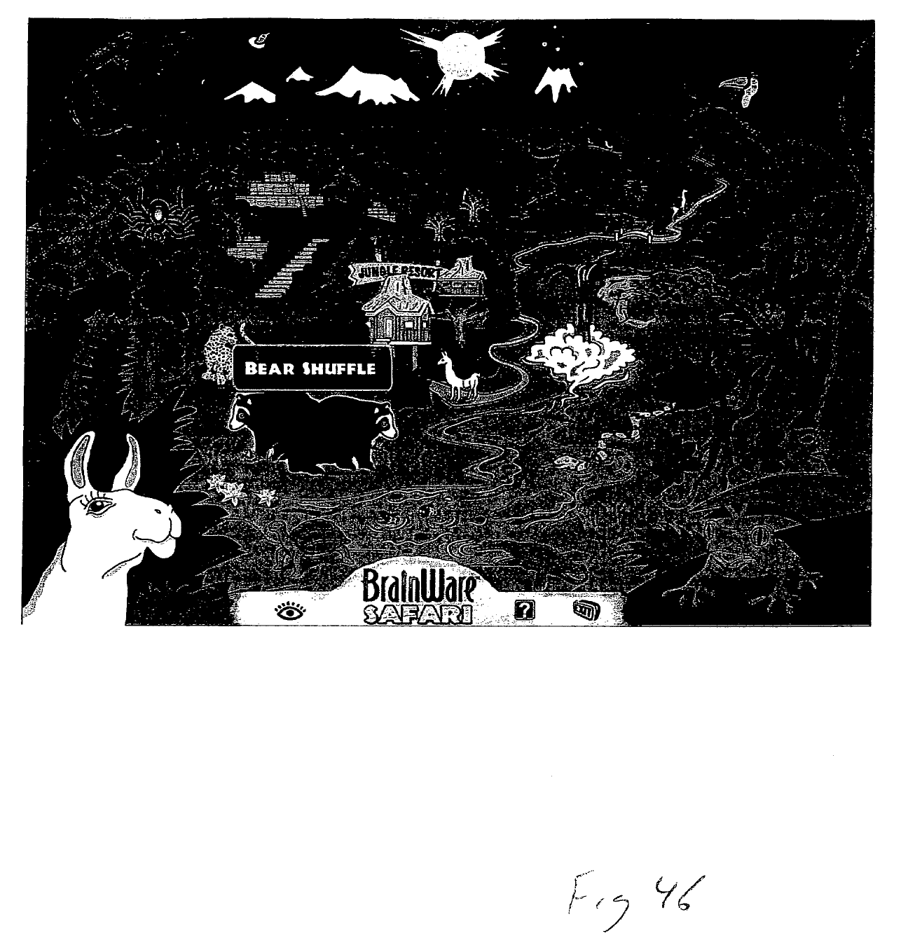

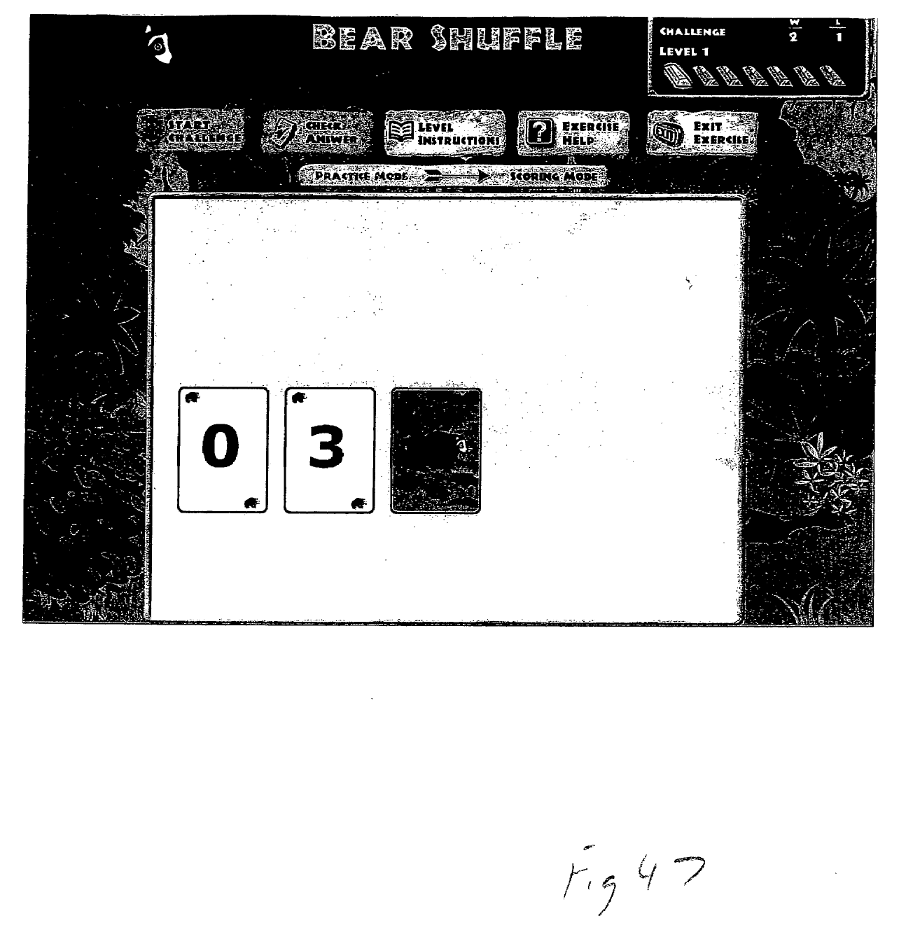

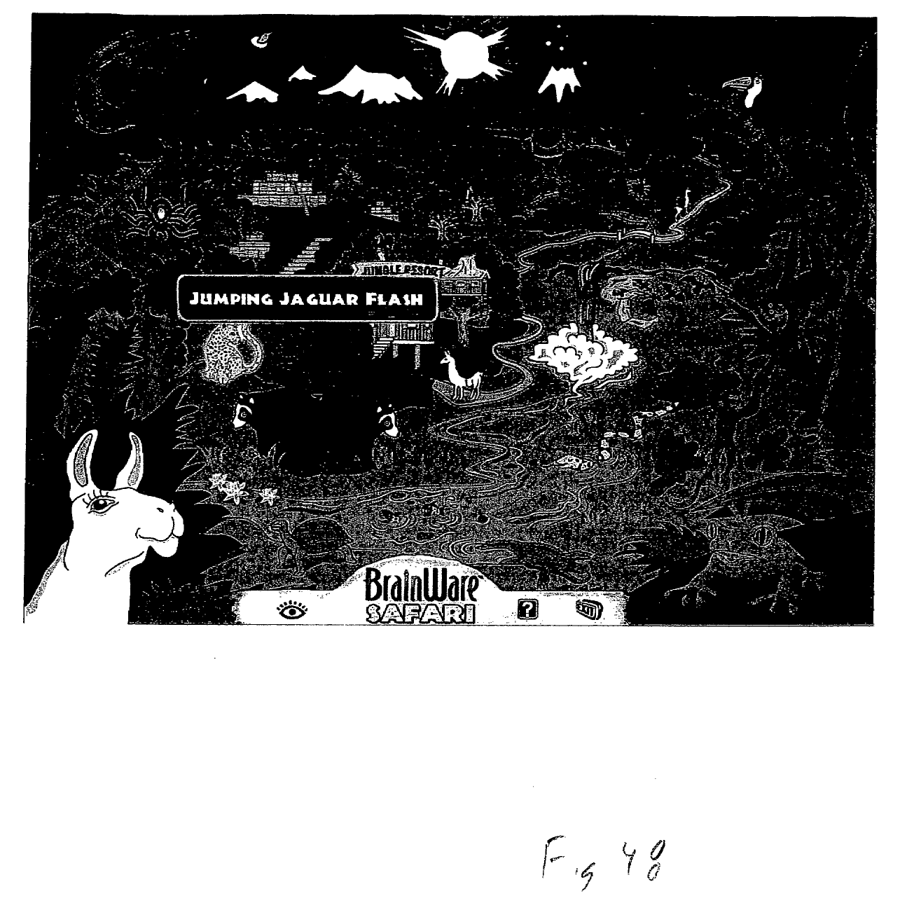

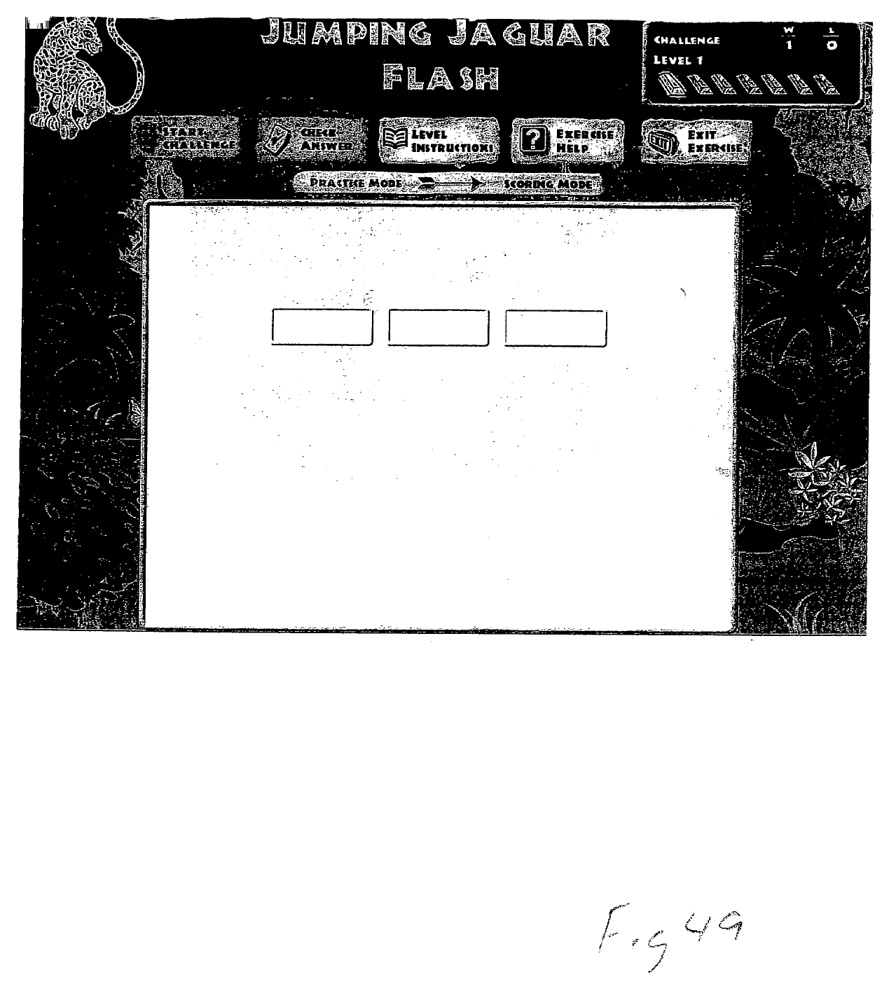

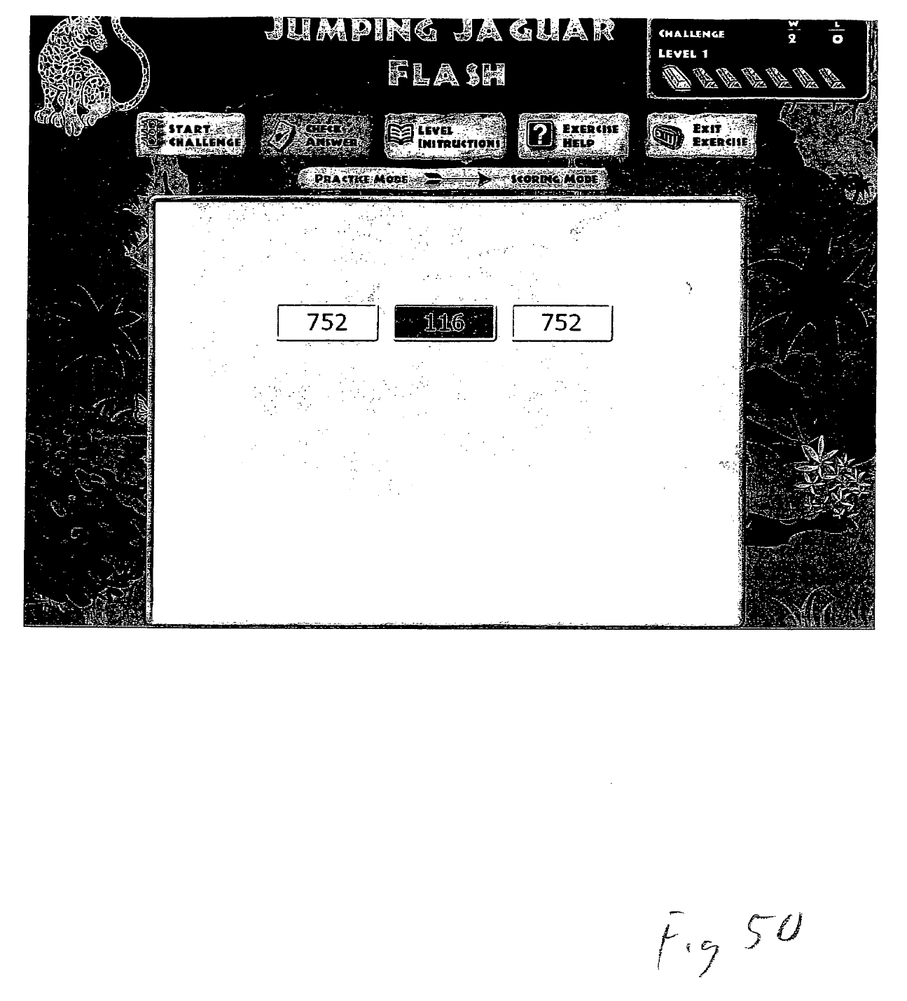

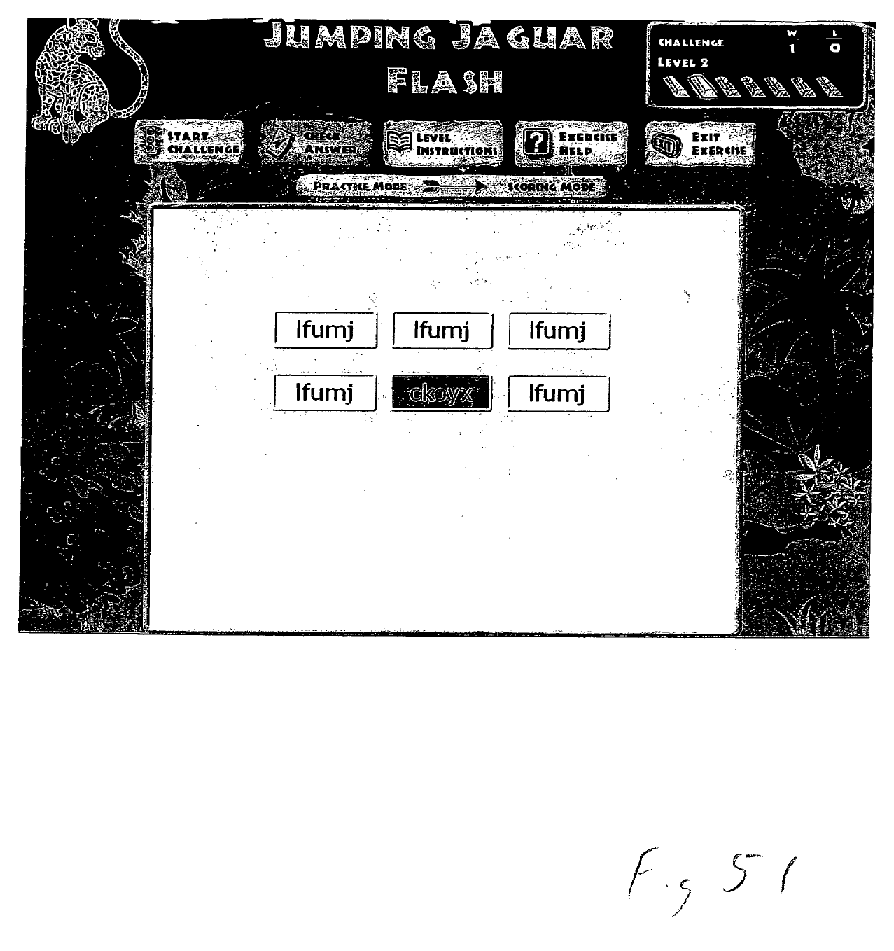

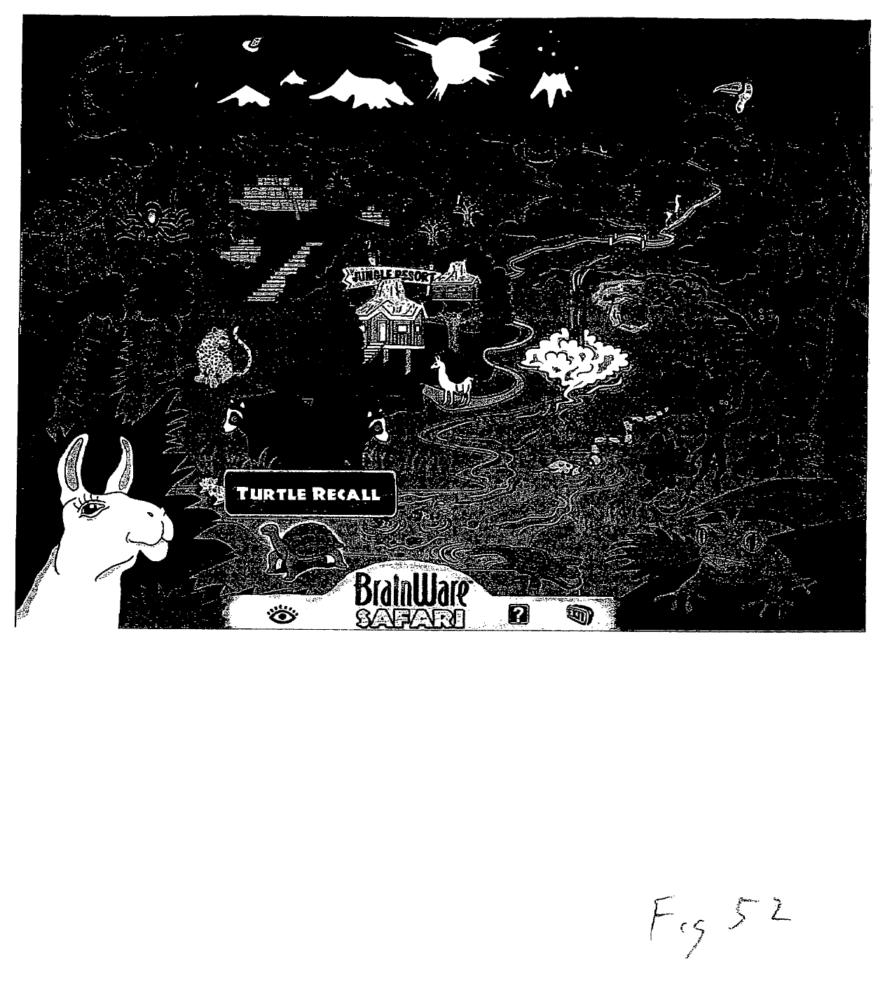

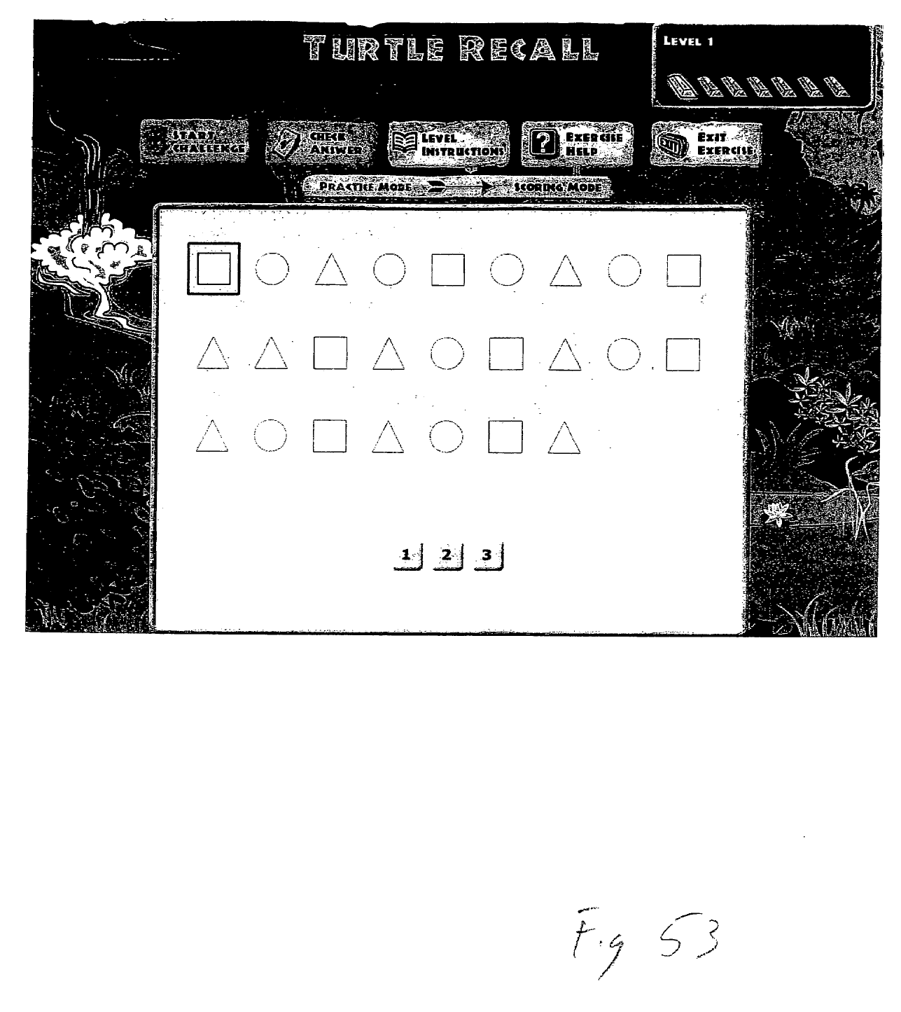

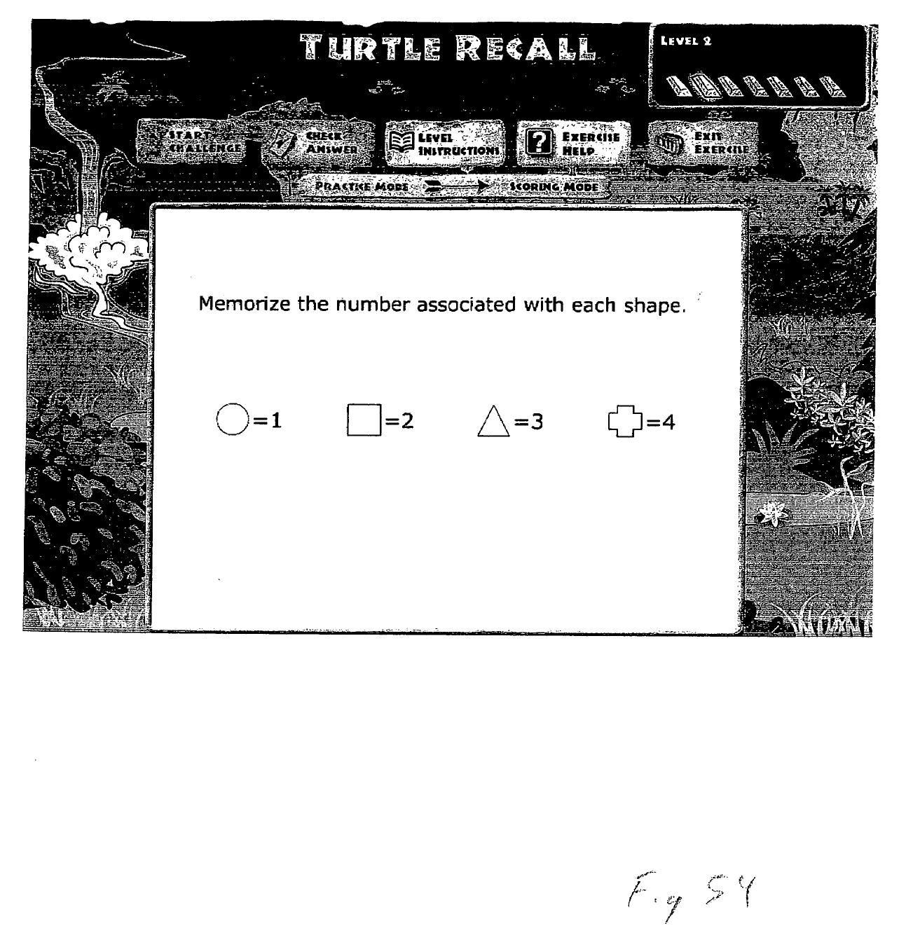

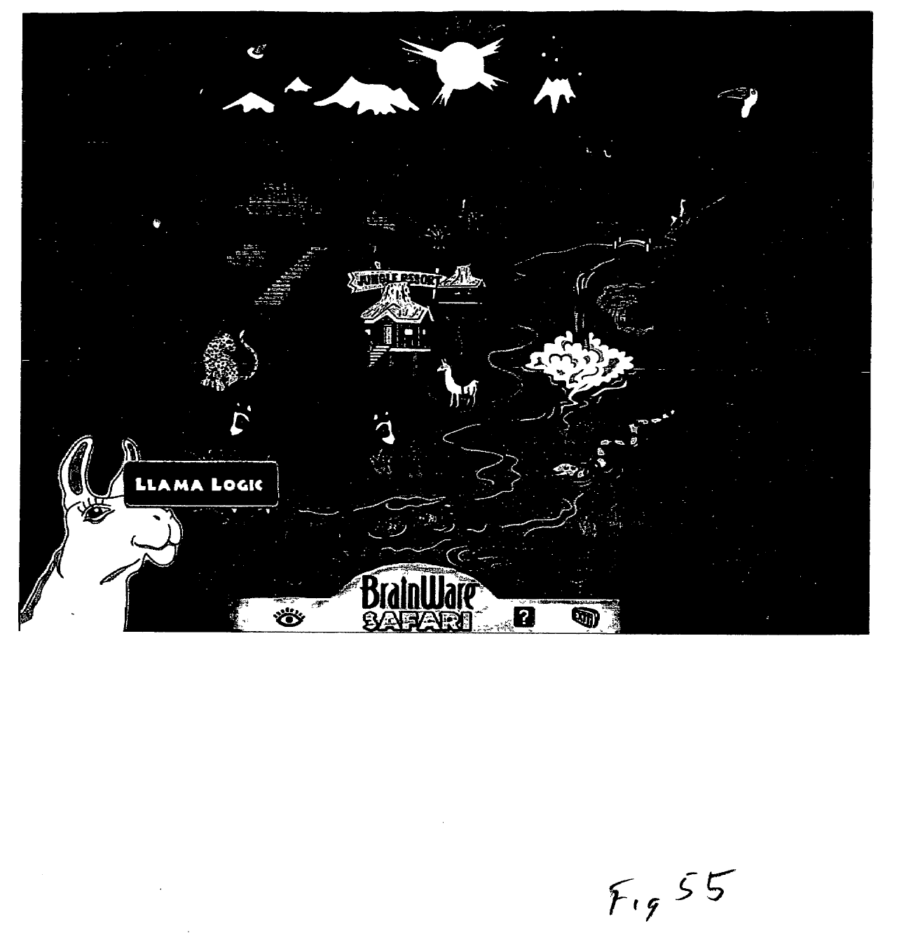

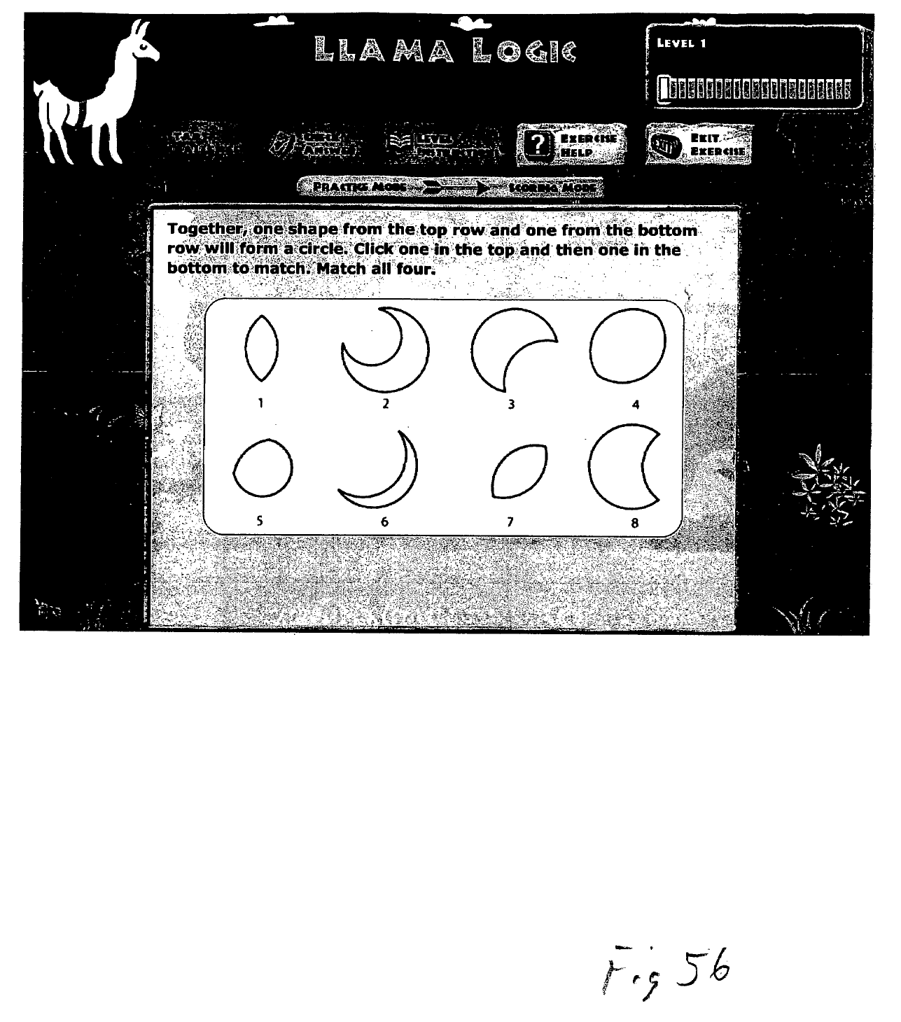

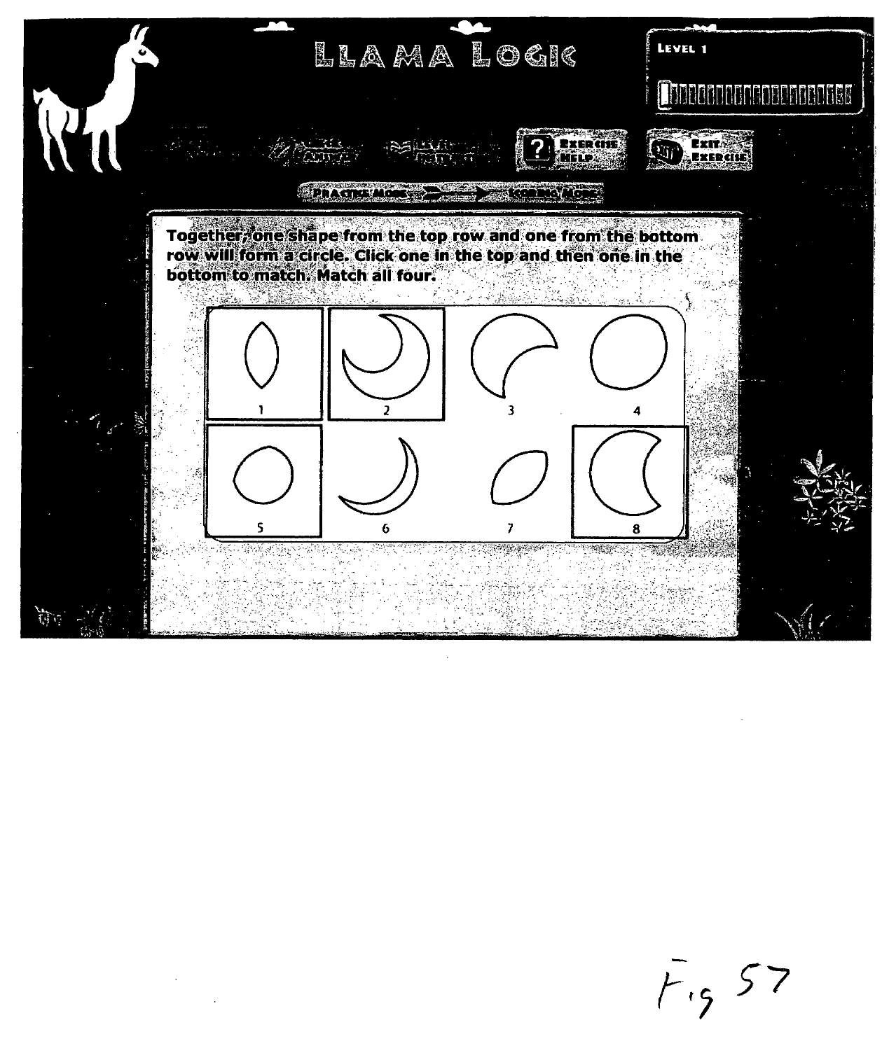

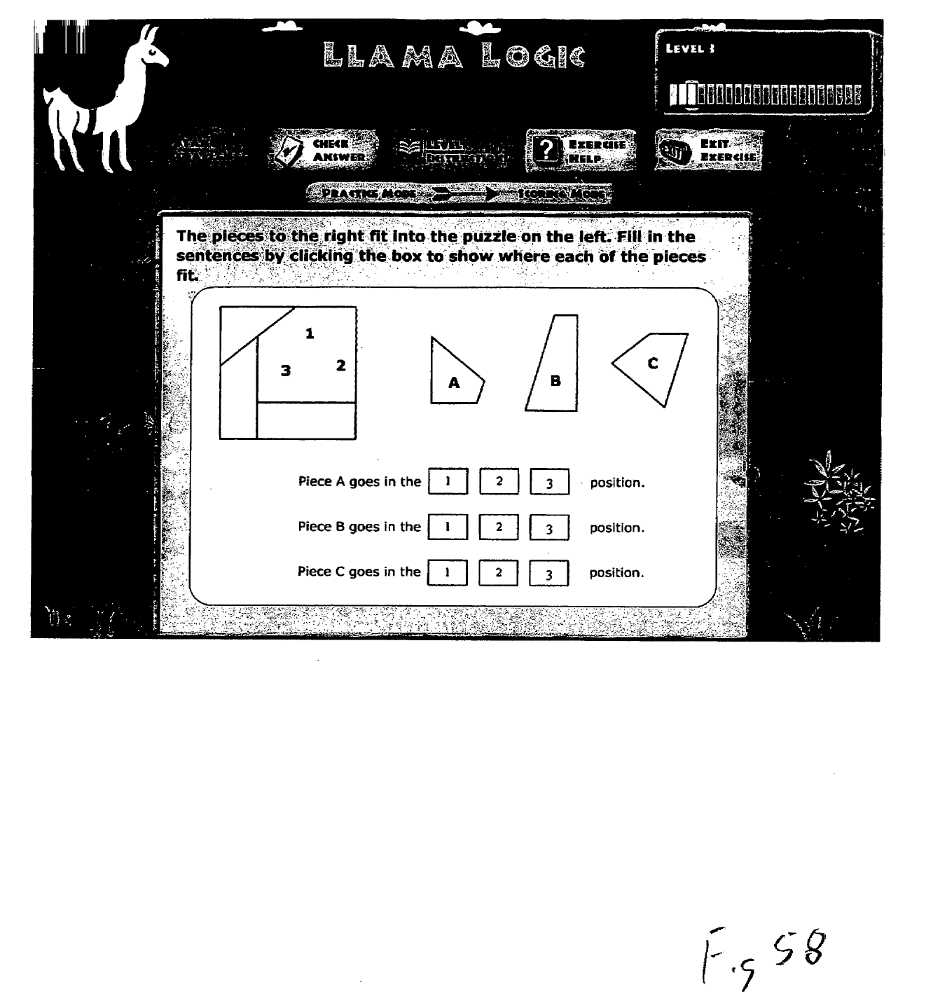

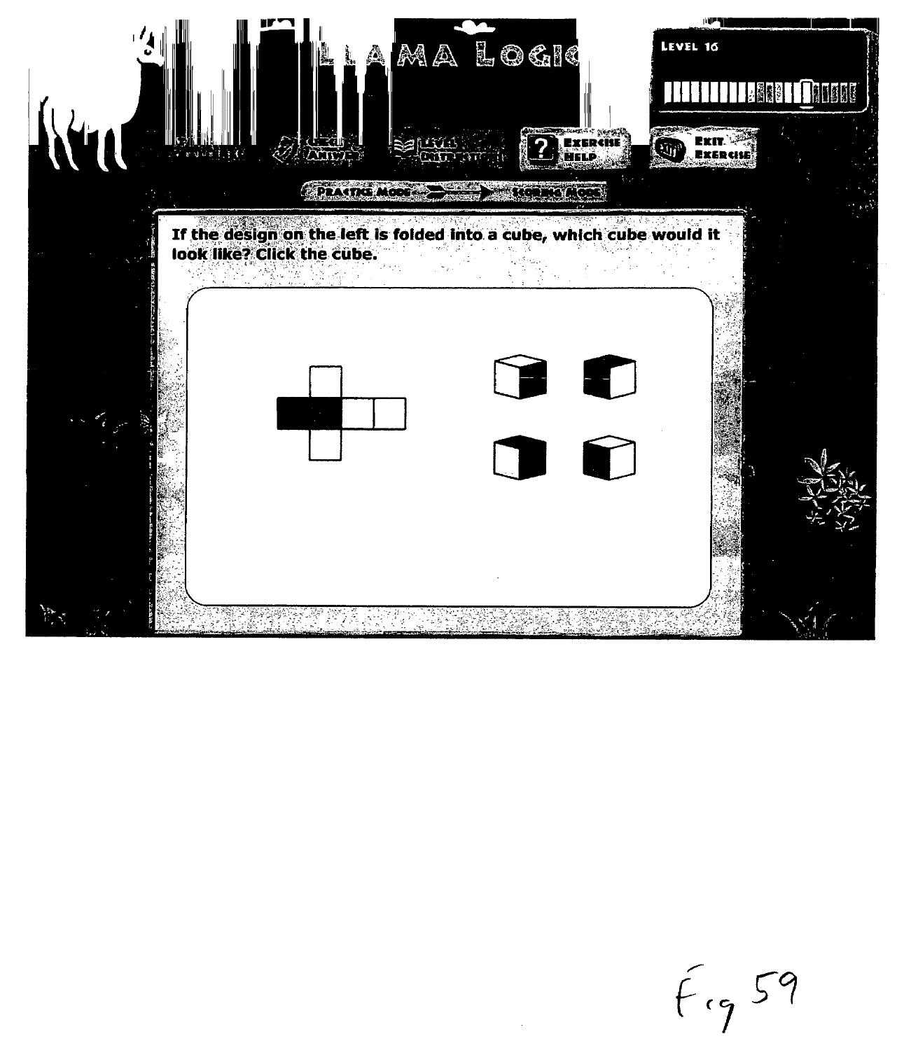

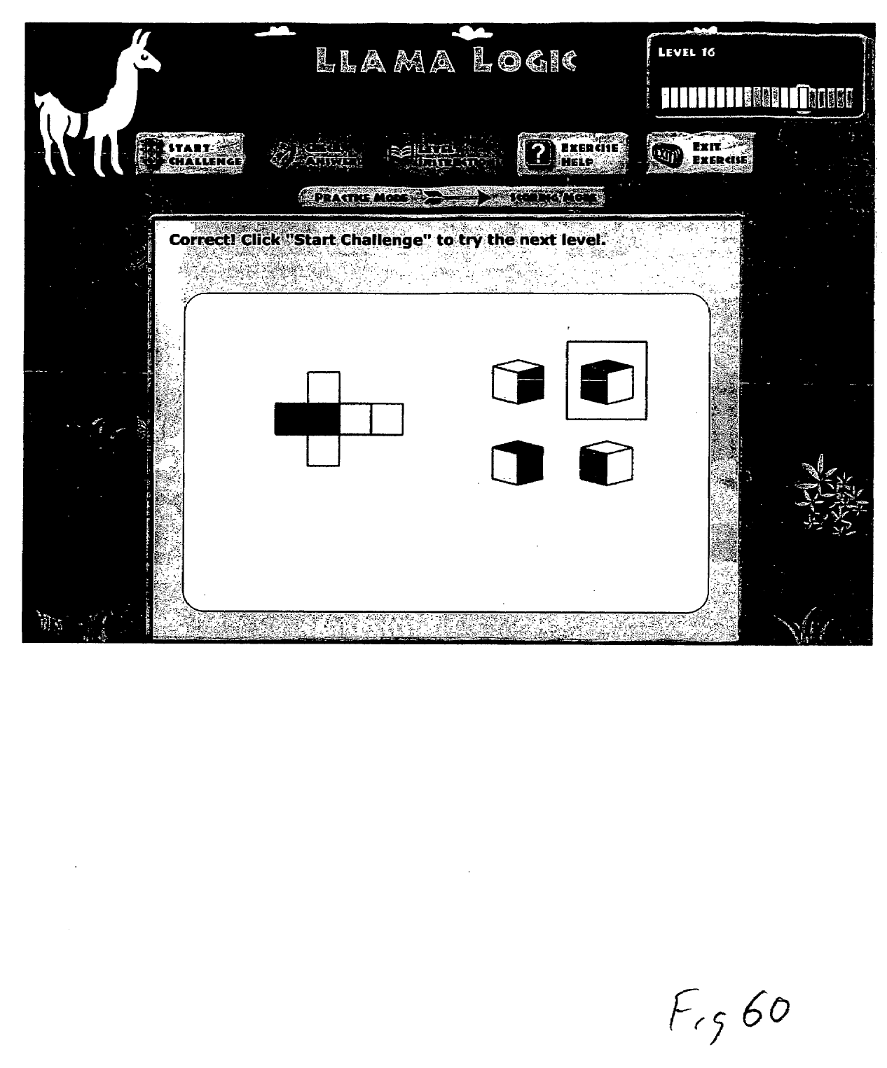

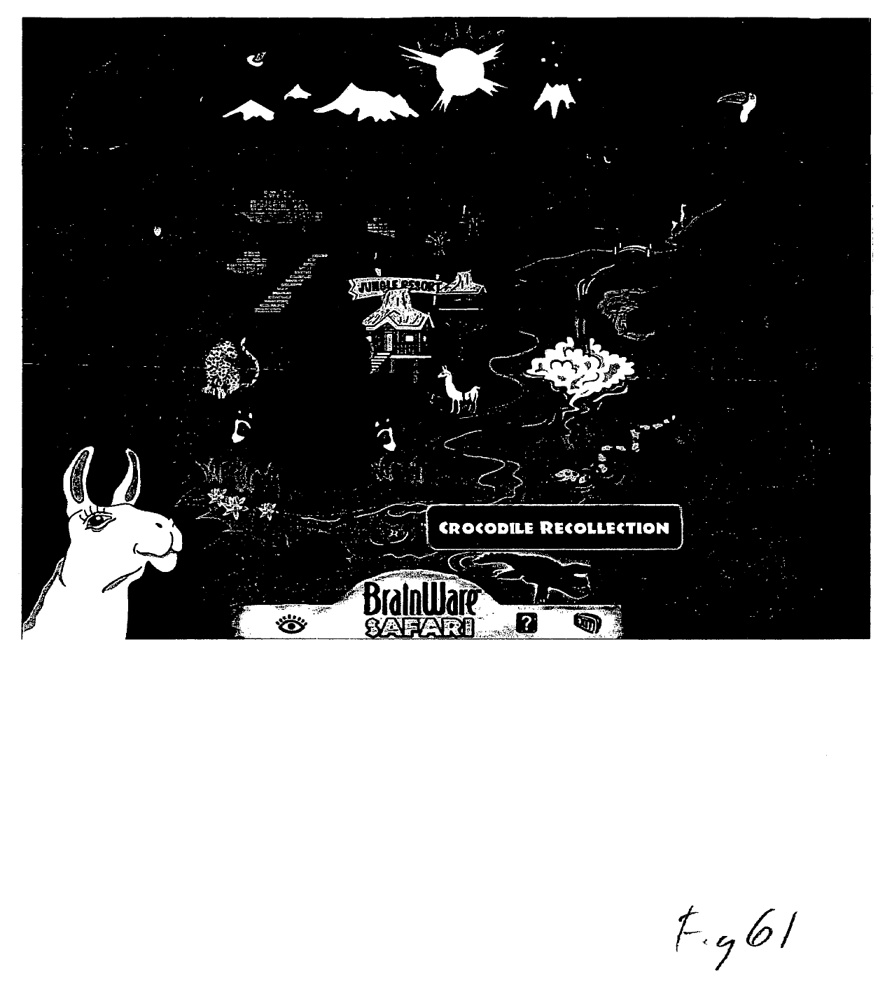

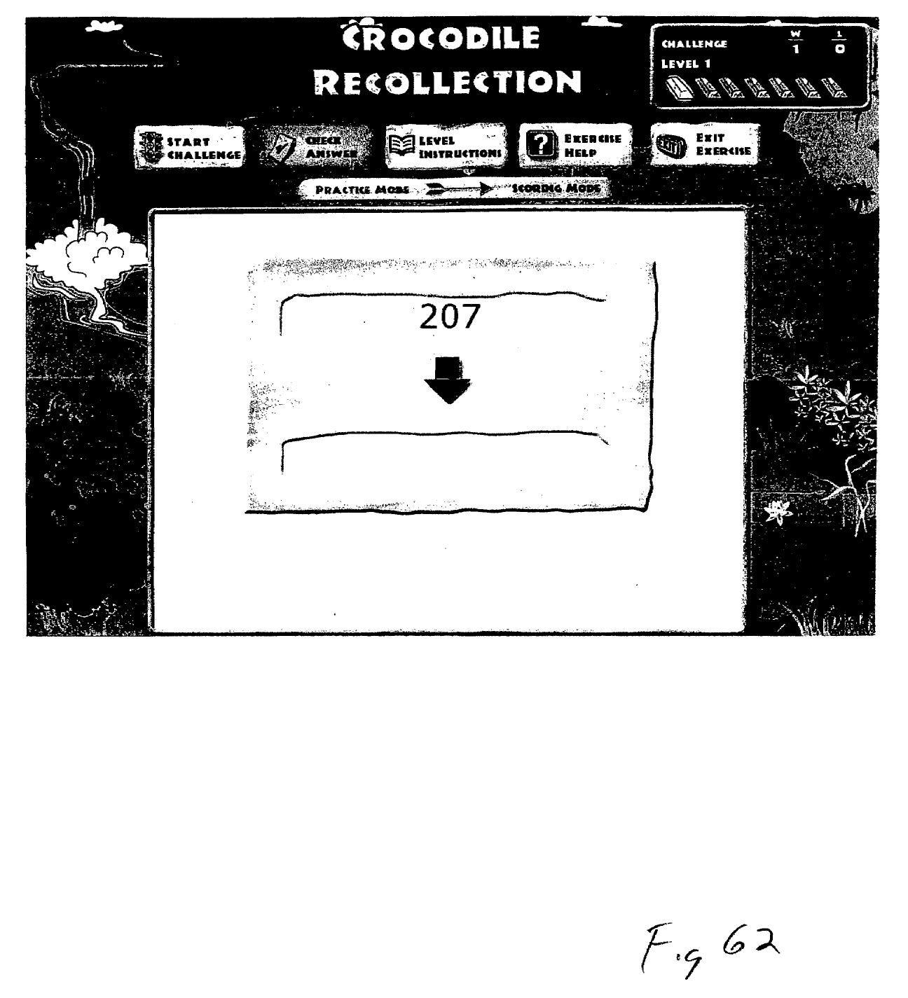

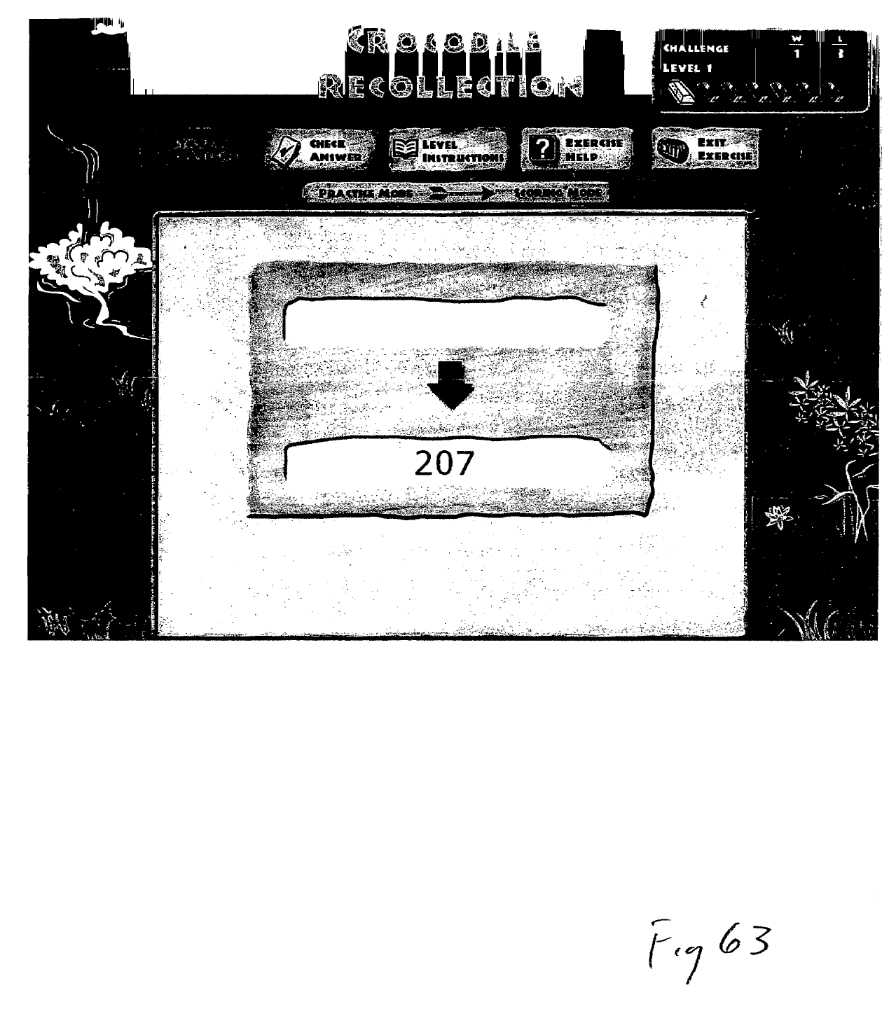

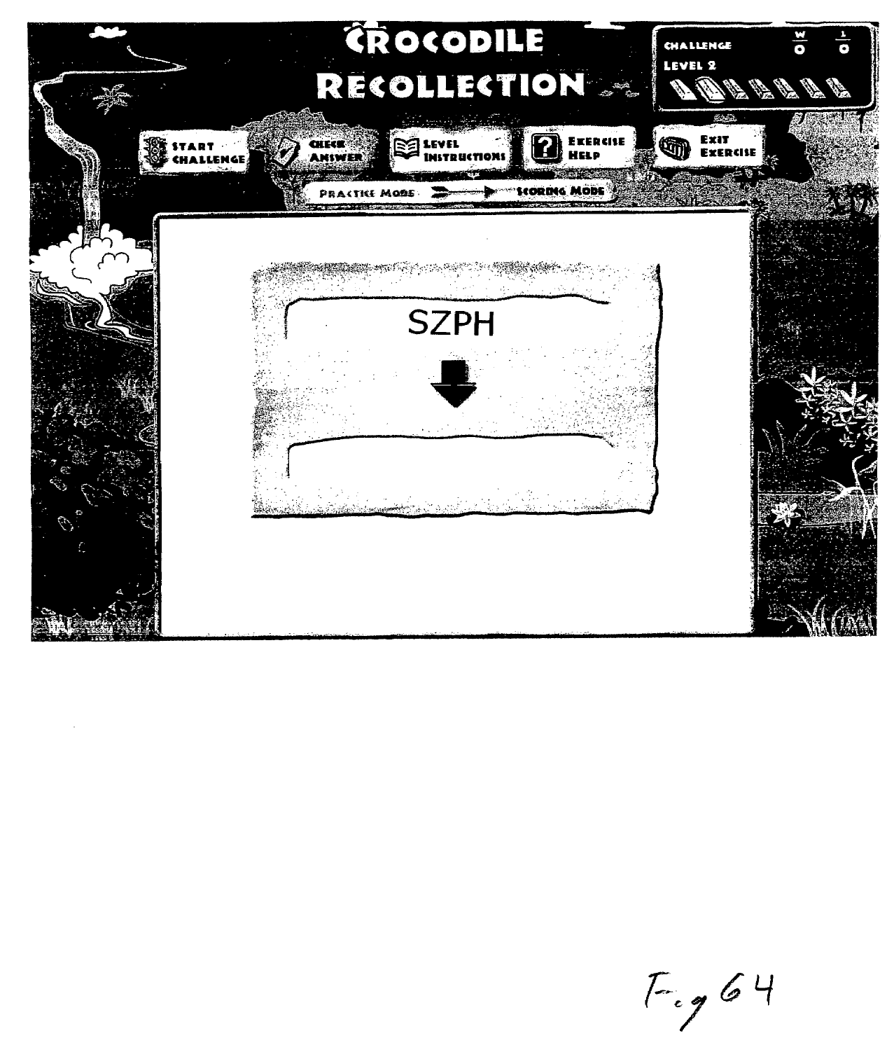

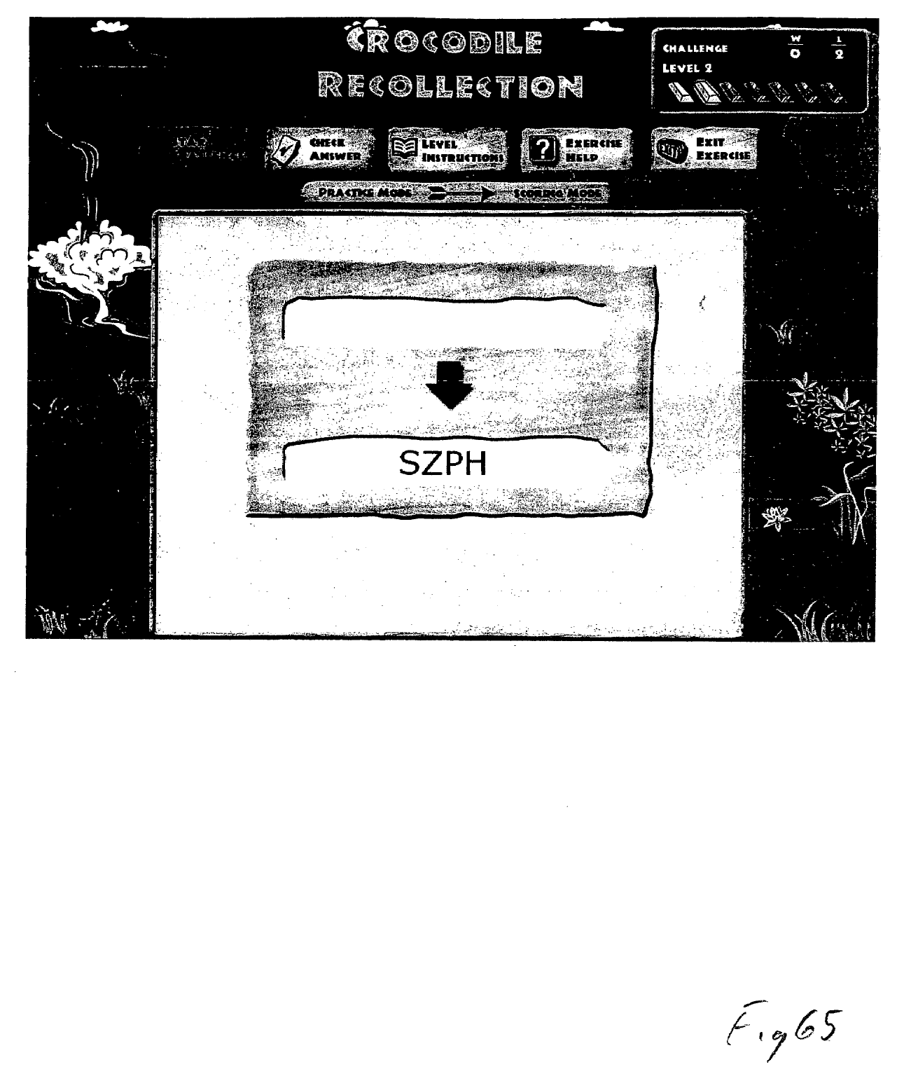

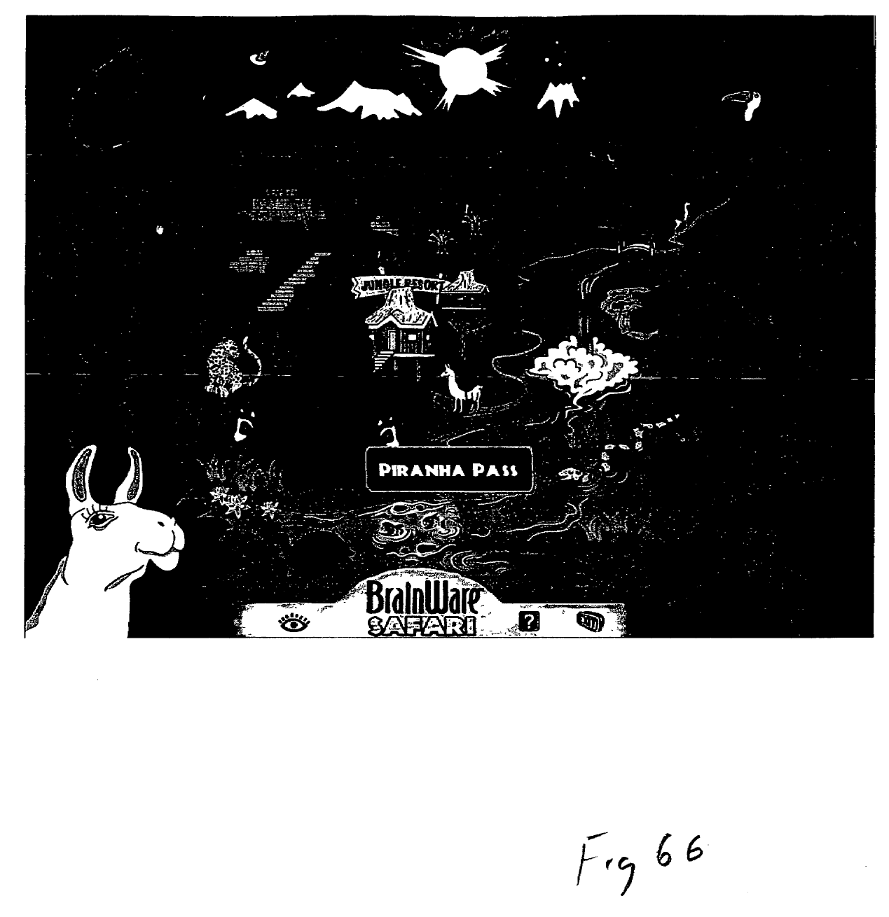

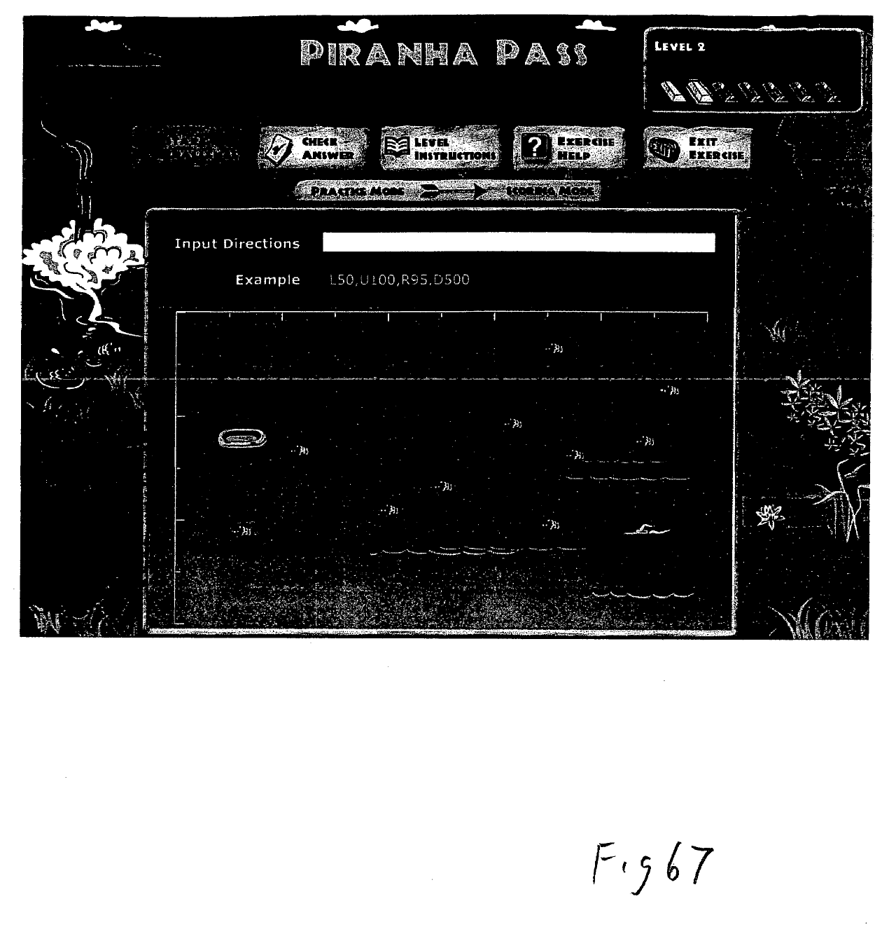

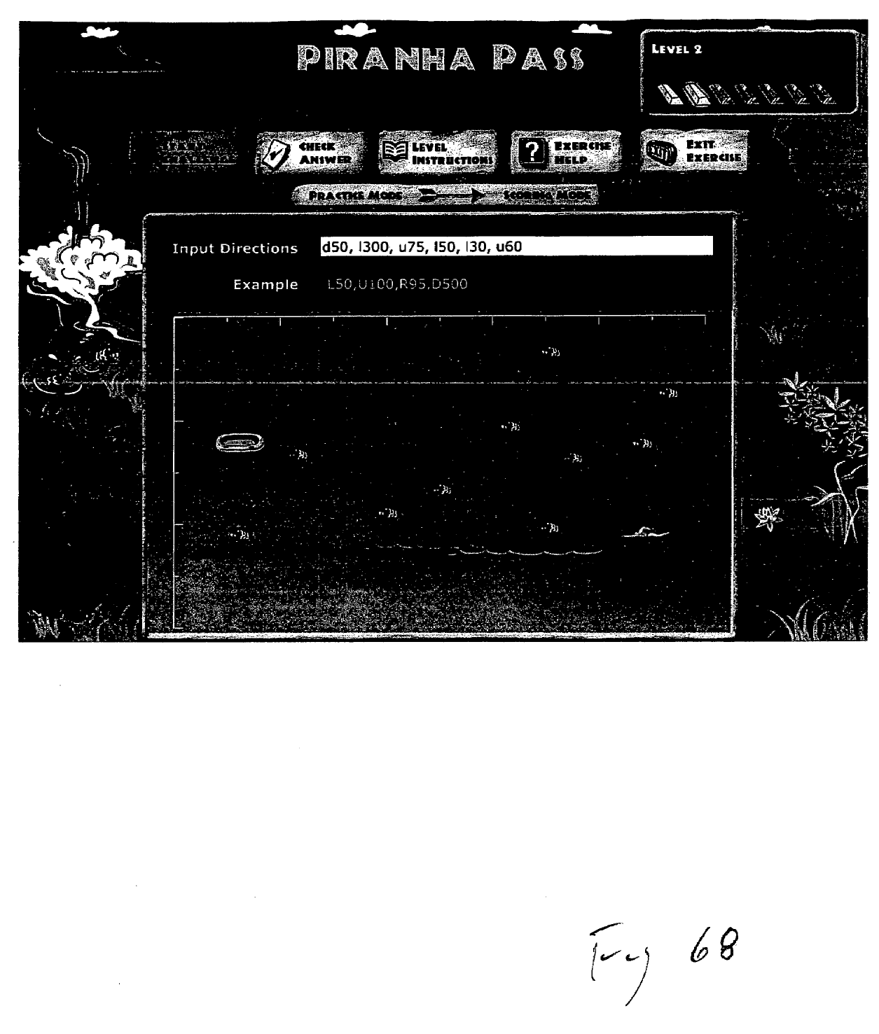

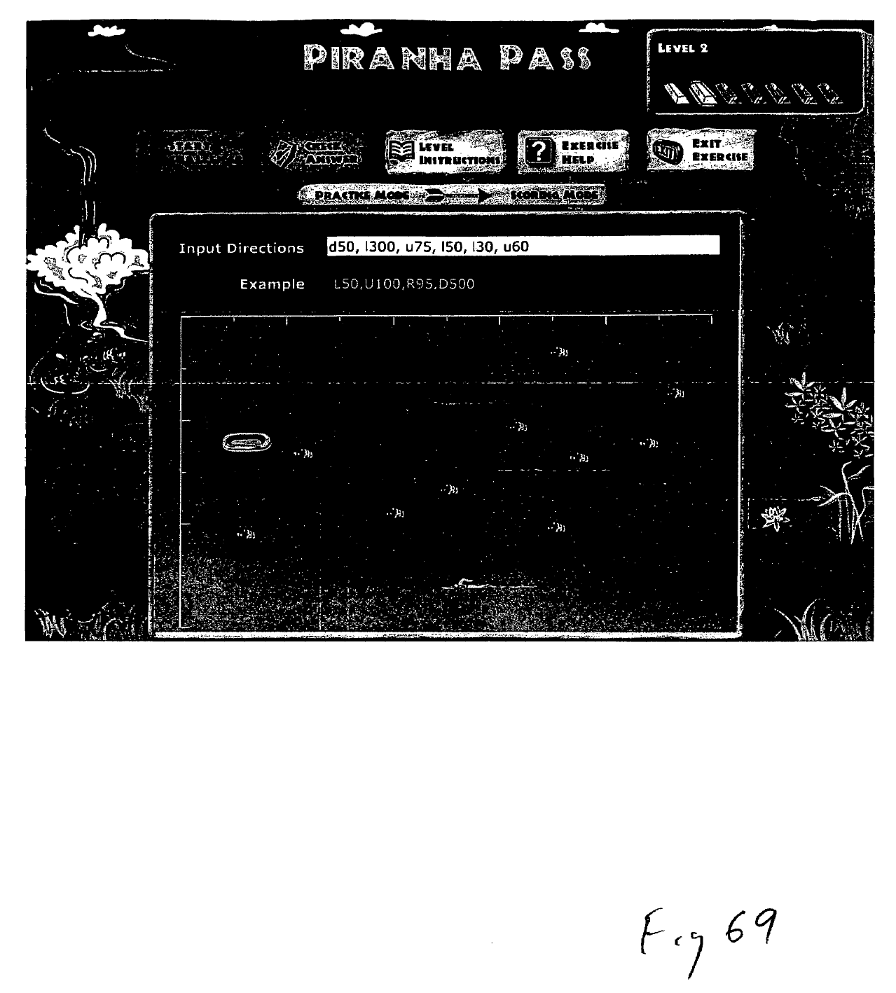

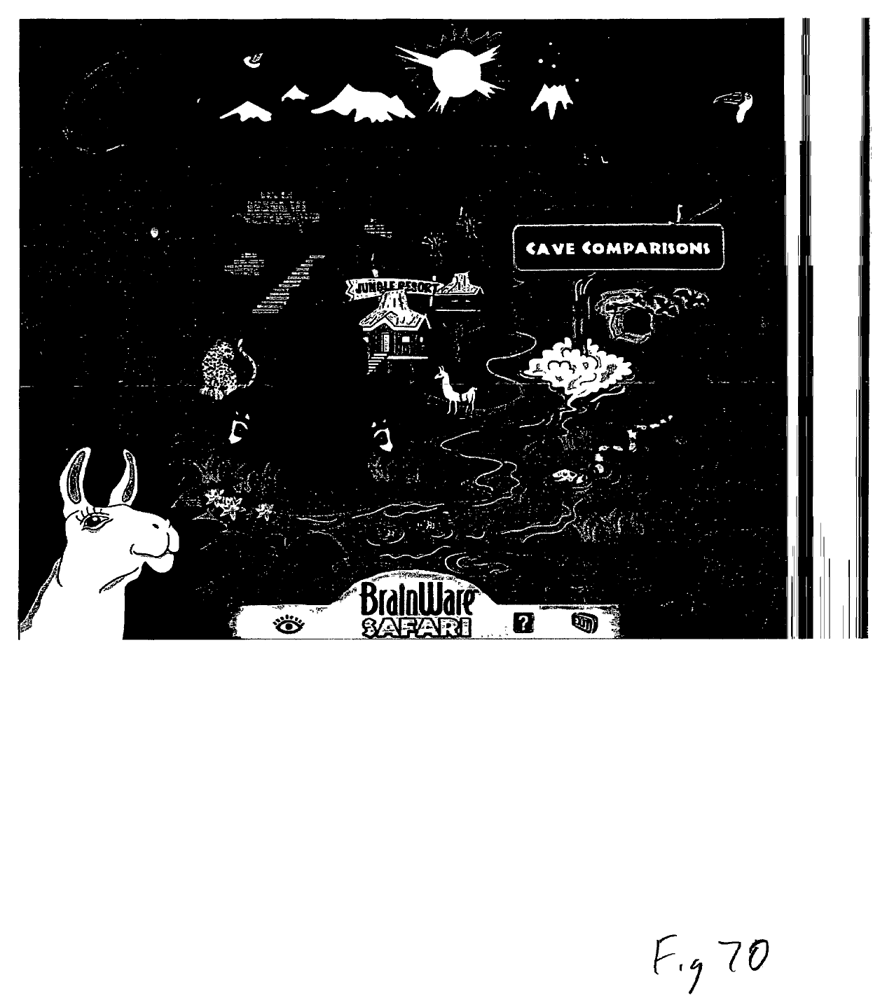

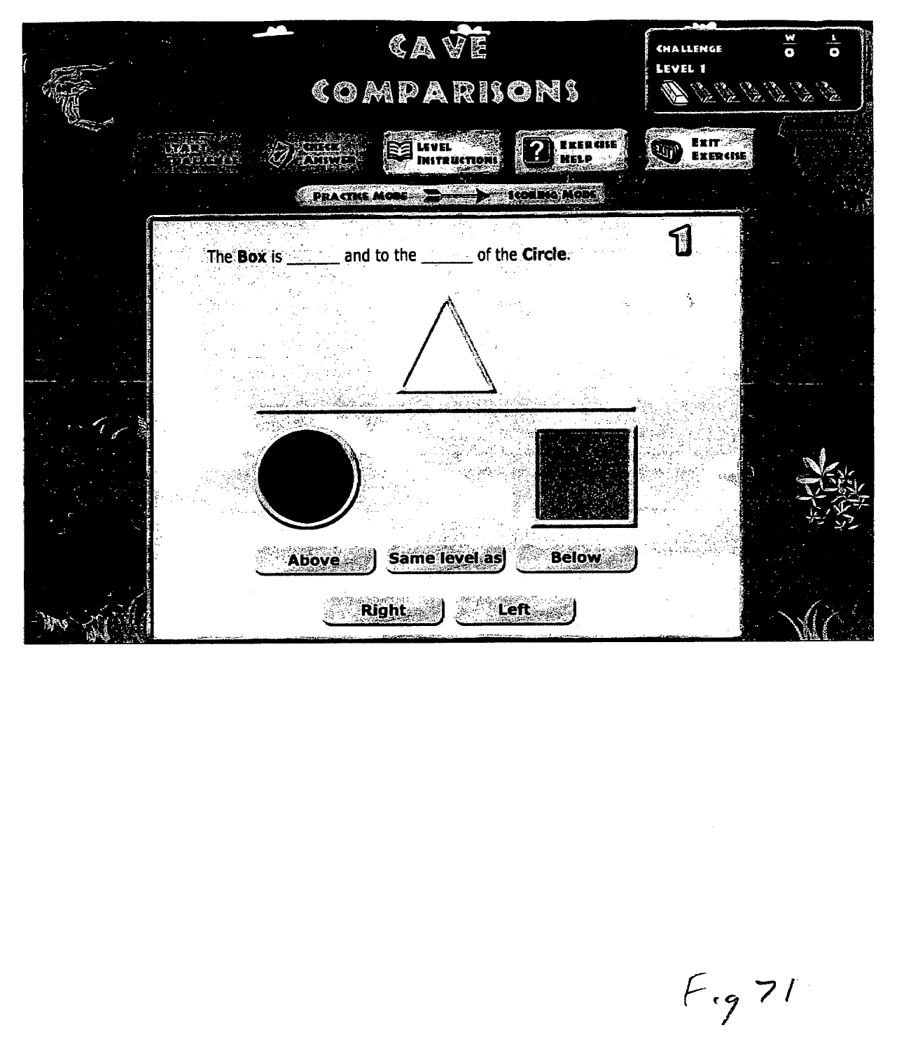

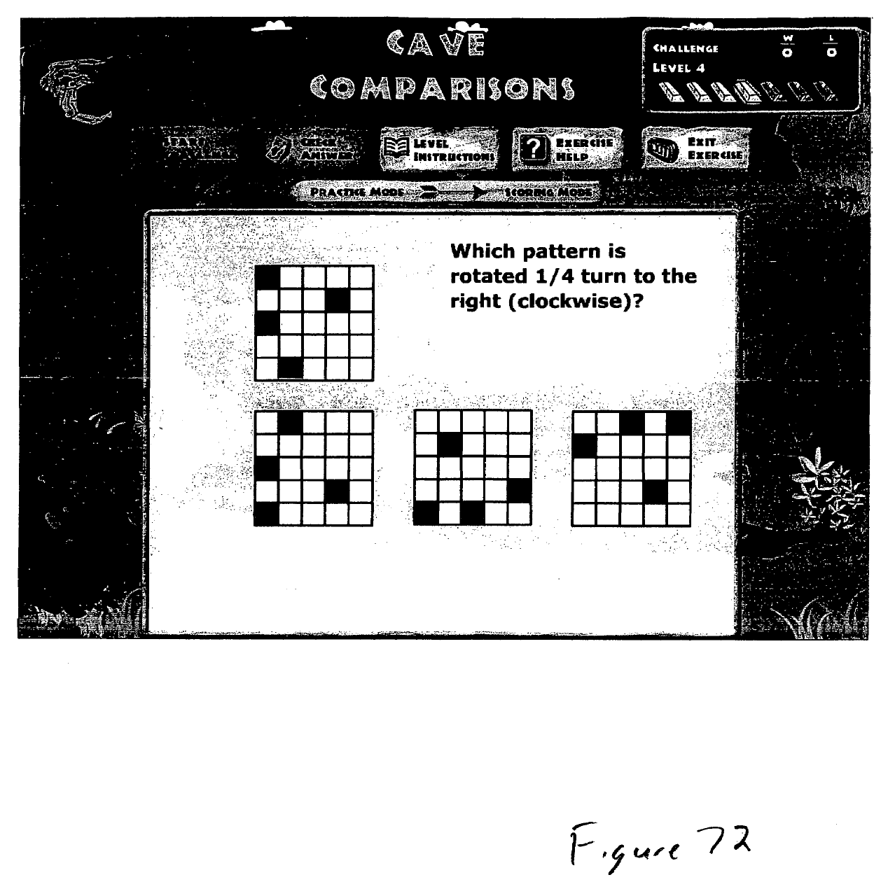

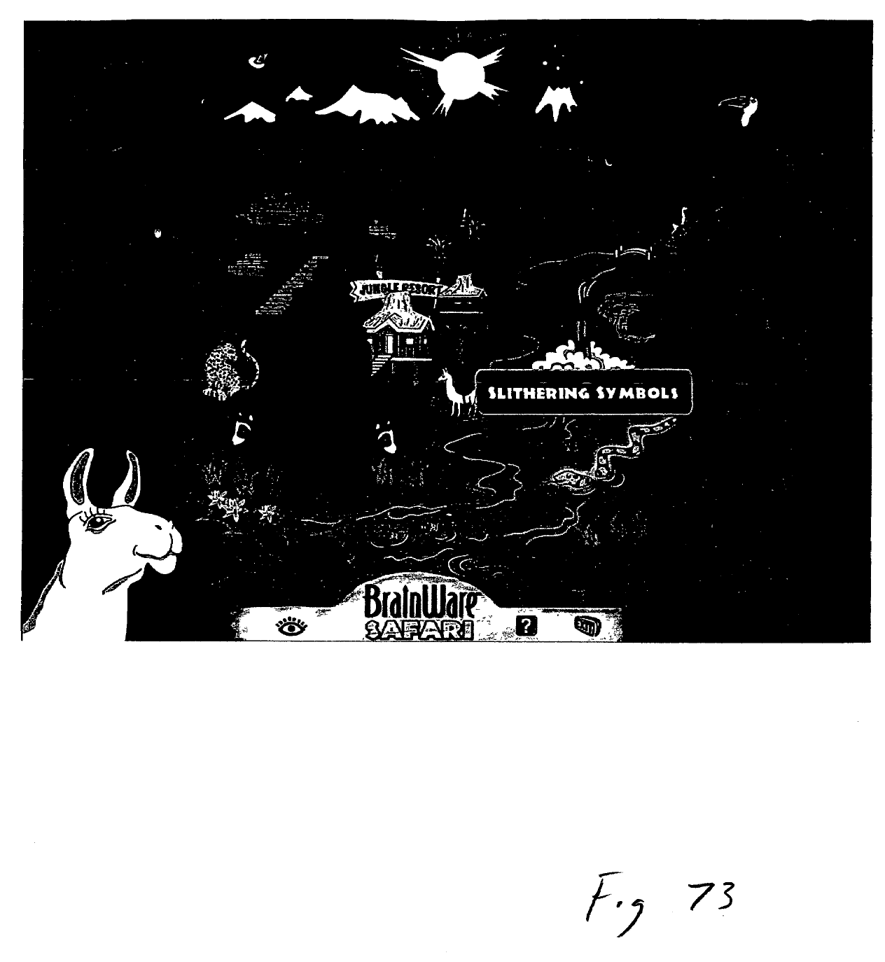

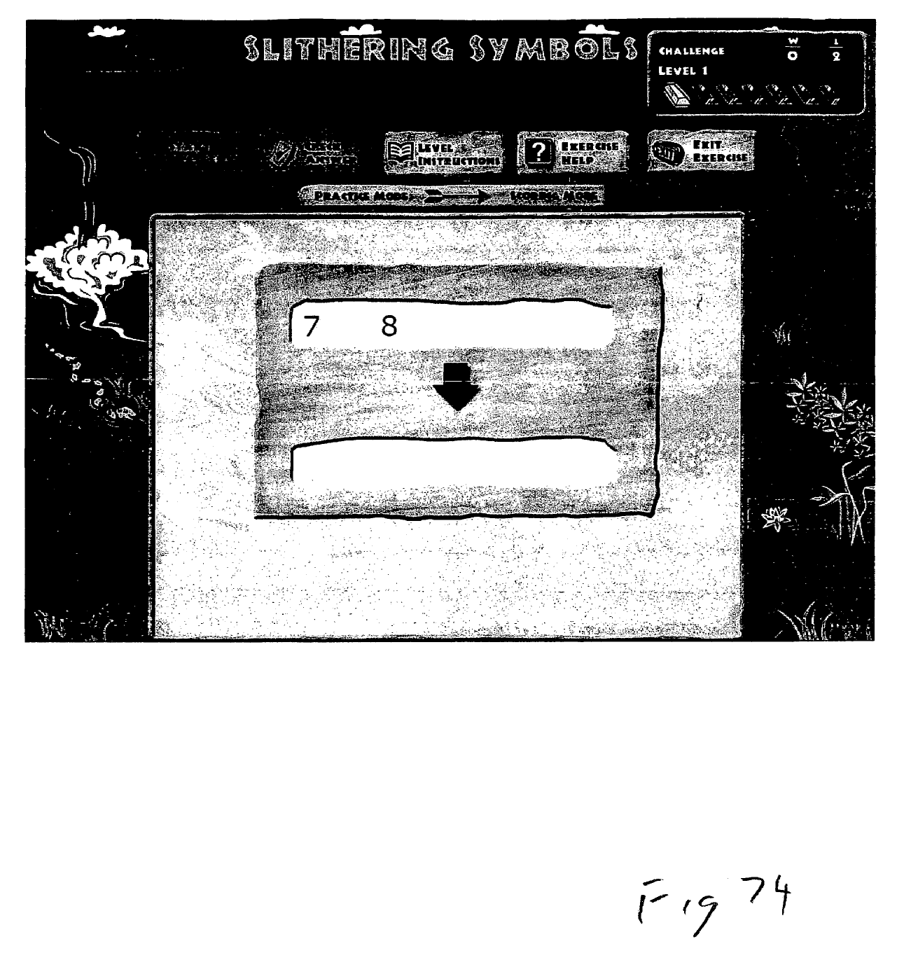

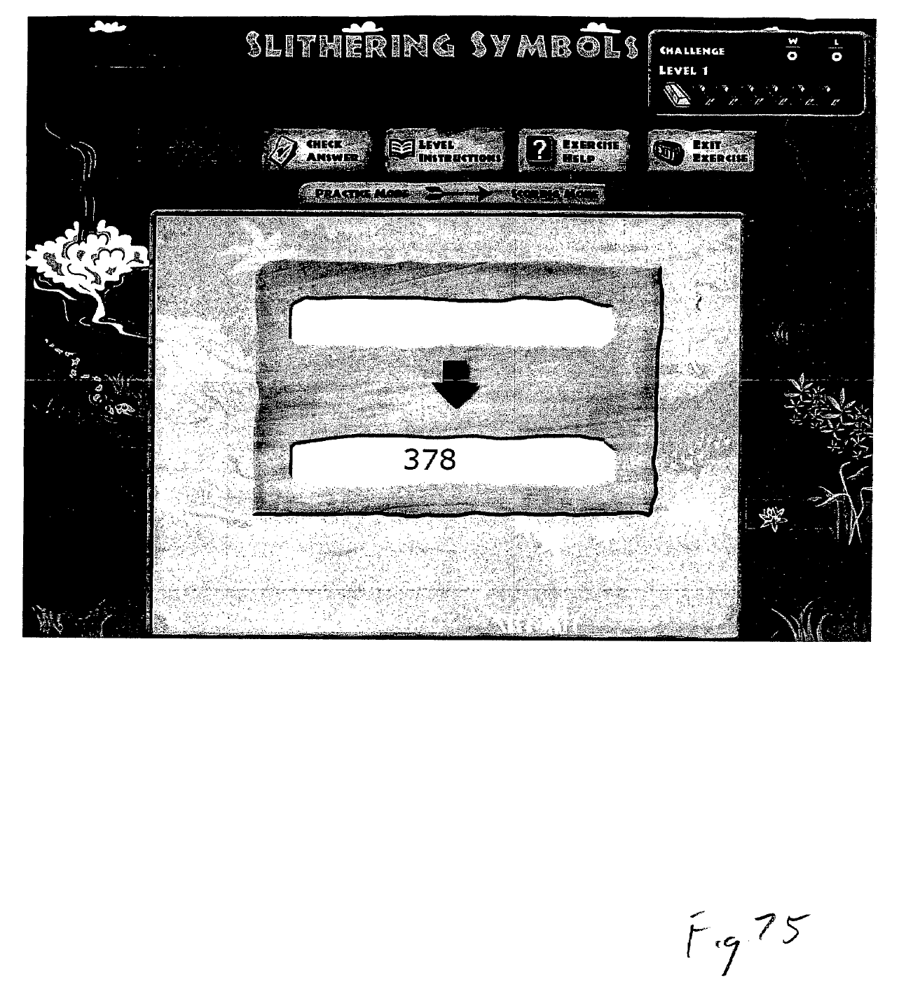

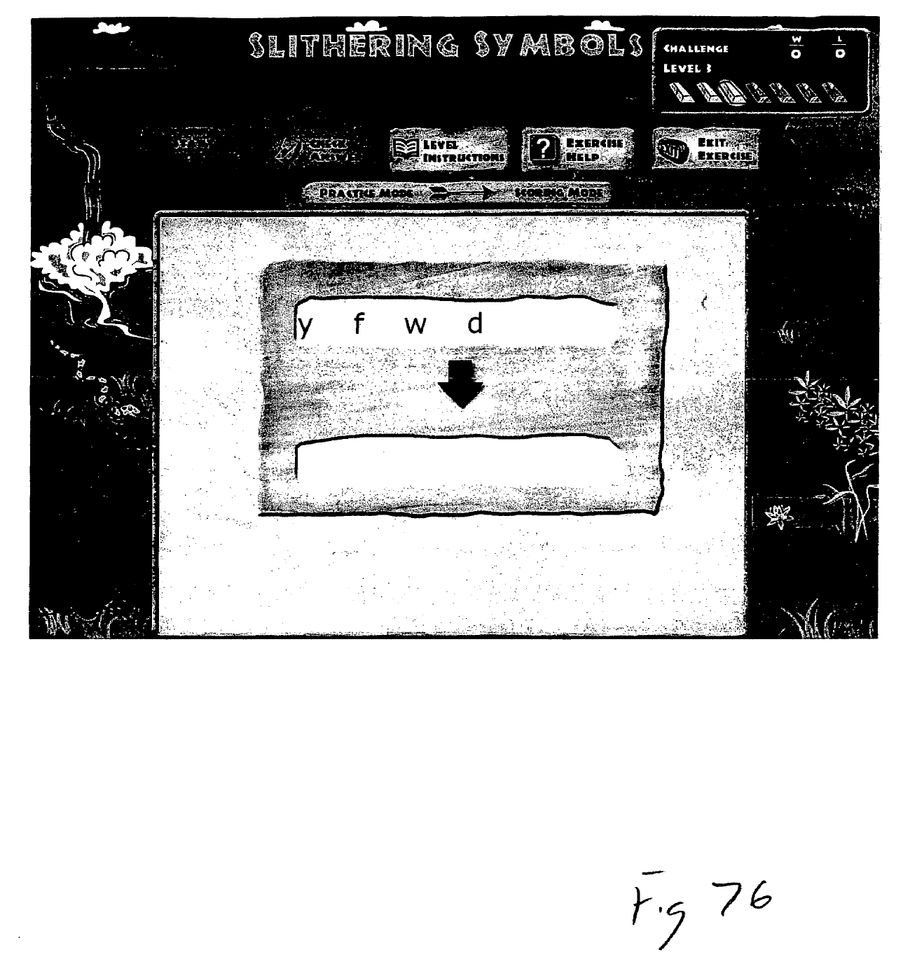

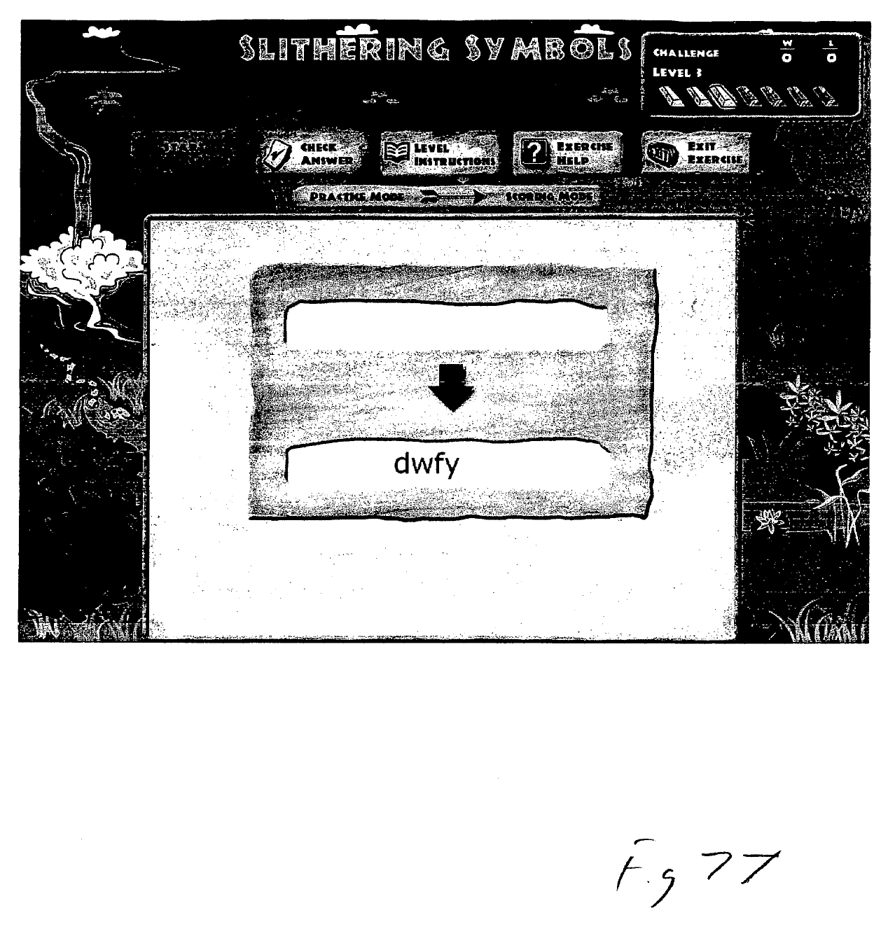

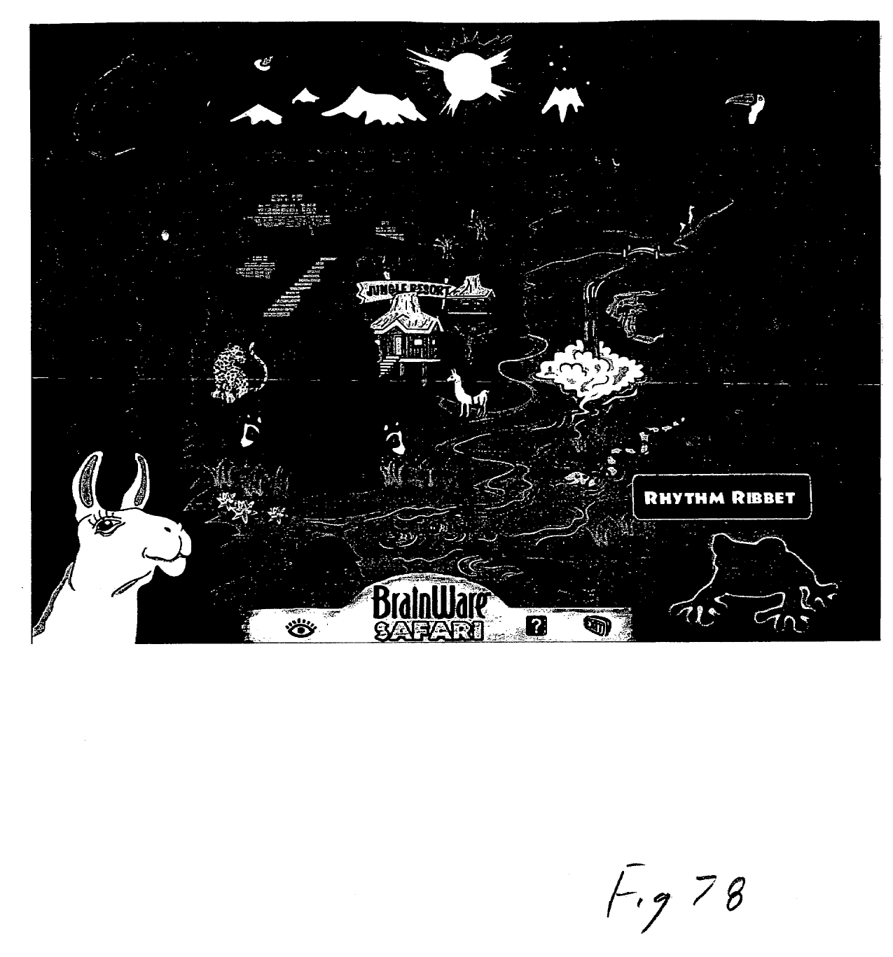

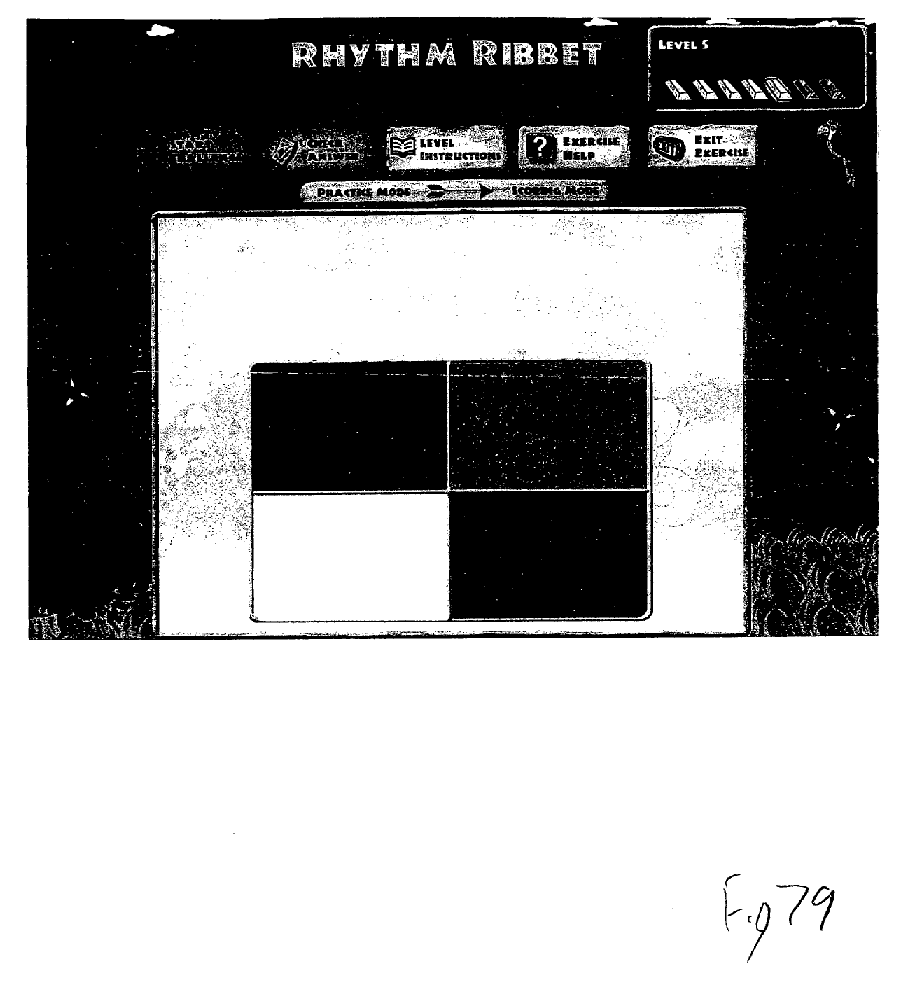

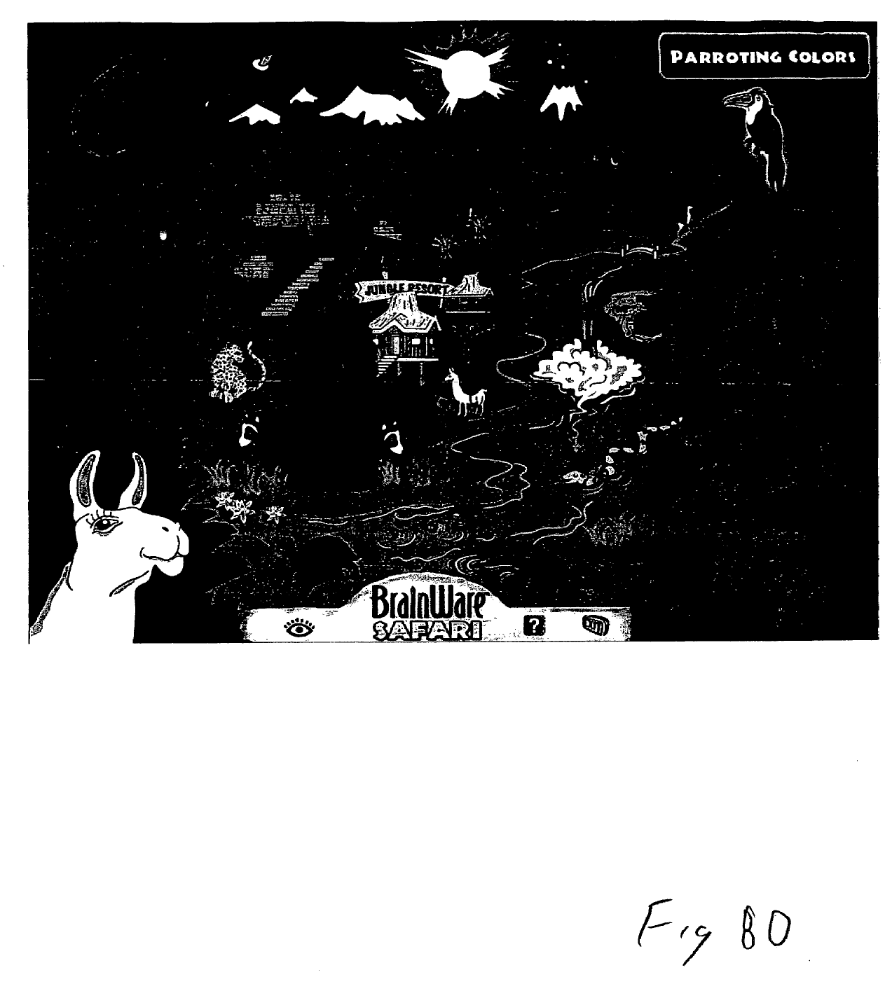

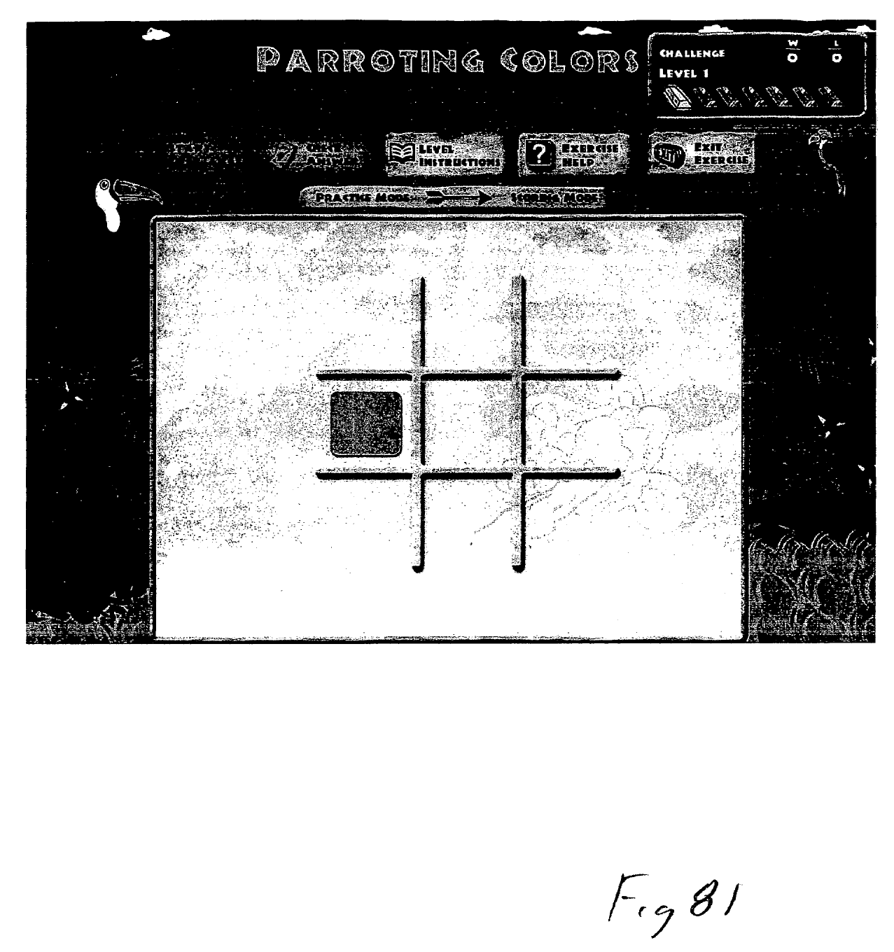

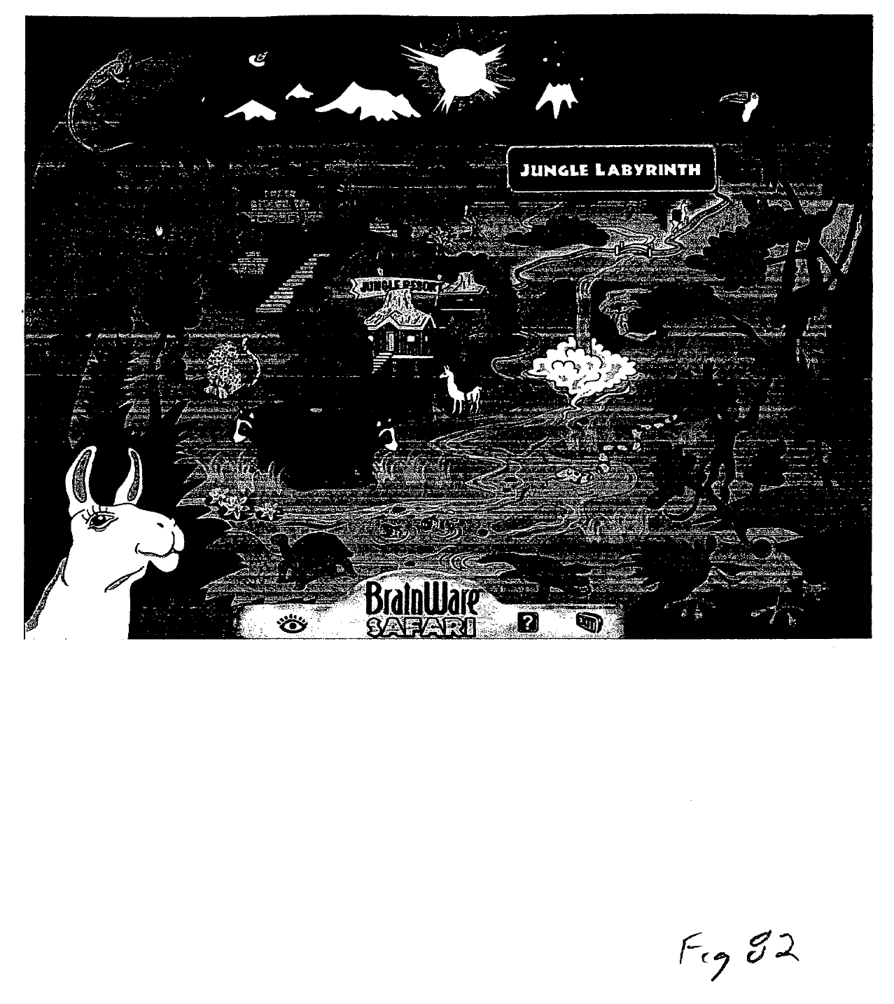

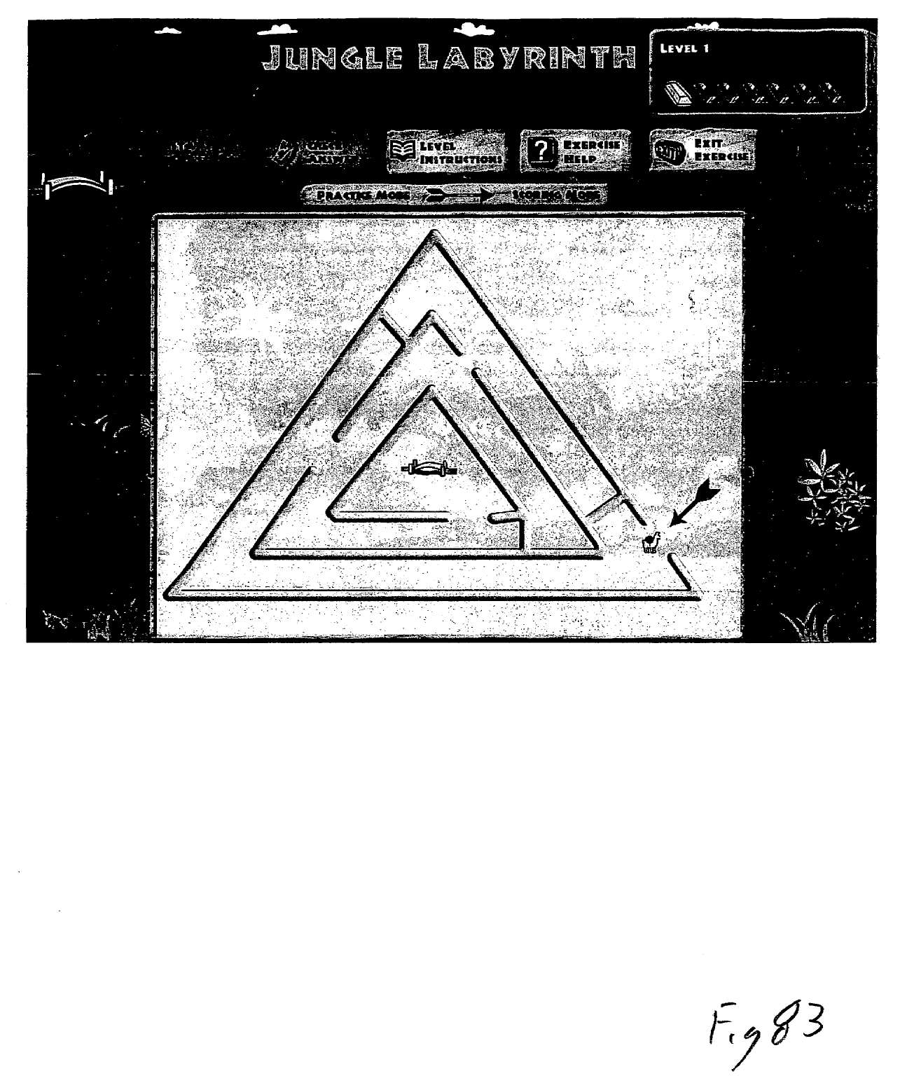

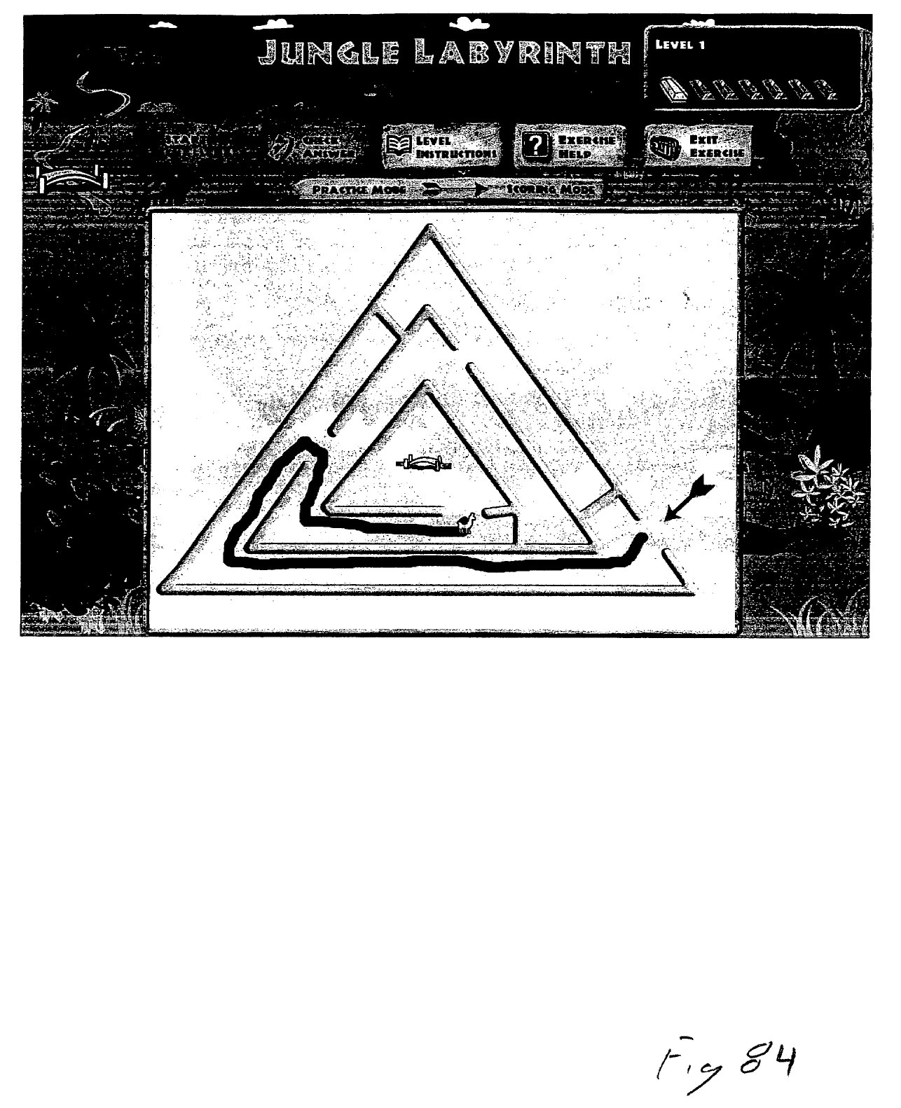

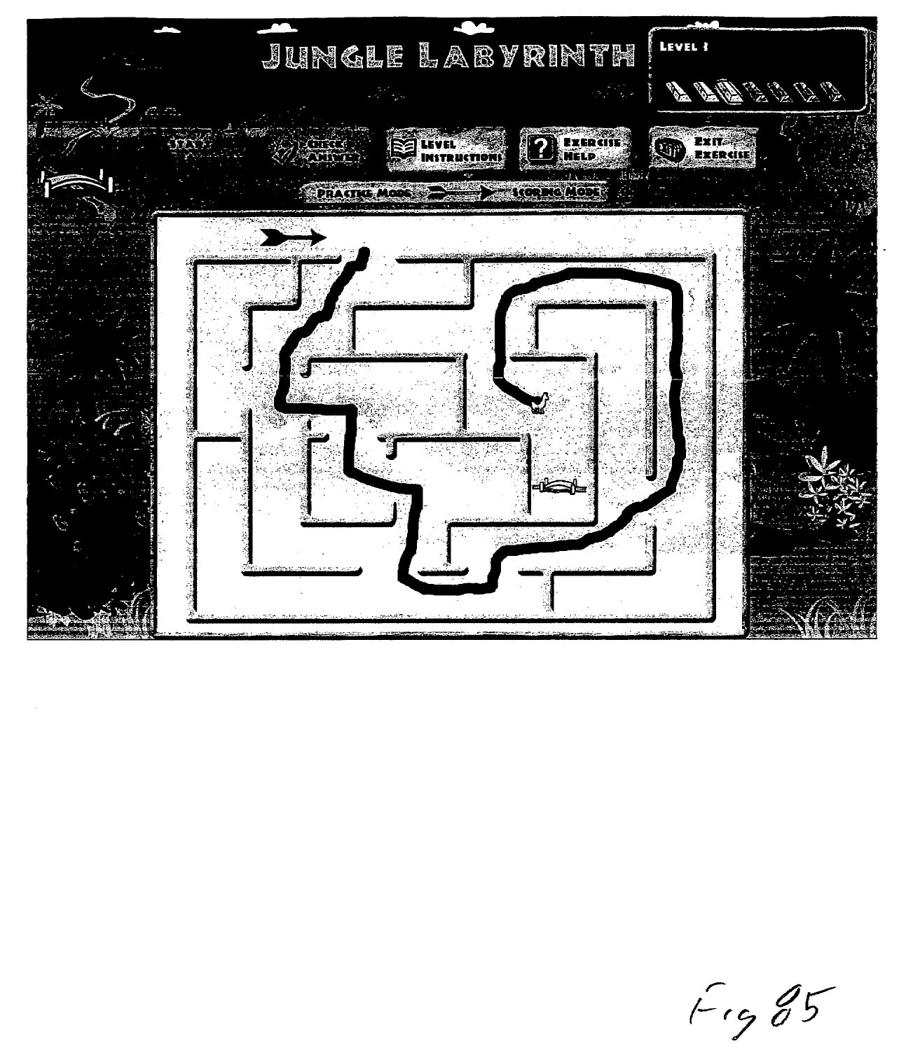

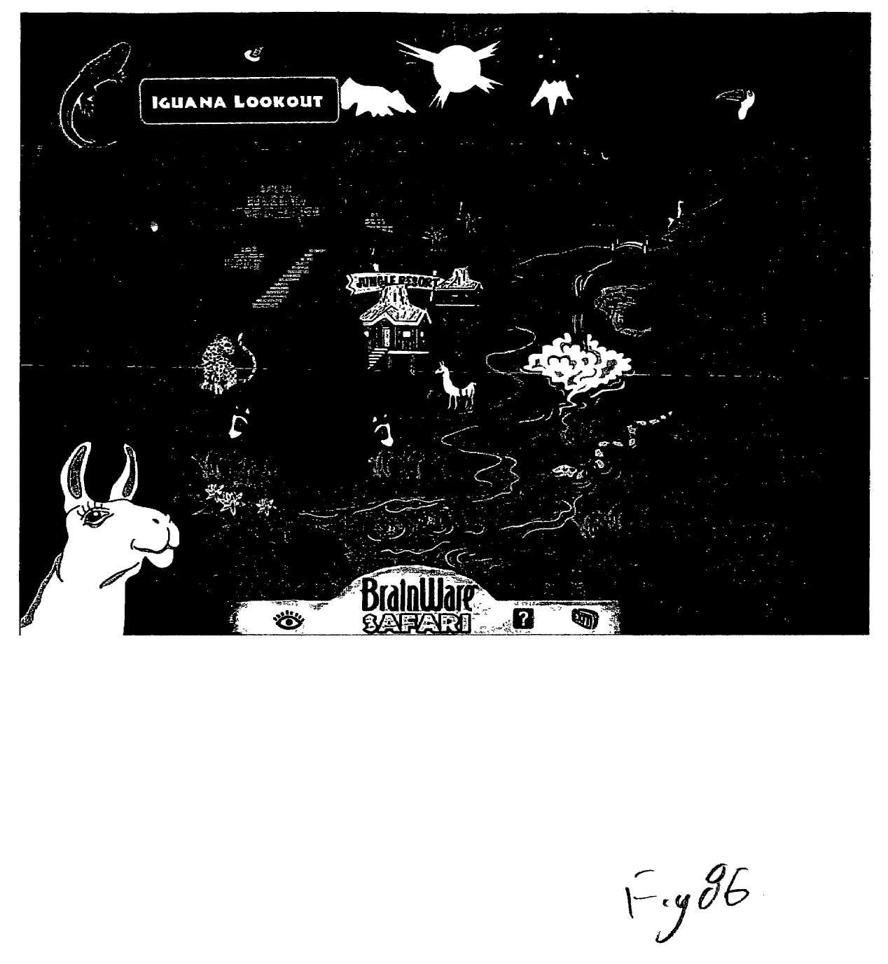

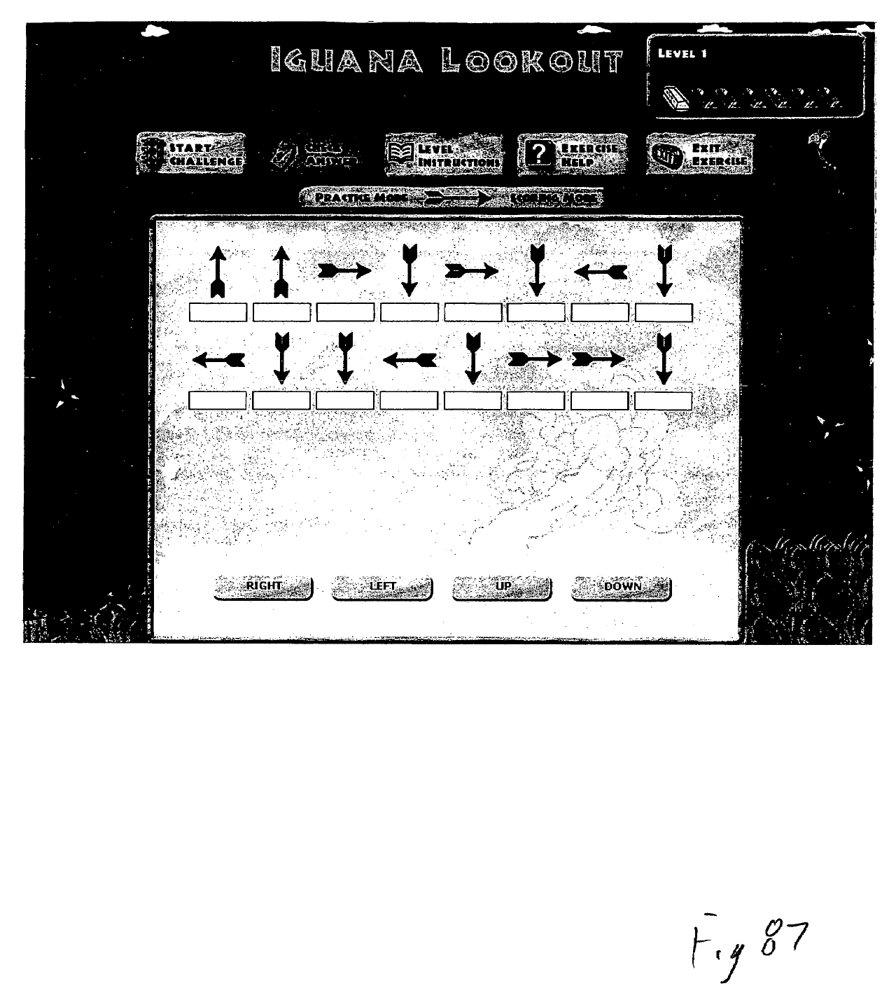

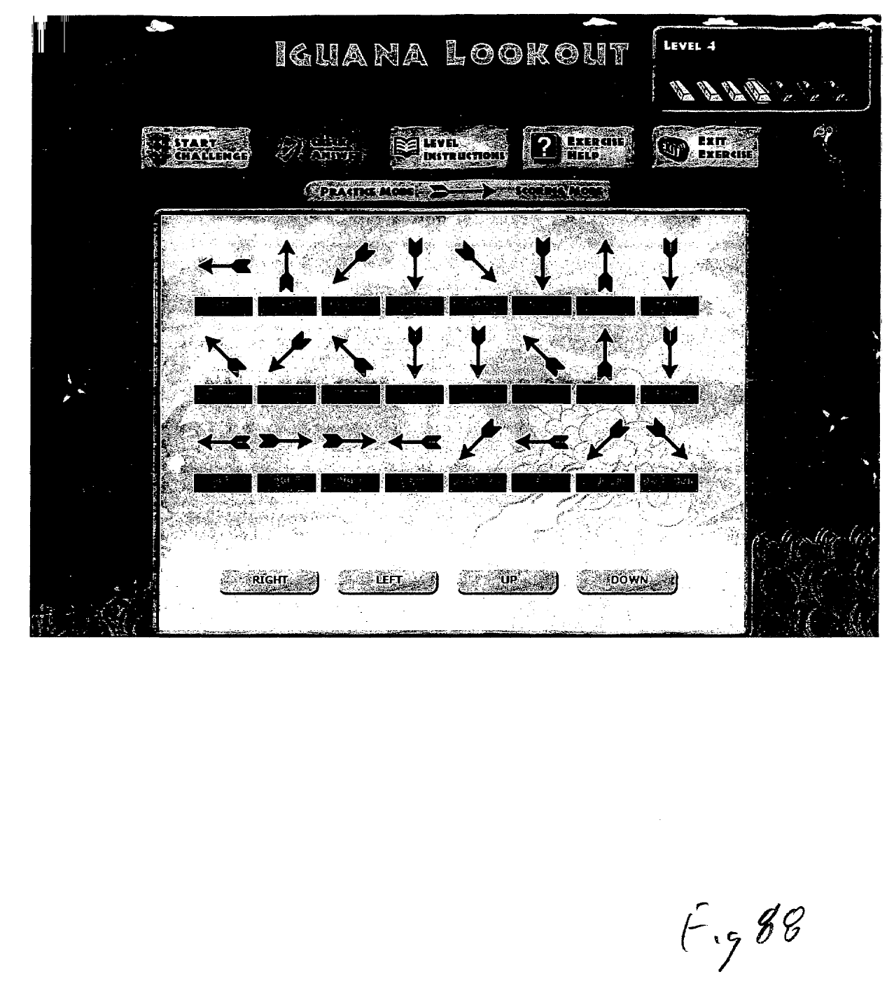

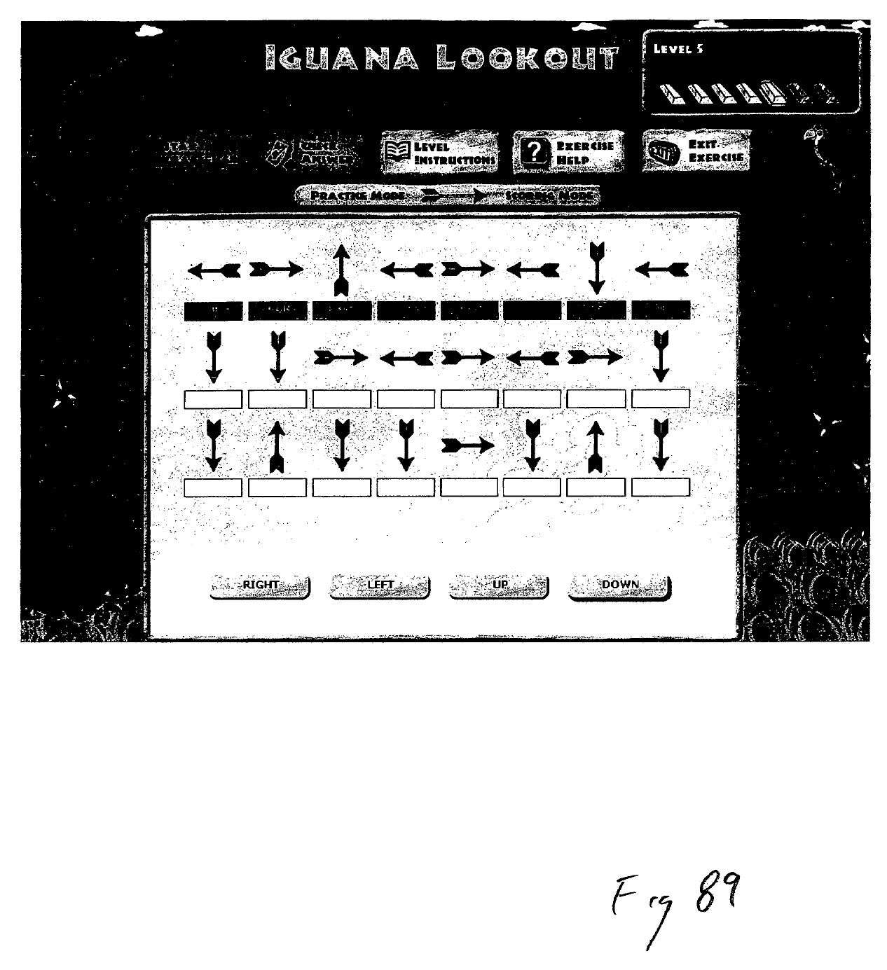

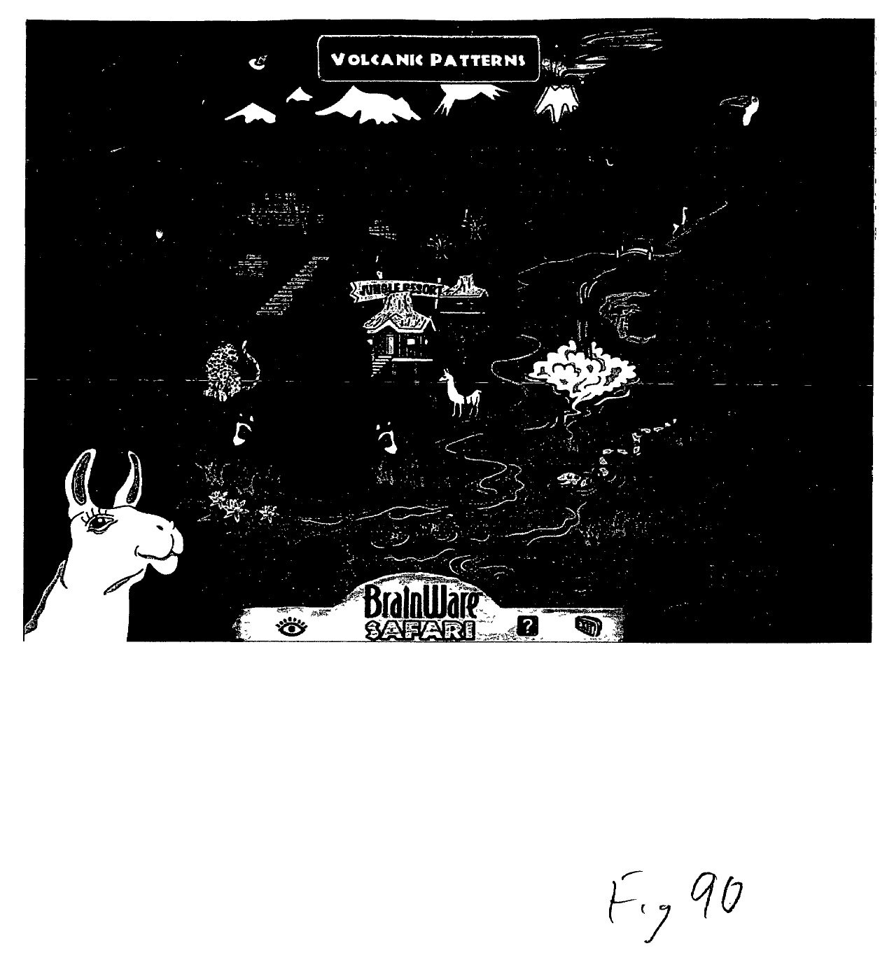

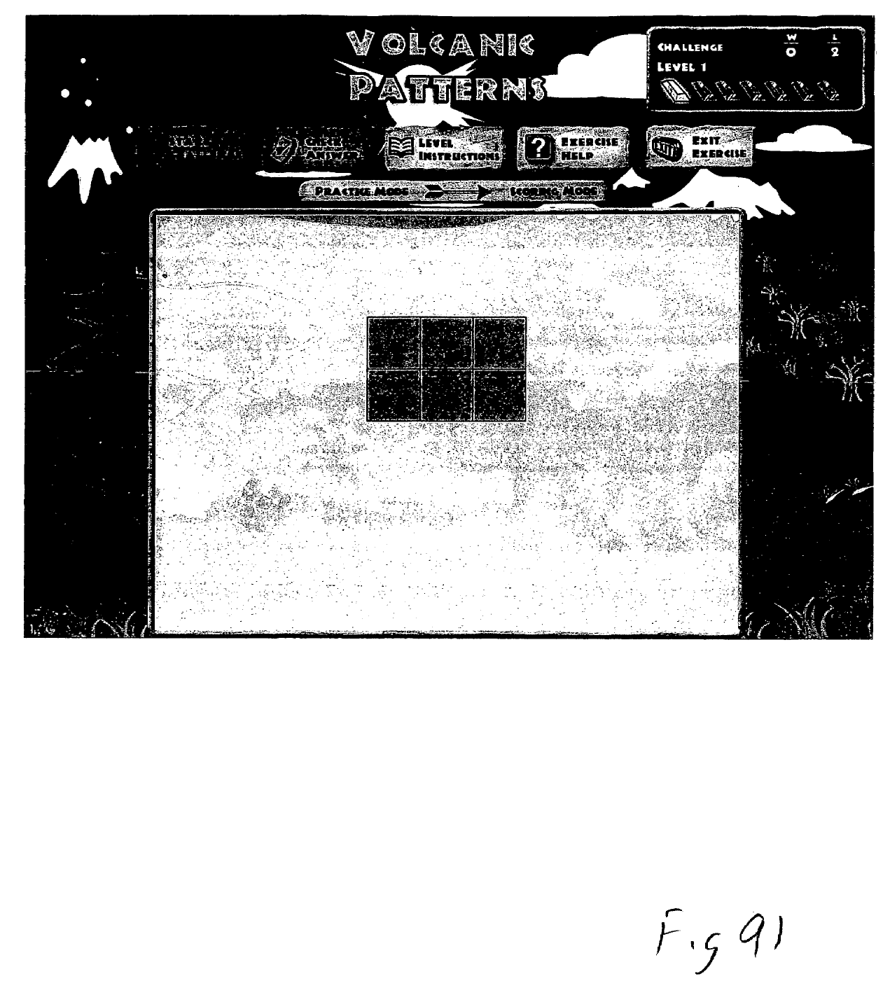

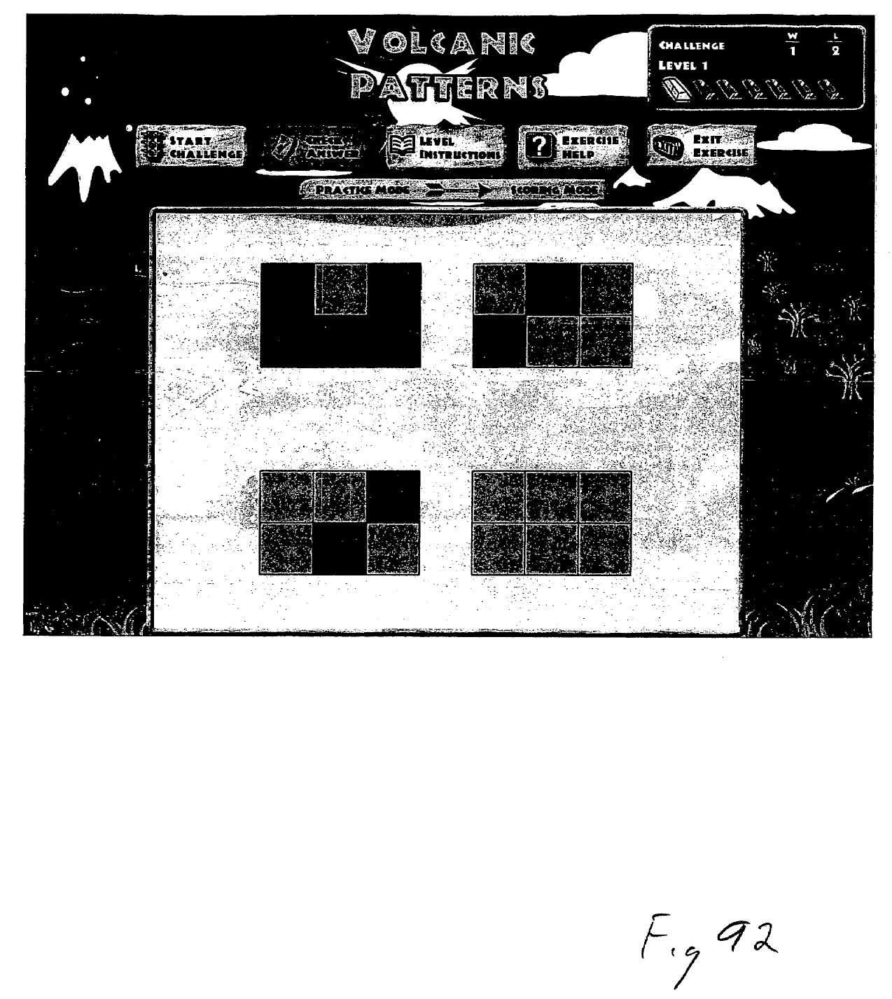

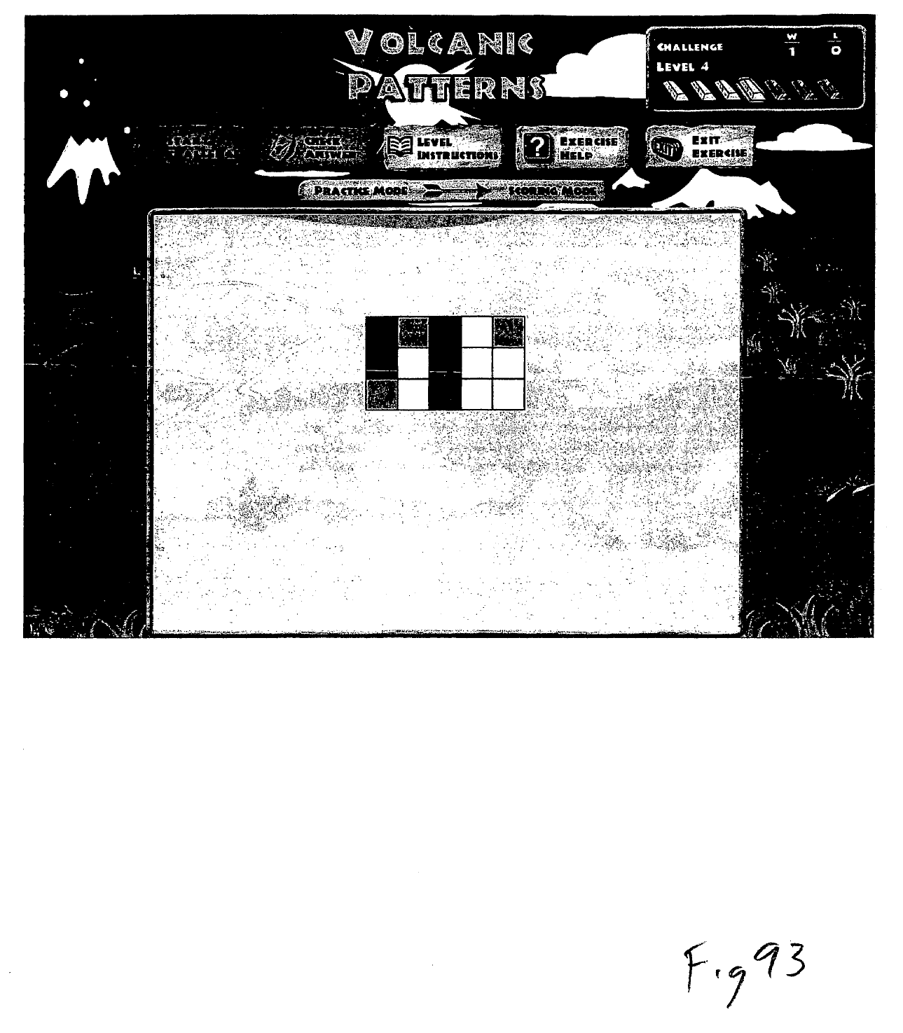

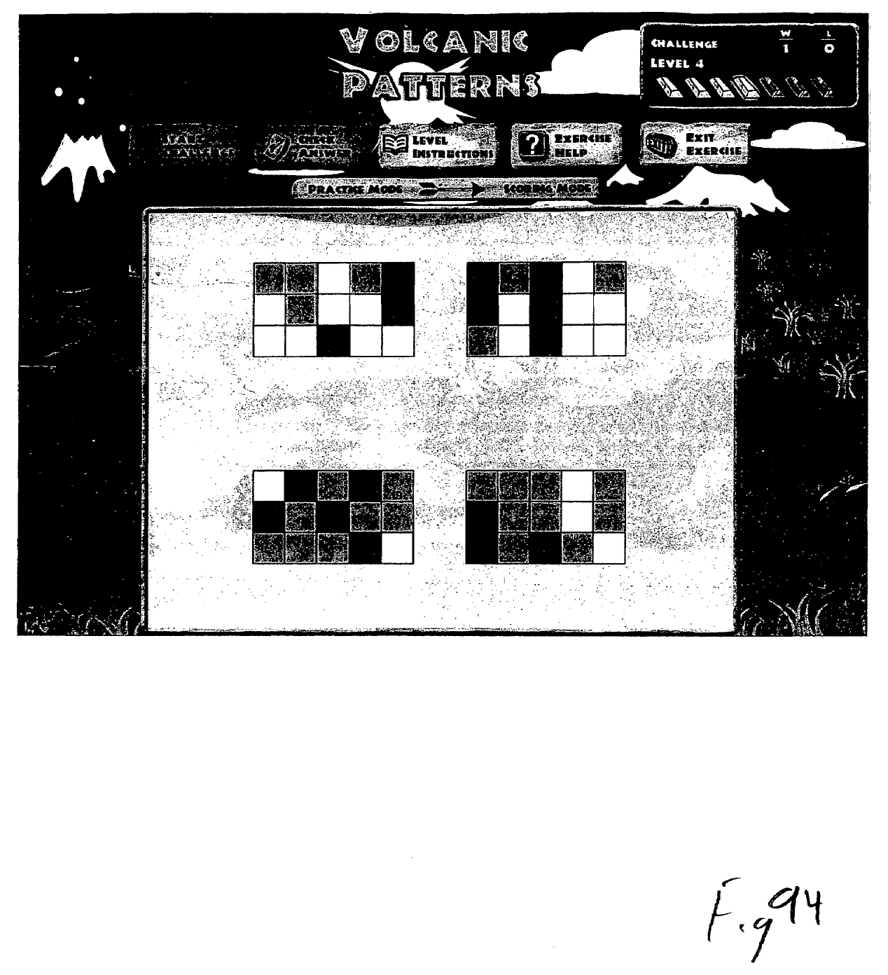

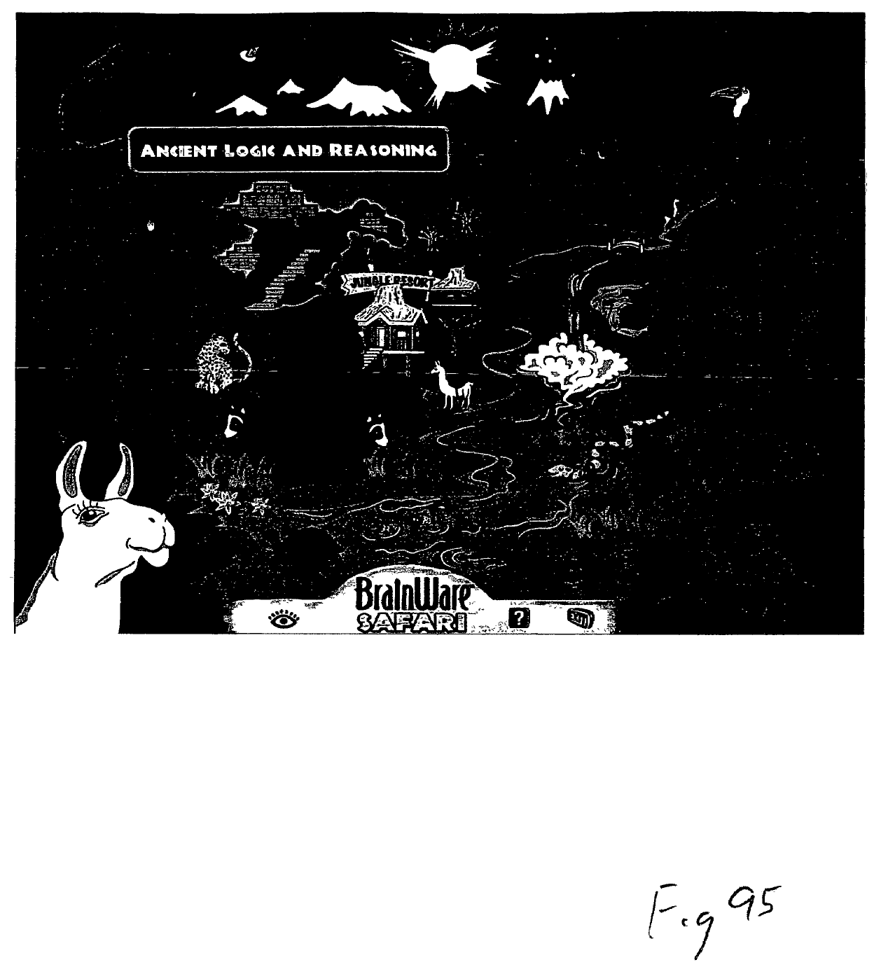

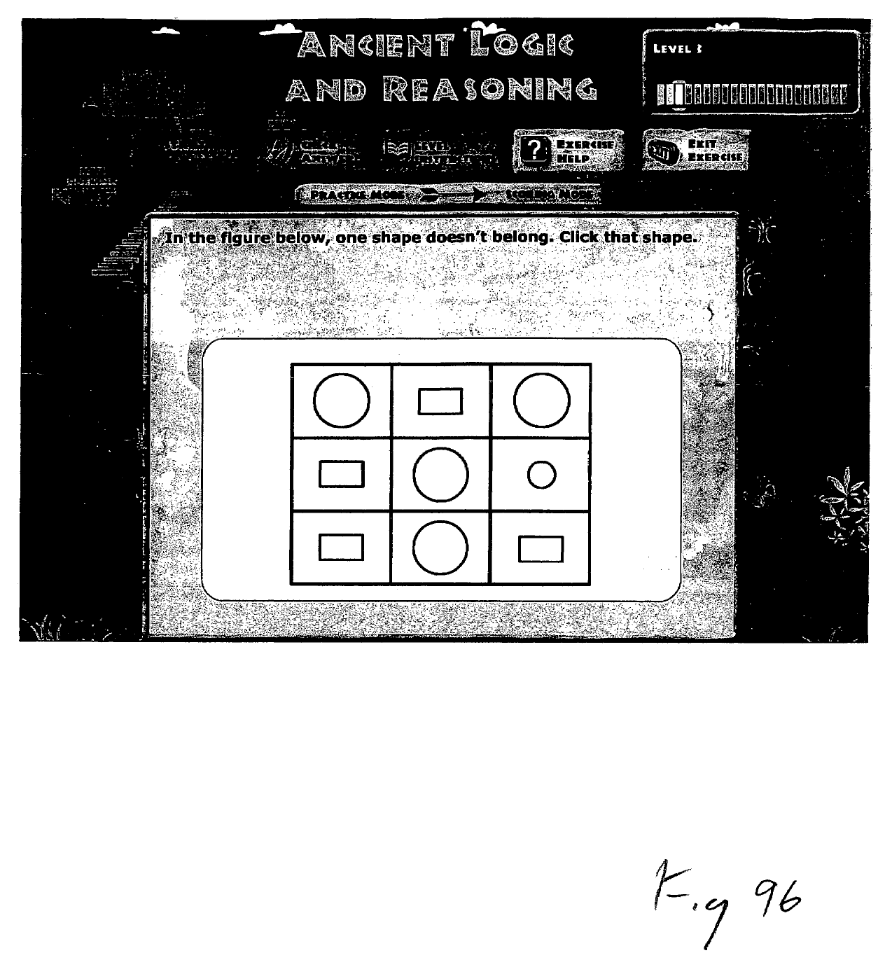

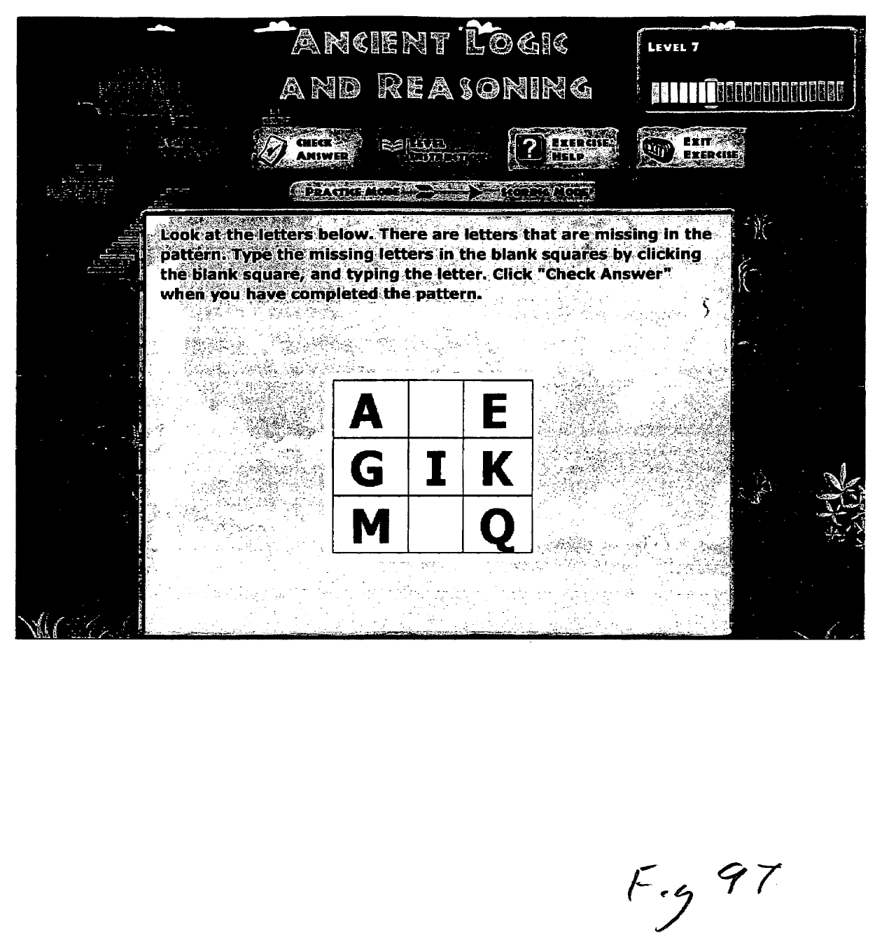

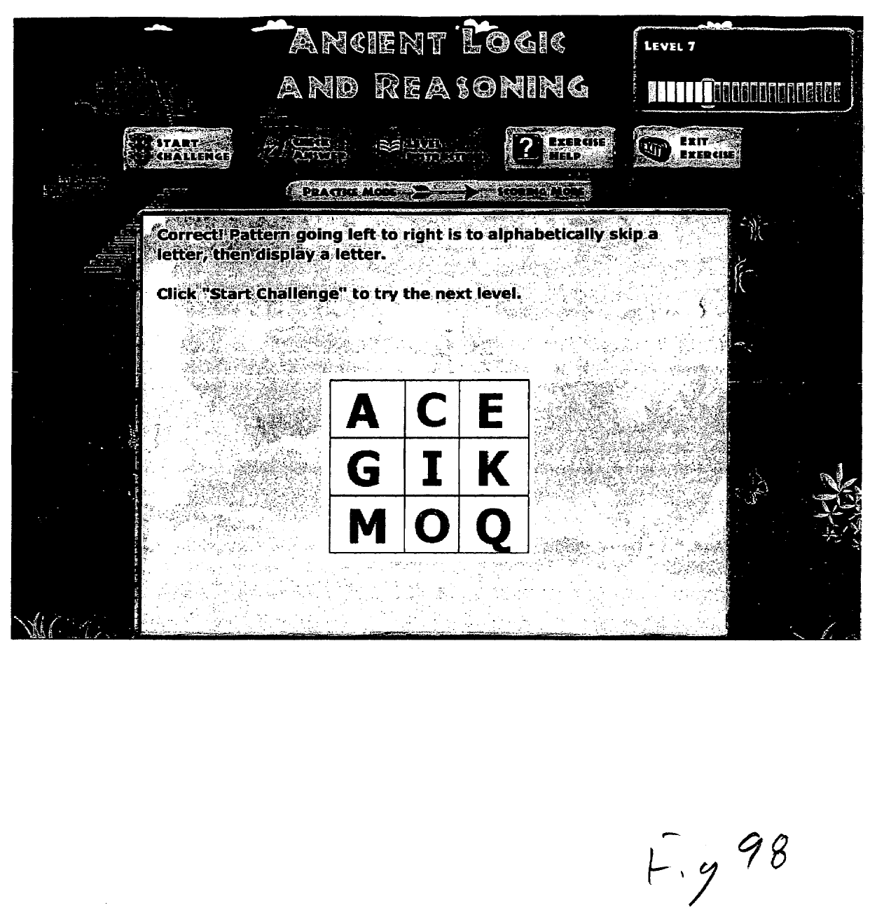

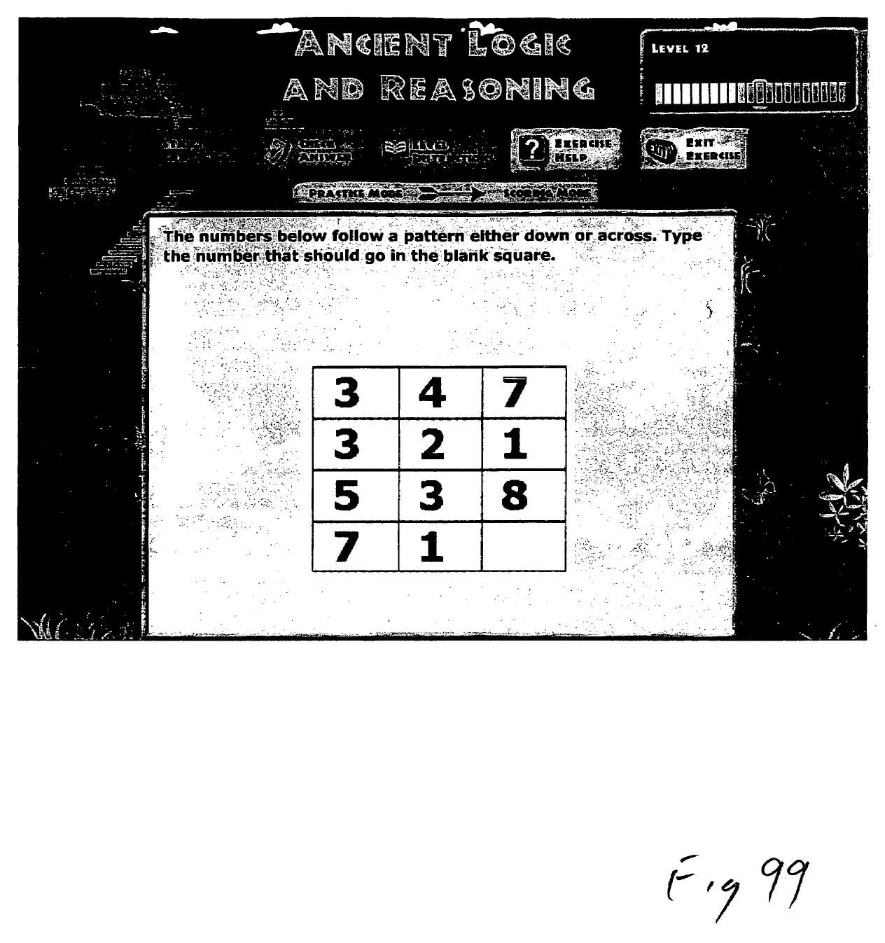

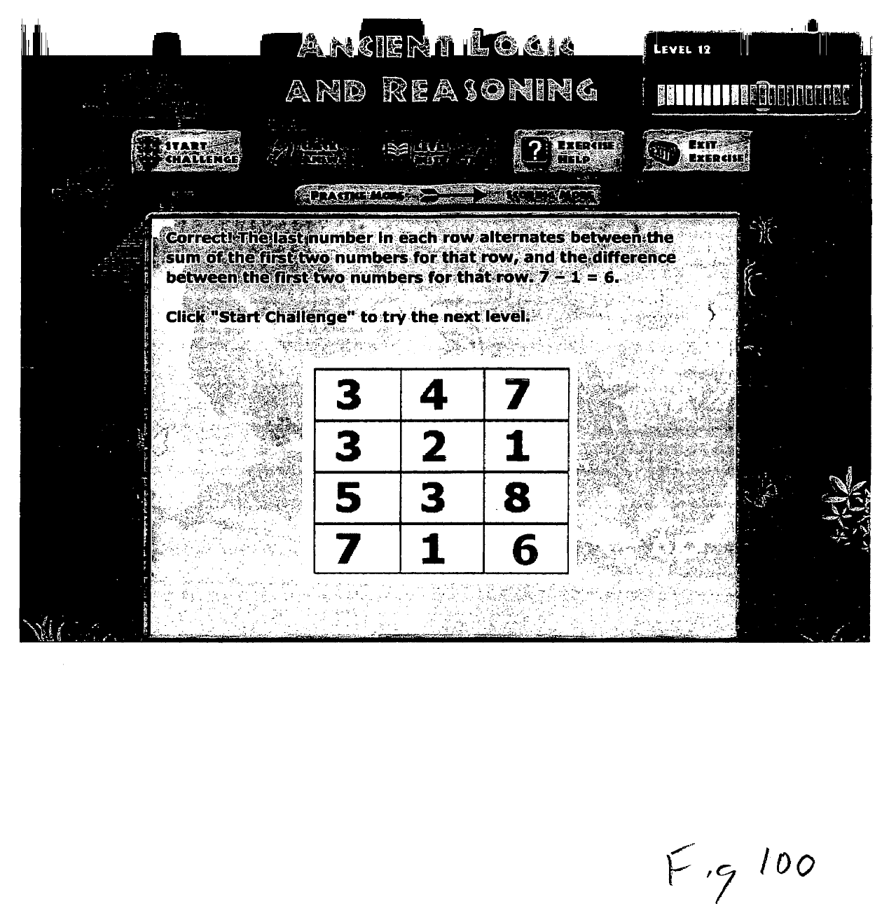

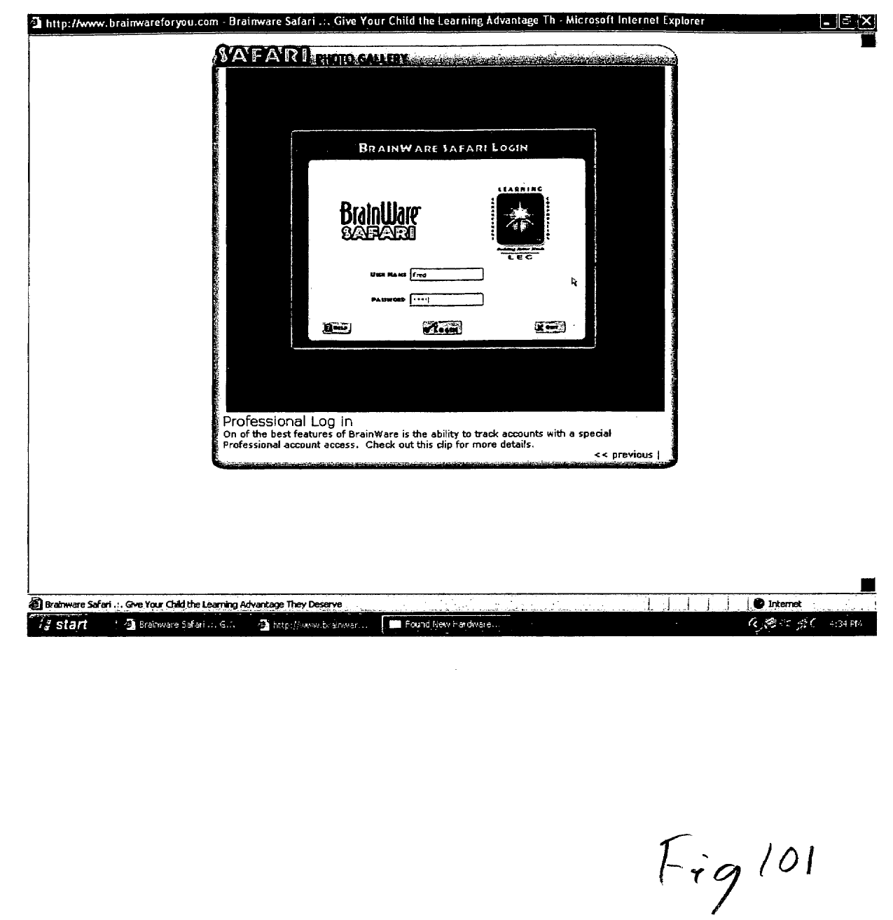

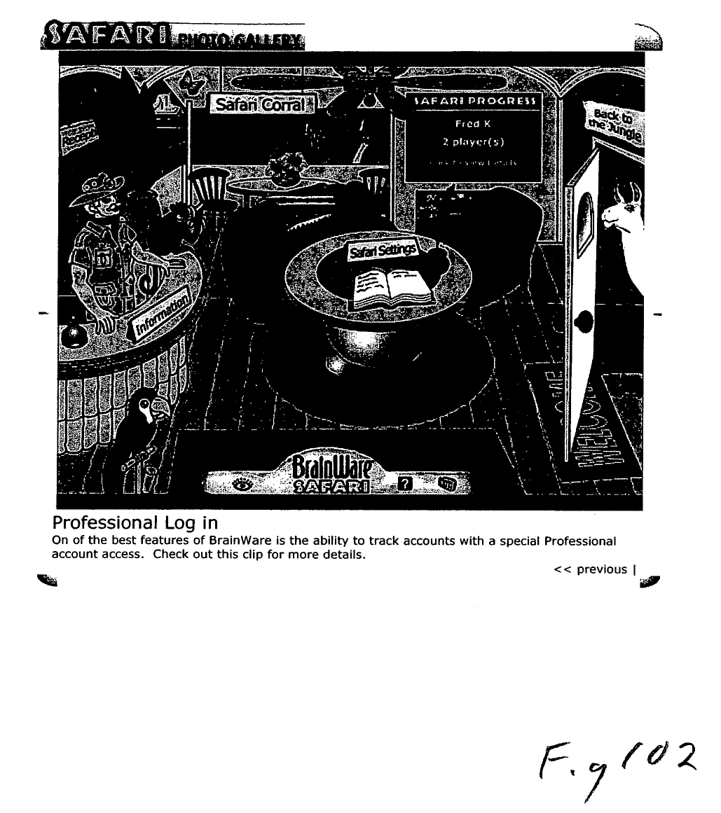

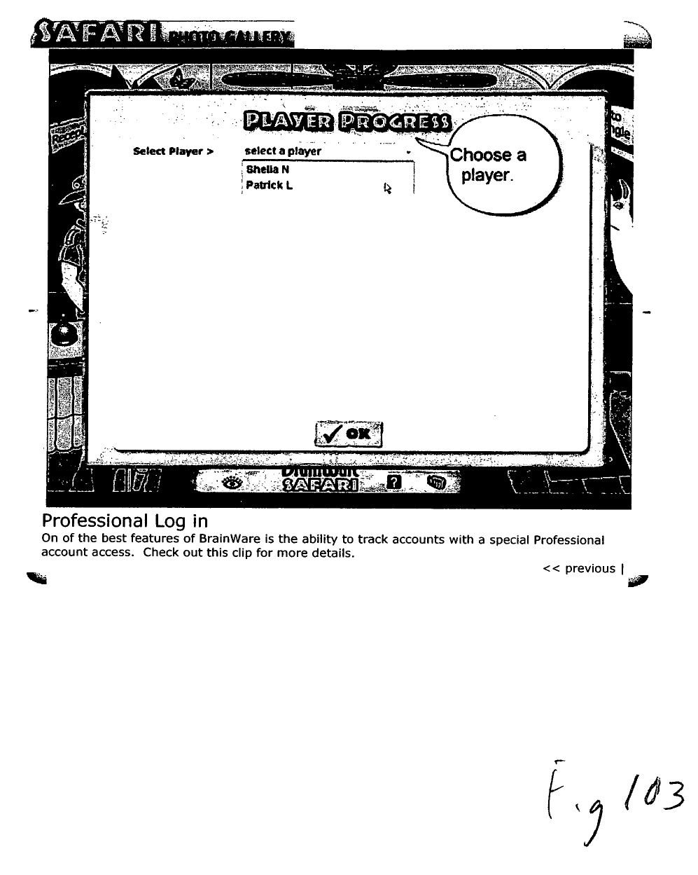

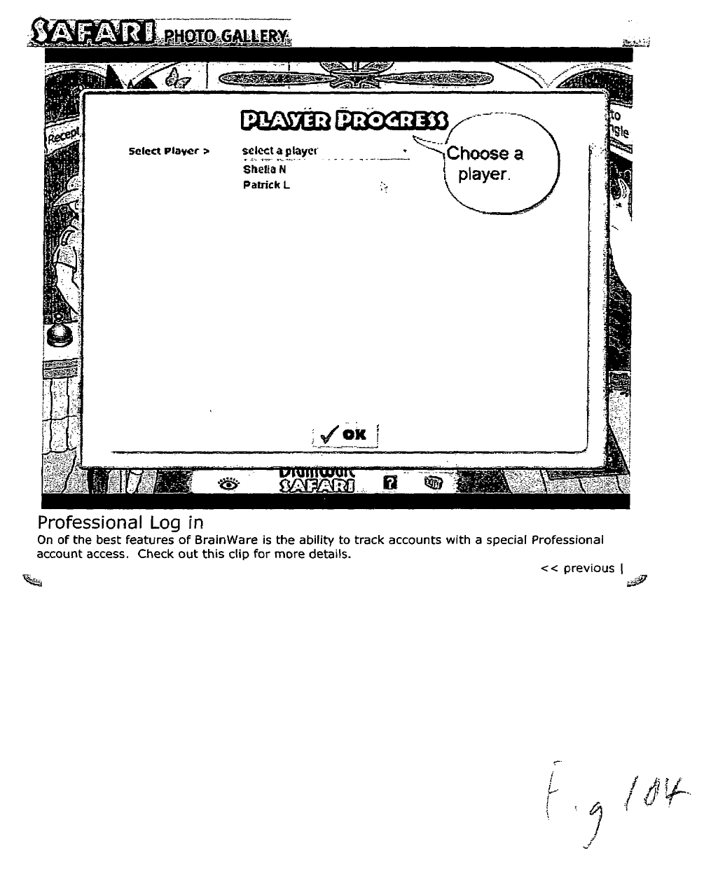

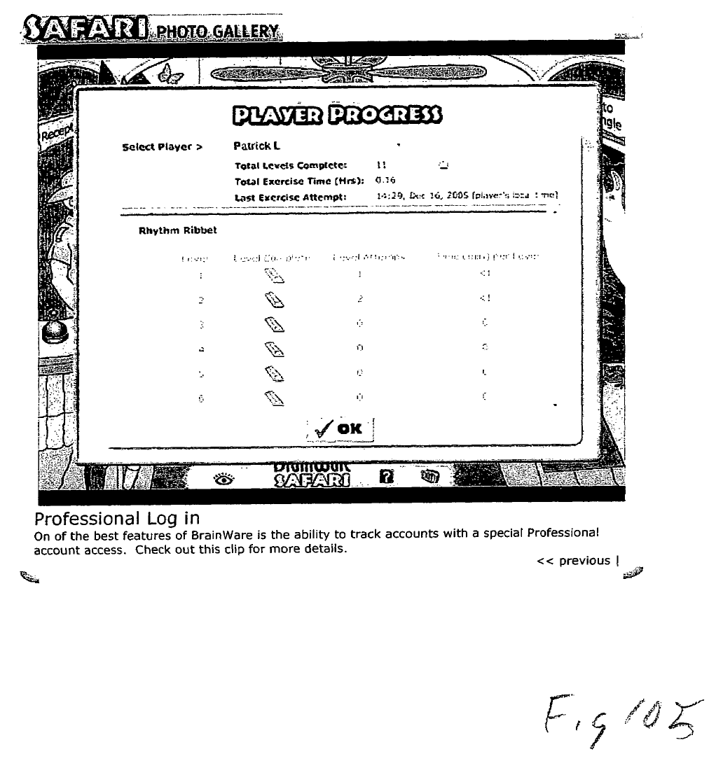

In the cognitive learning video game of the present invention, each player receives a unique username and password. This identification enables the present invention to keep track of the progress of each player, enabling the player to start where the player left off and progress at a suitable pace. Referring to FIG. 3, a log-in screen is seen which requests the user name and a password. After completing the user name and the password, the login button is chosen. In addition, help and quit buttons are provided. Upon successfully logging-in, a homepage that in the described embodiment is a “jungle resort” is accessed, as seen in FIG. 4. The homepage includes as links information, safari control, safari progress, and back to the jungle as well as an “eye spy” that highlights the exercise links, safari control, safari progress, and back to the jungle links, information, and exit buttons.

To initiate the cognitive learning video game of the present invention, the player selects an animated character who will stay with the player throughout their use of the cognitive learning video game. In the described embodiment, the character is an animated jungle animal referred to as a “safari friend”. To select a character, the player links to a character selection page which in the described embodiment is a “safari coral”. The character selection page is seen in FIG. 5. The character selection page displays the animated characters from which the player can choose. In the described example, the animated characters can include “Billy Bear”, “Jackie Jaguar”, “Moby Monkey”, and “Patti Parrot”. The safari corral also includes a link to the homepage. When the curser is placed over each animated character, a pop-up balloon provides detailed information about the character. This is seen for “Billy Bear” in FIG. 6 and for “Jackie Jaguar” in FIG. 7. Once a character is chosen, the choice is confirmed as seen in FIG. 8, and the player links back to the homepage.

As the player progresses through the cognitive learning video game of the present invention, the chosen character grows as the player progresses. Referring to FIG. 9, for example the progressive growth stages of the “Jackie Jaguar” are seen. The character begins in the infant stage which can depict a diaper and baby bottle, then progresses the toddler stage, referred in the described embodiment as the “skateboard” stage, in which the character can be dressed as a skater. Following the toddler stage, the character progresses to the preschool stage, referred in the described embodiment as the “jumping rope” stage, in which can depict a jumping rope. Following the preschool stage, the character progresses to the student stage, referred in the described embodiment as the “school days” stage, in which the character can be dressed as a student. Following the student stage, the character progresses to graduation in which the character can be dressed as a graduate. In the final stage, the character becomes an adult, which can include business attire and a briefcase.

Referring to FIG. 10, the homepage is again seen. To begin play, the player selects the link to the jungle link located near a door to the outside, which links to the play screen which in the described embodiment is a jungle. Referring to FIG. 11, the play screen is seen. By moving the curser over images in the play screen, links are provided to a plurality of themed cognitive exercises. In the described embodiment, these themed cognitive exercises can include “Rhythm Rabbit”, “Whispering Waterfall”, “Bear Shuffle”, “Tree Tic Tack Toe”, “Sky Scanning”, “Jungle Labyrinth”, “Memory Mountain”, “Parroting Colors”, “Cave Comparisons”, “Web Weaving”, “Iguana Lookout”, “Piranha Pass”, “Crocodile Recollection”, “Slithering Symbols”, “Arrow Point Bridge”, “Volcanic Patters”, “Jumping Jaguar Flash”, “Llama Logic”, and “Ancient Logic And Reasoning”, all described in detail below. The play screen also provides a link back to the homepage, in this example a “jungle resort” in the “jungle.”

Each exercise consists of challenges. Some are made up of a single challenge while others are made up of a set of challenges. If an exercise is made up of a set of challenges, the user is required to complete a given percentage of challenges in order to advance to the next level.

Each exercise screen can include several common elements. A level box displays what level the user is on. The level box indicates the number of the current level of the user by highlighting one gold bar for each level up to and including the current level. There is a glow around the gold bar that represents the current level. If an exercise requires the user to complete several challenges in order to pass, the number of challenges won and lost are indicated in the win (“W”) and lost (“L”) columns.

A start challenge button is provided that launches a challenge. A check answer button displays a feedback message box. The feedback informs the user whether the challenge was successfully completed. A level instructions box displays instructions about how to play the current level of the current exercise. An exercise help button displays general information about the elements on the exercise screens. An exit button returns the user to the play screen. A practice mode/scoring mode toggle button enables the user to turn on or off scoring before a challenge is started to practice the challenge. Some challenges do not provide for a practice mode.

In FIG. 11, the curser is placed over a spider which provides a link to the “Web Weaving” themed cognitive exercise. Referring to FIG. 12, initially an instructions page for the themed cognitive exercise is seen. The instructions page provides an overview and level-specific instructions. These are in text, and audio can be provided by selecting a speaker icon. In addition, a skills link provides detailed explanation of the cognitive skills the themed cognitive exercise develops.

The “Web Weaving” themed cognitive exercise particularly develops visual sustained attention, visual selective attention, divided attention, and flexible attention cognitive attention skills; visual simultaneous processing, visualization, and visual processing speed cognitive visual processing skills; visual-motor integration, auditory-motor integration, and timing-rhythm cognitive sensory integration; and visual sensory short-term memory, visual intermediate short-term memory, working memory, and visual special memory cognitive memory skills.

When the user is ready to play, an ok button is selected. For the “Web Weaving” themed cognitive exercise level one, a pattern of a certain number of dots—in this example five—is presented. A first image is shown, as seen in FIG. 13, having up to a limited number of lines connecting the dots, in this example three. After the user selects the start challenge button, the first pattern of lines connecting the dots disappears and a second pattern having the same dot configuration appears, as seen in FIG. 14. Using the spider as a curser, the user attempts to draw the pattern to match the pattern of the first image, as seen in FIG. 15. An erase button is provided for the user to change his or her mind. When satisfied with the pattern, as seen in FIG. 16, the user selects the check answer button and, if successful, a challenge passed pop-up window is presented as seen in FIG. 17. To pass the level, a certain number of successful exercises must be completed—in this example seven out of ten. A score box displays the number of successful exercises.

The themed cognitive exercises of the cognitive learning video game of the present invention place repetitive demands on deficient functions and present increasing levels of difficulty. Demands are placed in an integrated approach referred to as “cognitive loading.” Thus, the “Web Weaving” themed cognitive exercise includes multiple levels of increasing difficulty. Referring to FIGS. 18-20, level four of the “Web Weaving” themed cognitive exercise is seen. Again, as with level one a pattern of a certain number of dots—in this example five—is presented. A first image is shown, as seen in FIG. 18 having up to a limited number of lines connecting the dots, in this level four example, four. After the user selects the start challenge button, the first pattern disappears and a second pattern having the same dot configuration appears. The user draws the pattern to match the pattern of the first image, as seen in FIG. 19. When completed, the user selects the check answer button and, if successful a challenged passed pop-up window is presented. When the user has completed a certain number of successful exercises—in this example seven out of ten—a level passed pop-up window is presented, as seen in FIG. 20.

Since every player has strengths and weaknesses, some exercises will be relatively easy for certain individuals but difficult for others. As the player progresses through the exercises and levels, weak skills are developed to greater levels of capacity and efficiency, and strong skills are further strengthened. In this sense the cognitive learning video game of the present invention is self-pacing, by requiring more time and intensity for exercises that target skills that are weakest for the individual user.

Referring to FIGS. 21-25, the “Tree Tic Tac Toe” themed cognitive exercise is seen. The “Tree Tic Tac Toe” themed cognitive exercise particularly develops visual sustained attention, visual selective attention, divided attention, and flexible attention cognitive attention skills; directionality, visualization, and visual processing speed cognitive visual processing skills; visual-motor integration, auditory-motor integration, and timing-rhythm cognitive sensory integration; and visual sensory short-term memory, visual intermediate short-term memory, working memory, and visual special memory cognitive memory skills.

In FIG. 21, the curser is placed over a monkey hanging from a tree which provides a link to the “Tree Tic Tac Toe” themed cognitive exercise. After an instructions page as seen in FIG. 22 is seen, a traditional Tic Tac Toe game played against the cognitive learning video game is presented, as seen in FIG. 23. In the “Tree Tic Tac Toe” themed cognitive exercise, the user moves to the next level with six wins or ties out of 10.

Again, the “Tree Tic Tac Toe” themed cognitive exercise places repetitive demands on deficient functions and presents increasing levels of difficulty by “cognitive loading.” Referring to FIGS. 24-26, level four of the “Tree Tic Tac Toe” themed cognitive exercise is seen. In level four, three three-by-three matrixes are provided, as seen in FIG. 24. The user is required to visualize each three-by-three matrix on top of each other as a single game. The user alternates matrixes for each play. The first move is on the first matrix, the second play is on the second matrix, and so on. Thus, in FIG. 25, the user has completed three plays, which are seen in this example as the three “X's”, one on each matrix, while the cognitive learning video game has competed two plays, seen in this example as the two “O's”. When three X's or O's align across the three matrixes on top of each other or when all the squares in the three matrixes on top of each other have been completed to a draw, as seen in FIG. 26, the game is complete. Again, the user moves to the next level with six wins or ties out of 10.

Referring to FIGS. 27-32, the “Whispering Waterfall” themed cognitive exercise is seen. The “Whispering Waterfall” themed cognitive exercise develops auditory selective cognitive attention skills; visualization cognitive visual processing skills; auditory-motor integration and timing-rhythm cognitive sensory integration; auditory discrimination, auditory sequential processing, and auditory processing speed cognitive auditory processing; and auditory sensory short-term memory, auditory intermediate short-term memory, and working memory cognitive memory skills.

In FIG. 27, the curser is placed over a waterfall which provides a link to the “Whispering Waterfall” themed cognitive exercise. Referring to FIG. 28, initially an instructions page for the “Whispering Waterfall” themed cognitive exercise is seen. The instructions page provides an overview and level specific instructions. These are provided in text and audio can be listened to by selecting the speaker icon. In level one of the “Whispering Waterfall” themed cognitive exercise a number of letters are heard, in this example three. A beat is provided. To the beat, the “click here” button seen in FIG. 29 is clicked a given number of times, in this example five. Following the final beat, to successfully complete the task the user types the letters in the order recited. In the example set forth in FIG. 30, the letters “p”, “k”, and “o” were recited in order, the “click here” button was clicked five times on the beat, and the letters “p”, “k”, and “o” were typed in order, successfully completing the task as seen in FIG. 31. In the “Whispering Waterfall” themed cognitive exercise, the user moves to the next level with seven out of 10.

Again, the “Whispering Waterfall” themed cognitive exercise places repetitive demands on deficient functions and presents increasing levels of difficulty by “cognitive loading.” For example, in level four letter and number are recited, the “click here” button seen is clicked a given number of times, and the letters are typed in alphabetical order followed by the numbers in numerical order. In the example set forth in FIG. 32, the numbers “9”, “7”, “2” and the letter “j” were recited in that order, the “click here” button was clicked five times on the beat, and to successfully complete the task, the user types the letter “j” first followed by the numbers “2”, “7”, and “9” in order.

As previously described, the “jungle resort” homepage includes as a link safari control. Referring to FIG. 33, the “jungle resort” homepage is seen updated for the number of levels the user has completed. The “jungle resort” homepage includes the number of levels needed to be completed for the character's next growth. By selecting the safari progress link, a scoring information pop-up is seen, as seen in FIG. 34. The scoring information pop-up lists the progress of the user through the themed cognitive exercises, using in this example a bar chart using gold bars. The gold bars represent those areas that have been completed while grey bars display those areas that have yet to be completed. A scroll bar is provided to view additional themed cognitive exercises. Upon completion of the review, the user can return to the “jungle resort” homepage by selecting “OK”.

Referring to FIGS. 35-40, the “Arrow Point Bridge” themed cognitive exercise is seen. The “Arrow Point Bridge” themed cognitive exercise develops visual sustained attention and visual selective attention cognitive attention skills; directionality, visual span, visual simultaneous processing, visual sequential processing, visualization, and visual processing speed cognitive visual processing skills; auditory-motor integration and timing-rhythm cognitive sensory integration; and visual sensory short-term memory, visual intermediate short-term memory, visual sequential memory and visual simultaneous memory cognitive memory skills.

In FIG. 35, the curser is placed over a bridge which provides a link to the “Arrow Point Bridge” themed cognitive exercise. After an instructions page for the “Arrow Point Bridge” themed cognitive exercise is seen, in level one a number of arrows flash as seen in FIG. 36, in this example two. A beat is provided. To the beat, the “click here” button seen in FIG. 37 is clicked a given number of times, in this example five. To successfully complete the task, following the final beat, the user selects the direction the arrows were pointed, as seen in FIG. 38, with “r” designating right, “u” designating up, “l” representing left, and “d” representing down. Again, the “Arrow Point Bridge” themed cognitive exercise places repetitive demands on deficient functions and presents increasing levels of difficulty by “cognitive loading.” For example, in level six a given number of arrows are flashed as seen in FIG. 39, in this example three, the “click here” button is clicked a given number of times, and the user must rotate the arrows to the right 90° in their head and select the rotated direction, as seen in FIG. 40.

Referring to FIGS. 41-43, the “Memory Mountain” themed cognitive exercise is seen. The “Memory Mountain” themed cognitive exercise develops visual sustained attention, visual selective attention, divided attention, and flexible attention cognitive attention skills; visual discrimination, visual form consistency, visual simultaneous processing, visualization, and visual processing speed cognitive visual processing skills; auditory-motor integration and timing-rhythm cognitive sensory integration skills; visual sensory short-term memory, visual intermediate short-term memory, working memory, visual special memory, and visual simultaneous memory cognitive memory skills; and visual thinking cognitive thinking skill.

In FIG. 41, the curser is placed over a mountain which provides a link to the “Memory Mountain” themed cognitive exercise. After an instructions page for the “Memory Mountain” themed cognitive exercise is seen, in level one a pattern of a given number of “X's” is displayed in a three-by-three matrix for a brief period of time, as seen in FIG. 42, in this example three. A beat is provided. To the beat, a “click here” button is clicked a given number of times, in this example five. To successfully complete the task, following the final beat, the pattern of a given number of “X's” is repeated in a three-by-three matrix by the user. When the answer is checked, the original pattern and the selected pattern are displayed as seen in FIG. 43. Again, the “Arrow Point Bridge” themed cognitive exercise places repetitive demands on deficient functions and presents increasing levels of difficulty by “cognitive loading.” For example, in level two a pattern of a larger number of “X's” is displayed in the three-by-three matrix for a brief period of time, in this example four.

Referring to FIGS. 44 and 45, the “Sky Planning” themed cognitive exercise is seen. The “Sky Planning” themed cognitive exercise develops visual sustained attention, auditory selective attention, and flexible attention cognitive attention skills; visual discrimination, visual figure ground, visual sequential processing, and visualization cognitive visual processing skills; ocular-motor, auditory-motor integration, timing-rhythm, and visual-auditory integration cognitive sensory integration skills; auditory discrimination, auditory sequential, and auditory processing speed cognitive auditory processing skills; and auditory sensory short-term memory, auditory intermediate short-term memory, working memory, and auditory sequential memory cognitive memory skills.

In FIG. 44, the curser is placed over a bird which provides a link to the “Sky Planning” themed cognitive exercise. After an instructions page for the “Sky Planning” themed cognitive exercise is seen, in level one a sequence of numbers is heard, in this example three. Then, a page displaying randomly positioned numbers is displayed, as seen in FIG. 45. For each new exercise, the page displaying positioned numbers is randomly reset. To successfully complete the task, the user selects the numbers in the same sequence as heard. In the “Sky Planning” themed cognitive exercise, the user moves to the next level with seven out of 10. Again, the “Sky Planning” themed cognitive exercise places repetitive demands on deficient functions and presents increasing levels of difficulty by “cognitive loading.” For example, in level three a given number of numbers is heard, in this example four. The numbers are found in the order from highest to lowest, not in the order recited.

Referring to FIGS. 46 and 47, the “Bear Shuffle” themed cognitive exercise is seen. The “Bear Shuffle” themed cognitive exercise develops visual sustained attention, visual selective attention, and sustained attention cognitive attention skills; visual sequential processing, visualization, and visual processing speed cognitive visual processing skills; and visual sensory short-term memory, visual intermediate short-term memory, working memory, visual special memory, and visual sequential memory cognitive memory skills.

In FIG. 46, the curser is placed over a bear which provides a link to the “Bear Shuffle” themed cognitive exercise. After an instructions page for the “Bear Shuffle” themed cognitive exercise is seen, in level one a given number of cards are shown face down. The cards are turned up one at a time. Each card is shown before the next card is turned over, as seen in FIG. 47. After the last card has been shown, all the cards are turned face down. To successfully complete the task, the user then moves the cards in numerical order, left to right. For example, if the cards are displayed as 6 9 2, the card of the right is moved In the “Bear Shuffle” themed cognitive exercise, the user moves to the next level with seven out of 10. Again, the “Bear Shuffle” themed cognitive exercise places repetitive demands on deficient functions and presents increasing levels of difficulty by “cognitive loading.” For example, in level four four cards are face down. One at a time the cards are turned up. After the last card has been shown, all the cards are turned face down. Cards change place, and then more cards change place. To successfully complete the task, the user then moves the cards in numerical order, left to right.

Referring to FIGS. 48-51, the “Jumping Jaguar Flash” themed cognitive exercise is seen. The “Jumping Jaguar Flash” themed cognitive exercise develops visual sustained attention and visual selective attention cognitive attention skills; visual discrimination, visual span, visual simultaneous processing, visualization, and visual processing speed cognitive visual processing skills; and visual sensory short-term memory, visual intermediate short-term memory, and visual simultaneous memory cognitive memory skills.

In FIG. 48, the curser is placed over a jaguar which provides a link to the “Jumping Jaguar Flash” themed cognitive exercise. After an instructions page for the “Jumping Jaguar Flash” themed cognitive exercise is seen, in level one three boxes are shown in a row, as seen in FIG. 49. Groups of characters briefly appear in each box. The characters disappear at the same time. To successfully complete the task, the user selects the box that displayed different characters than the others, as seen in FIG. 50. In the “Jumping Jaguar Flash” themed cognitive exercise, the user moves to the next level with seven out of 10. Again, the “Jumping Jaguar Flash” themed cognitive exercise places repetitive demands on deficient functions and presents increasing levels of difficulty by “cognitive loading.” For example, in level two rows of three boxes are presented, with the user selected the box displaying different characters from the other five boxes, as seen in FIG. 51.

Referring to FIGS. 52-55, the “Turtle Recall” themed cognitive exercise is seen. The “Turtle Recall” themed cognitive exercise develops visual sustained attention and visual selective attention cognitive attention skills; ocular-motor cognitive sensory integration skill; and visual sensory short-term memory, visual intermediate short-term memory, and long-term memory cognitive memory skills.

In FIG. 52, the curser is placed over a turtle which provides a link to the “Turtle Recall” themed cognitive exercise. In level one a series of shapes and numbers are briefly displayed. The user commits the shapes and numbers to memory. For example, the number one is display as corresponding to the triangle shape, the number two corresponds to the square shape, and the number three corresponds to the circle. The system then instructs the user to wait at least a given number of hours to complete the next level, in this example 12.

After at least twelve hours, the user can return to the “Turtle Recall” themed cognitive exercise. A series of the shapes is provided, as seen in FIG. 53. To successfully complete the task, the user selects the number that correlates to the shape. Again, the user must wait a given number of hours to complete the next level, in this example 12. Again, the “Turtle Recall” themed cognitive exercise places repetitive demands on deficient functions and presents increasing levels of difficulty by “cognitive loading.” For example, in level two a larger number of shapes and numbers are briefly displayed, as seen in FIG. 54. The user commits the shapes and numbers to memory. The system then instructs the user to wait at least a given number of hours to complete the next level, in this example 12. After at least twelve hours, the user can return to the “Turtle Recall” themed cognitive exercise. A series of the shapes is provided, as seen in FIG. 55. To successfully complete the task, the user selects the number that correlates to the shape.

Referring to FIGS. 56-61, the “Llama Logic” themed cognitive exercise is seen. The “Llama Logic” themed cognitive exercise develops visual-form consistency and visual sequential processing cognitive visual processing skills; and logic, reasoning, problem solving, strategic thinking, visual thinking, and conceptual thinking cognitive thinking skills.

In FIG. 56, the curser is placed over a llama which provides a link to the “Llama Logic” themed cognitive exercise. In level one a series of shapes are displayed in two rows, as seen in FIG. 57. The combination of a shape from the first row and a shape from the second row form a circle. To successfully complete the task, the user selects the shapes that together form a circle. In FIG. 58, the user has successfully matched two of the shapes. Upon matching of all the shapes, the level is completed.

Again, the “Llama Logic” themed cognitive exercise places repetitive demands on deficient functions and presents increasing levels of difficulty by “cognitive loading.” For example, in level three a partially completed puzzle is displayed with the remaining pieces, as seen in FIG. 59. To successfully complete the task, the user selects which of the remaining pieces goes into which position in the partially competed puzzle. For further example, in level sixteen a cube blank is displayed with three of the faces colored, as seen in FIG. 60. To successfully complete the task, the user selects which of the displayed cubes the blank would become, as seen in FIG. 61. Twenty-one levels much be completed to complete the exercise.

Referring to FIGS. 62-66, the “Crocodile Recollection” themed cognitive exercise is seen. The “Crocodile Recollection” themed cognitive exercise develops visual sustained attention, visual selective attention, divided attention, and flexible attention cognitive attention skills; visual discrimination, visual span, visual simultaneous processing, visualization, and visual processing speed cognitive visual processing skills; auditory-motor integration and timing-rhythm cognitive sensory integration skills; and visual sensory short-term memory, visual intermediate short-term memory, working memory, and visual simultaneous memory cognitive memory skills.

In FIG. 62, the curser is placed over a crocodile which provides a link to the “Crocodile Recollection” themed cognitive exercise. After an instructions page for the “Crocodile Recollection” themed cognitive exercise is seen, in level one a given number of numbers are flashed, as seen in FIG. 63, in this example three. A beat is provided. To the beat, a “click here” button is clicked a given number of times, in this example five. To successfully complete the task, the user types the tree numbers in the order presented, as seen in FIG. 64. In the “Crocodile Recollection” themed cognitive exercise, the user moves to the next level with seven out of 10. Again, the “Crocodile Recollection” themed cognitive exercise places repetitive demands on deficient functions and presents increasing levels of difficulty by “cognitive loading.” For example, in level two four upper case letters are flashed, as seen in FIG. 65. A beat is provided. To the beat, a “click here” button is clicked a given number of times, in this example five. To successfully complete the task, the user types the tree numbers in the order presented, as seen in FIG. 66.

Referring to FIGS. 67-70, the “Piranha Pass” themed cognitive exercise is seen. The “Piranha Pass” themed cognitive exercise develops visual sustained attention, visual selective attention, divided attention, and flexible attention cognitive attention skills; directionality, visualization, and visual processing speed cognitive visual processing skills; ocular-motor cognitive sensory integration skill; visual sensory short-term memory, visual intermediate short-term memory, and visual spatial memory cognitive memory skills; and logic, reasoning, planning, problem solving, strategic thinking, visual thinking, and decision speed cognitive thinking skills.

In FIG. 67, the curser is placed over a school of piranhas which provides a link to the “Piranha Pass” themed cognitive exercise. After an instructions page for the “Piranha Pass” themed cognitive exercise is seen, in level one a fish, a swimmer, and a raft are displayed. Distance markers are provided on the top and side of the screen, as seen in FIG. 68, with each distance marker separated by a given number of units, in this example 50. To successfully complete the task, the user plans a path for the swimmer to avoid the piranhas and get to the raft, and enters the directions and distances for the swimmer. An example from level two is seen in FIGS. 69 and 70, in which in FIG. 70 the swimmer is in the midst of completing the instructions. In the “Piranha Pass” themed cognitive exercise, the user moves to the next level with seven out of 10. Again, the “Piranha Pass” themed cognitive exercise places repetitive demands on deficient functions and presents increasing levels of difficulty by “cognitive loading.” For example, in level four the exercise is repeated with a defined time limit, in this example 60 seconds.

Referring to FIGS. 71-73, the “Cave Comparisons” themed cognitive exercise is seen. The “Cave Comparisons” themed cognitive exercise develops visual selective attention, auditory selective attention, and flexible attention cognitive attention skills; visual discrimination, visual form consistency, directionality, visual simultaneous processing, visualization, and visual processing speed cognitive visual processing skills; visual sensory short-term memory, auditory sensory short-term memory, visual intermediate short-term memory, auditory intermediate short-term memory, working memory, visual special memory, and visual simultaneous memory cognitive memory skills; and visual thinking and decision speed cognitive thinking skills.

In FIG. 71, the curser is placed over a cave which provides a link to the “Cave Comparisons” themed cognitive exercise. After an instructions page for the “Cave Comparisons” themed cognitive exercise is seen, in level one a circle, a square, a triangle, and a line are shown, as seen in FIG. 72. A sentence compares the circle, square and triangle. To successfully complete the task, the user selects the choices that correctly complete the sentence. In the “Cave Comparisons” themed cognitive exercise, the user moves to the next level with seven out of 10. Again, the “Cave Comparisons” themed cognitive exercise places repetitive demands on deficient functions and presents increasing levels of difficulty by “cognitive loading.” For example, level four has four grids and a question, as seen in FIG. 73. Each grid is five rows across and five rows down, with some black squares. The top grid is erased. To successfully complete the task, the user selects one grid that answers the question.

Referring to FIGS. 74-78, the “Slithering Symbols” themed cognitive exercise is seen. The “Slithering Symbols” themed cognitive exercise develops visual sustained attention and visual selective attention cognitive attention skills; visual discrimination, visual span, visual simultaneous processing, visual sequential processing, visualization, and visual processing speed cognitive visual processing skills; and visual sensory short-term memory, visual intermediate short-term memory, visual sequential memory, and visual simultaneous memory cognitive memory skills.

In FIG. 74, the curser is placed over a snake which provides a link to the “Slithering Symbols” themed cognitive exercise. After an instructions page for the “Slithering Symbols” themed cognitive exercise is seen, in level one three numbers briefly appear, as seen in FIG. 75 where two of the three numbers have appeared. After the third number appears, the numbers disappear. A beat is provided. To the beat, a “click here” button is clicked a given number of times, in this example five. To successfully complete the task, the user types the three numbers in numerical order, as seen in FIG. 76. To successfully complete the task, the user selects the choices that correctly complete the sentence. In the “Slithering Symbols” themed cognitive exercise, the user moves to the next level with seven out of 10. Again, the “Slithering Symbols” themed cognitive exercise places repetitive demands on deficient functions and presents increasing levels of difficulty by “cognitive loading.” For example, in level three four letters appear one at a time, as seen in FIG. 77. After the forth letter appears, the letters disappear. A beat is provided. To the beat, a “click here” button is clicked a given number of times, in this example five. To successfully complete the task, the user types the four letters in reverse order to what was presented, as seen in FIG. 78.

Referring to FIGS. 79 and 80, the “Rhythm Ribbet” themed cognitive exercise is seen. The “Rhythm Ribbet” themed cognitive exercise develops visual sustained attention, auditory sustained attention, visual selective attention, auditory selective attention, divided attention, and flexible attention cognitive attention skills; visual simultaneous processing, visual sequential processing, and visual processing speed cognitive visual processing skills; visual-motor integration, auditory-motor integration, timing-rhythm, and visual-auditory integration cognitive sensory integration skills; auditory processing cognitive auditory processing skill; and visual sensory short-term memory, auditory sensory short-term memory, visual intermediate short-term memory, auditory intermediate short-term memory, working memory, visual sequential memory, and auditory sequential memory cognitive memory skills.

In FIG. 79, the curser is placed over a frog which provides a link to the “Rhythm Ribbet” themed cognitive exercise. After an instructions page for the “Rhythm Ribbet” themed cognitive exercise is seen, in level one a beat at a given rate is presented, in this example 60 beats per minute. In keeping with the theme, a fly is displayed with each beat. To the beat, a “click here” button is clicked. In keeping with the theme, when a beat is successfully clicked, a tongue of a frog captures the fly. To successfully complete the level, the user clicks the “click here” button a given number of times, in this example 20. Again, the “Rhythm Ribbet” themed cognitive exercise places repetitive demands on deficient functions and presents increasing levels of difficulty by “cognitive loading.” For example, in level five boxes of different colors are presented, as seen in FIG. 80. To successfully complete the level, the user clicks the “click here” button to the beat in a given pattern of the colored boxes, in this example red, red, blue, blue, blue, green. The “Rhythm Ribbet” themed cognitive exercise has seven levels.

Referring to FIGS. 81 and 82, the “Parroting Colors” themed cognitive exercise is seen. The “Parroting Colors” themed cognitive exercise develops visual selective attention, divided attention, and flexible attention cognitive attention skills; visual processing speed cognitive visual processing skill; auditory-motor integration and timing-rhythm cognitive sensory integration skills; and visual sensory short-term memory, and visual spatial memory cognitive memory skills.

In FIG. 81, the curser is placed over a parrot which provides a link to the “Parroting Colors” themed cognitive exercise. After an instructions page for the “Parroting Colors” themed cognitive exercise is seen, in level one two colored squares are displayed, as seen in FIG. 82 where one of the two colors is seen. A “click here” button is clicked a given number of times, in this example five. To successfully complete the task, the user clicks the grid squares in the order the colors were presented. In the “Parroting Colors” themed cognitive exercise, the user moves to the next level with seven out of 10. Again, the “Parroting Colors” themed cognitive exercise places repetitive demands on deficient functions and presents increasing levels of difficulty by “cognitive loading.” For example, in level four four colored squares are shown, then disappear. A beat is provided. To the beat, a “click here” button is clicked a given number of times, in this example five. To successfully complete the task, the user clicks the grid squares in the order the colors were presented.

Referring to FIGS. 83-86, the “Jungle Labyrinth” themed cognitive exercise is seen. The “Jungle Labyrinth” themed cognitive exercise develops visual sustained attention, visual selective attention, and divided attention cognitive attention skills; visualization and visual processing speed cognitive visual processing skills; ocular-motor and visual-motor integration cognitive sensory integration skills; and planning, problem solving, strategic thinking, visual thinking, and decision speed cognitive thinking skills.

In FIG. 83, the curser is placed over a llama on a path which provides a link to the “Jungle Labyrinth” themed cognitive exercise. After an instructions page for the “Jungle Labyrinth” themed cognitive exercise is seen, in level one a maze is displayed, as seen in FIG. 84. To successfully complete the task, the user guides the llama through the maze without going backwards or running into a wall, as seen in FIG. 85. In the “Jungle Labyrinth” themed cognitive exercise, the user moves to the next level after completing three mazes. Again, the “Jungle Labyrinth” themed cognitive exercise places repetitive demands on deficient functions and presents increasing levels of difficulty by “cognitive loading.” For example, in level three a more complex maze is provided that must be completed within a given amount of time, 120 seconds in this example, as seen in FIG. 86.

Referring to FIGS. 87-90, the “Iguana Lookout” themed cognitive exercise is seen. The “Iguana Lookout” themed cognitive exercise develops visual sustained attention, visual selective attention, divided attention, and flexible attention cognitive attention skills; visual discrimination, directionality, visualization, and visual processing speed cognitive visual processing skills; auditory-motor integration and timing-rhythm cognitive sensory integration skills; and ocular-motor and visual-motor integration cognitive sensory integration skills.

In FIG. 87, the curser is placed over an iguana which provides a link to the “Iguana Lookout” themed cognitive exercise. After an instructions page for the “Iguana Lookout” themed cognitive exercise is seen, in level one two rows of arrows are displayed, as seen in FIG. 88. To successfully complete the level, the user selects the button that names the direction of the arrow in a given time period, in this example 42 seconds. Again, the “Iguana Lookout” themed cognitive exercise places repetitive demands on deficient functions and presents increasing levels of difficulty by “cognitive loading.” For example, in level three three rows of arrows are provided with the arrows pointing up, down, left, right, up left, up right, down left ort down right, as seen in FIG. 89. By further example, in level five three rows of arrows are provided. The user must choose the button of the direction the arrow would face is rotated 90 degrees to the fright, as seen in FIG. 90.

Referring to FIGS. 91-95, the “Volcanic Patterns” themed cognitive exercise is seen. The “Volcanic Patterns” themed cognitive exercise develops visual sustained attention and visual selective attention cognitive attention skills; visual discrimination, visual figure ground, visual simultaneous processing, and visual processing speed cognitive visual processing skills; ocular-motor, auditory-motor integration, timing-rhythm, and visual-auditory integration cognitive sensory integration skills; auditory-motor integration and timing-rhythm cognitive sensory integration skills; and visual sensory short-term memory, visual intermediate short-term memory, visual special memory, and visual simultaneous memory cognitive memory skills.

In FIG. 91, the curser is placed over a volcano which provides a link to the “Volcanic Patterns” themed cognitive exercise. After an instructions page for the “Volcanic Patterns” themed cognitive exercise is seen, in level one a pattern of two colors is briefly displayed three across and two down. Four patterns that look like the original pattern are displayed, as seen in FIG. 92. To successfully complete the task, the user selects the matching pattern, as seen in FIG. 93. In the “Volcanic Patterns” themed cognitive exercise, the user moves to the next level after completing seven out of ten. Again, the “Volcanic Patterns” themed cognitive exercise places repetitive demands on deficient functions and presents increasing levels of difficulty by “cognitive loading.” For example, in level four a three color pattern is displayed that is five across and three down, as seen in FIG. 94. Four patterns that look like the original pattern are displayed. To successfully complete the task, the user selects the matching pattern, as seen in FIG. 95.

Referring to FIGS. 96-101, the “Ancient Logic and Reasoning” themed cognitive exercise is seen. The “Ancient Logic and Reasoning” themed cognitive exercise develops visual sequential processing cognitive visual processing skills and logic, reasoning, problem solving, strategic thinking, visual thinking, and conceptual thinking cognitive thinking skills.

In FIG. 96, the curser is placed over a volcano which provides a link to the “Ancient Logic and Reasoning” themed cognitive exercise. The “Ancient Logic and Reasoning” themed cognitive exercise displays a series of levels. For example, in level three, the user must select the shape that does not belong, as seen in FIG. 97. In further example, in level seven the user must choose the letters that are missing in the pattern displayed, as seen in FIGS. 98 and 99. In further example, in level twelve a series of numbers are displayed with the number forming a pattern down or across, as seen in FIGS. 100 and 101. The user must complete 21 levels.

In another embodiment, a clinician, educator or parent or other person can monitor the time spent in the program and the progress made, at a detailed level. Referring to FIG. 102, a separate log-in is provided for the monitor. Once logged-in, the “jungle resort” homepage is seen, seen in FIG. 103. The safari progress link displays the number of players to whom the monitor has access. In the scoring information pop-up of this embodiment, seen in FIG. 104, a drop-down menu displays the players to whom the monitor has access. Once a player is chosen, a summary of the progress of that player is shown as seen in FIG. 105, including for example the total number of levels completed, the total time spent, and the last exercise attempt. In addition, detailed information on each themed cognitive exercise is shown, including for example the level completed for each themed cognitive exercise, the number of attempts for each level, and the time spent per level. Upon completion of the review, the monitor can return to the “jungle resort” homepage by selecting “OK”.

As previously described, each themed cognitive exercise addresses different cognitive skills. Since each individual user has diverse cognitive skill strengths and weaknesses, themed cognitive exercises that seem difficult to one user may seem easy to another and vice versa. The more difficult a user finds a given themed cognitive exercise, the greater the likelihood that user is weak in that particular cognitive skill, and the more benefit he or she is likely to derive from working in that skill area.

The themed cognitive exercises in the cognitive learning video game of the present invention develop various, multiple skills simultaneously, and activities reinforce other themed cognitive exercises. It is not uncommon for a user to reach a point at which they find a themed cognitive exercise difficult, and sometimes even frustrating. The important thing to remember is that time spent doing a challenging exercise is what actually causes the brain to develop. It is not uncommon for a user to leave a themed cognitive exercise because it is “too hard,” successfully complete some levels in a different themed cognitive exercise, and then return to the “hard” themed cognitive exercise and master it.

In problem solving, it is important to understand the large picture as well as the details. In addition, it is important to retain knowledge as well as be able to reorganize that knowledge. A series of details must be remembered, how the details interrelate must be understood, implications from the details must be drawn, and the important details must be screened from the less important details. The series of themed cognitive exercise of the present invention interact with each other in developing and exercising these brain functions.

For example, learning to see the mazes in the Jungle Labyrinth themed cognitive exercise described above develops and exercises the ability to plot a direction through a problem by focusing on the main point. The Jungle Labyrinth themed cognitive exercise develops and exercises the ability to keep track of the main point in light of distracting details. However, it is also important to see the patterns in those details, and the Parroting Colors themed cognitive exercise described above develops and exercises the ability to do that. The Parroting Colors themed cognitive exercise gives you the configurations of detail.

However, it is also important not to get lost in those details. The Piranha Pass themed cognitive exercise described above develops and exercises the ability to be aware of details and direction at the same time. The Piranha Pass themed cognitive exercise forces more precision into what has been learned from the mazes. However, when reading through a long passage or working through a long math problem, it is important not to lose a sense of pace and get stuck on one detail. The Rhythm Ribbet themed cognitive exercise described above develops and exercises the skill to keep on time while keeping on track.

However, it is also important to recall and be able to quickly find information. The Sky Scanning themed cognitive exercise described above develops and exercises the skill needed to recall and find information quickly. And it is important to recollect the configuration of the sought information. The Slithering Symbols themed cognitive exercise described above develops and exercises the ability to keep details straight and in the right order.

However, the context where the information can be found might change. The Tree Tic Tac Toe themed cognitive exercise described above develops and exercises the ability to maintain structure while jumping around. It is also important to see the same patterns in disparate information. The Turtle Recall themed cognitive exercise described above develops and exercises the flexibility to jump from one symbolic system to another. The Web Weaving themed cognitive exercise described above develops and exercises the ability to put information together. And the Whispering Waterfall themed cognitive exercise described above develops and exercises the ability to keep track of how information all fits together.

The cognitive learning video game of the present invention can also help improve the cognitive skills involved in being tested on what one has learned. For example, the Illinois Standards Achievement Test (ISAT) places demands on cognitive skills. Reading a passage for comprehension in the ISAT requires sustained attention—the ability to stay on task for a sustained period of time. If attention is not sustained, parts of the passage may not be processed or understood. Most themed cognitive exercises of the present invention work on sustained attention, particularly including, for example, the Iguana Lookout, Jungle Labyrinth, Rhythm Ribbet, and Slithering Symbols themed cognitive exercises described above.

Questions on the ISAT about a reading passage like for example “Which of these events happened first in the story?” requires visual sequential memory—the ability to recall a sequence of bits of information in the same order as originally received. The Arrow Point Bridge, Bear Shuffle, Rhythm Ribbet, and Slithering Symbols themed cognitive exercises described above work on visual sequential memory.

The question in the Grade 4 sample question of the ISAT, “Sasha's drawings and Yeh Yeh's books were alike because they both—A. were handmade; B. reminded Yeh Yeh of his homeland; C. were treasures to Yeh Yeh; or D. had been made especially for him” is an example of conceptual thinking—the ability to recognize a collection of features that go together to create an idea or category of ideas. The Ancient Logic and Reasoning and Llama Logic themed cognitive exercises described above help develop conceptual thinking skills.

The shape in problem 4 of the Grade 4 sample tests of the ISAT shows a series of 1-cubic-unit cubes stacked together. Only 9 of the cubes have faces that can be seen, but the student must visualize—the ability to recall an image of what has been seen and to mentally manipulate and change aspects of that image in the mind—the cubes that cannot be seen to determine that there are actually 12 of them. Most themed cognitive exercises of the present invention develop visualization skills, particularly including for example the Cave Comparisons, Piranha Pass, Web Weaving, and Whispering Waterfall themed cognitive exercises described above.

A Grade 4 sample problem of the ISAT shows a plate with four different kinds of cookies. There is one, two or three of each kind of cookie. The student must answer the question, “Which kind of cookie would Tim most likely get if he takes one without looking?” is an example of ocular-motor—the ability to use the eyes efficiently to read and gather information from the environment. The Iguana Lookout, Jungle Labyrinth, Piranha Pass, Sky Scanning and Turtle Recall themed cognitive exercises described above address ocular-motor skills.

A sample problem of the ISAT states: “George collected 489 rocks for his science project. Matthew collected 100 fewer than George. How many rocks did Matthew collect?” requires the student to keep both amounts and the boy to which each relates in mind while subtracting 100 from 489 is an example of Working Memory—the ability to hold information in the mind while performing a mental operation on it. The Bear Shuffle, Cave Comparisons, Memory Mountain and Tree Tic-Tac-Toe are among the themed cognitive exercises described above that improve working memory skills.

The Grade 4 question of the ISAT: “The fish, dog and bird are alike in many ways. One way is that they all have—A. legs; B. hair; C. lungs; or D. backbones” is an example of Visual Discrimination—the ability to distinguish differences. The themed cognitive exercises described above that develop visual discrimination include Cave Comparisons, Jumping Jaguar Flash, Sky Scanning and Volcanic Patterns.

In the ISAT, a chart of experimental results and a question that asks the student to draw a conclusion about the results in the chart is an example of reasoning—the ability to form concepts and solve problems using unfamiliar information. The Ancient Logic and Reasoning and Piranha Pass themed cognitive exercises described above are two of the exercises that develop reasoning skills.

The following problem in the Grade 4 question of the ISAT requires thinking logically—the ability to reason and think rationally and analytically “A girl found the skull of an animal. She did not know what the animal was, but she was sure it preyed on other animals for its food. Which clue led to her conclusion? A. The eye sockets faced sideways; B. The skull was much longer than it was wide; C. There was a projecting ridge on the front of the skull; or D. Four of the teeth were long and pointed.” The Llama Logic and Tree Tic-Tac-Toe are two of the themed cognitive exercises described above that develop logic skills.

A cognitive learning video game of the present invention was tested in a controlled study conducted on a group of 34 students in first through seventh grades at the Christian Heritage Academy, 315 Waukegan Road, Northfield, Ill. 60093. These students participated in a study of a cognitive learning video game branded BrainWare Safari by the assignee of the present invention Learning Enhancement Corporation, 200 South Wacker, Suite 3100, Chicago, Ill. 60606. Half of the students used BrainWare Safari cognitive learning video game at home for 11 weeks; the other half of the students served as a control and simply followed their normal routines.

Outcomes were as measured by pre- and post-testing with the Woodcock Johnson III Cognitive Battery and Tests of Achievement, thought to be “the most comprehensive battery of cognitive abilities available to assessment professionals.” Kaufman & Kaufman (Eds), “Essentials of WJ III Abilities Assessment”, New York: John Wiley & Sons (2002). See also Woodcock, McGrew, Mather, and Schrank, “Woodcock-Johnson III”, Riverside Publishing 3d Ed. (2001). Surprisingly, the test group showed an average of four years and two months improvement in cognitive skills while the control group showed a four month average improvement in cognitive skills. Also surprisingly, the test group showed a one year and 11 months average improvement in tests of achievement (reading and math) while the control group showed a one month average improvement in tests of achievement (reading and math).

Thus, the cognitive learning video game of the present invention is a comprehensive cognitive processing program designed to enhance the ability to assimilate and process information more quickly and accurately. The cognitive learning video game of the present invention develops and exercises the foundational skills for critical thinking and problem solving. The cognitive learning video game of the present invention is a comprehensive program that provides the greatest improvement in the shortest period of time in a fun, friendly video gaming format.

It should be understood that various changes and modifications preferred in to the embodiment described herein would be apparent to those skilled in the art. Such changes and modifications can be made without departing from the spirit and scope of the present invention and without diminishing its attendant advantages. It is therefore intended that such changes and modifications be covered by the appended claims.

1. A video game comprising a cognitive development program that utilizes multimedia graphics in an interactive interface whereby the ability of the brain to assimilate and process information is enhanced.

2. The video game of claim 1 further wherein the cognitive development program comprises themed cognitive exercises that tax multiple cognitive skills.

3. The video game of claim 2 further wherein the cognitive skills are selected from the group comprising cognitive attention skills, cognitive visual processing skills, cognitive sensory integration skills, cognitive auditory processing skills, cognitive memory skills, cognitive thinking skills, and combinations thereof.

4. The video game of claim 1 further wherein the cognitive development program comprises sequenced challenges that address a range of strengths and weaknesses to provide appropriate levels of challenge and intensity.

5. The video game of claim 1 further wherein the cognitive development program comprises multiple levels of exercises that become progressively more challenging.

6. The video game of claim 1 further wherein the cognitive development program comprises hierarchical nature human learning, progressing from simpler to more complex neurological processes.

7. The video game of claim 1 further comprising immediate feedback to enable error correction, and faster, more accurate learning.

8. The video game of claim 1 further wherein the cognitive development program develops cognitive skills in concert.

9. The video game of claim 1 further comprising themed multimedia graphics and animated characters.

10. The video game of claim 9 further wherein the animated character stays with the player throughout use of the video game and grows up as the user progresses.

11. The video game of claim 9 further wherein the multimedia graphics are jungle themed and the animated character comprises an animal.

12. The video game of claim 1 further comprising self-pacing, by requiring more time and intensity for exercises that target skills that are weakest for a user.

13. The video game of claim 1 further comprising a monitor of the time spent in the program and the progress made.

14. A video game comprising sequenced challenges that address a range of cognitive strengths and weaknesses to provide appropriate levels of challenge and intensity whereby the ability of the mind to assimilate and process information quickly and accurately is enhanced.

15. The video game of claim 14 further wherein the sequenced challenges comprise themed cognitive exercises that tax multiple cognitive skills.

16. The video game of claim 15 further wherein the cognitive skills are selected from the group comprising cognitive attention skills, cognitive visual processing skills, cognitive sensory integration skills, cognitive auditory processing skills, cognitive memory skills, cognitive thinking skills, and combinations thereof.

17. The video game of claim 14 further wherein the sequenced challenges comprise multiple levels of exercises that become progressively more challenging.

18. The video game of claim 14 further wherein the sequenced challenges comprise hierarchical nature human learning, progressing from simpler to more complex neurological processes.

19. The video game of claim 14 further comprising immediate feedback to enable error correction, and faster, more accurate learning.

20. The video game of claim 14 further wherein the sequenced challenges develop cognitive skills in concert.

21. The video game of claim 14 further comprising themed multimedia graphics and animated characters.

22. The video game of claim 21 further wherein the animated character stays with the player throughout use of the video game and grows up as the user progresses.

23. The video game of claim 21 further wherein the multimedia graphics are jungle themed and the animated character comprises an animal.

24. The video game of claim 14 further comprising self-pacing, by requiring more time and intensity for exercises that target skills that are weakest for a user.

25. The video game of claim 14 further comprising a monitor of the time spent in the sequenced challenges and the progress made.

26. A video game comprising hierarchical nature human learning, progressing from simpler to more complex neurological processes that utilizes multimedia graphics in an interactive interface whereby the ability of the mind to assimilate and process information quickly and accurately is enhanced.

27. The video game of claim 26 further wherein the hierarchical nature human learning comprises themed cognitive exercises that tax multiple cognitive skills.

28. The video game of claim 27 further wherein the cognitive skills are selected from the group comprising cognitive attention skills, cognitive visual processing skills, cognitive sensory integration skills, cognitive auditory processing skills, cognitive memory skills, cognitive thinking skills, and combinations thereof.

29. The video game of claim 26 further wherein the hierarchical nature human learning comprises sequenced challenges that address a range of strengths and weaknesses to provide appropriate levels of challenge and intensity.

30. The video game of claim 26 further wherein the hierarchical nature human learning comprises multiple levels of exercises that become progressively more challenging.

31. The video game of claim 26 further comprising immediate feedback to enable error correction, and faster, more accurate learning.

32. The video game of claim 26 further wherein the hierarchical nature human learning develops cognitive skills in concert.

33. The video game of claim 26 further comprising themed multimedia graphics and animated characters.

34. The video game of claim 33 further wherein the animated character stays with the player throughout use of the video game and grows up as the user progresses.

35. The video game of claim 33 further wherein the multimedia graphics are jungle themed and the animated character comprises an animal.

36. The video game of claim 26 further comprising self-pacing, by requiring more time and intensity for exercises that target skills that are weakest for a user.

37. The video game of claim 26 further comprising a monitor of the time spent in the video game and the progress made.

38. A video game comprising a cognitive development program that presents exercises that tax multiple cognitive skills selected from the group comprising cognitive attention skills, cognitive visual processing skills, cognitive sensory integration skills, cognitive auditory processing skills, cognitive memory skills, cognitive thinking skills, and combinations thereof, whereby exercising the brain enhances the ability to assimilate and process information more quickly and accurately.

39. The video game of claim 38 further wherein the cognitive attention skills are selected from a group comprising visual sustained attention, auditory sustained attention, visual selective attention, auditory selective attention, divided attention, and combinations thereof.

40. The video game of claim 38 further wherein the cognitive visual processing skills are selected from a group comprising visual discrimination, visual figure ground, visual form consistency, directionality, visual span, visual simultaneous processing, visual sequential processing, visualization, visual processing speed, and combinations thereof.

41. The video game of claim 38 further wherein the cognitive sensory integration skills are selected from a group comprising ocular-motor, visual-motor integration, auditory-motor integration, timing-rhythm, visual-auditory integration, and combinations thereof.

42. The video game of claim 38 further wherein the cognitive auditory processing skills are selected from a group comprising auditory discrimination, auditory sequential processing, auditory processing speed, and combinations thereof.

43. The video game of claim 38 further wherein the cognitive memory skills are selected from a group comprising visual sensory short-term memory, auditory sensory short-term memory, visual intermediate short-term memory, auditory intermediate short-term memory, working memory, visual spatial memory, long term memory, visual sequential memory, auditory sequential memory, visual simultaneous memory, and combinations thereof.

44. The video game of claim 38 further wherein the cognitive thinking skills are selected from a group comprising logic, reasoning, planning, problem solving, strategic thinking, visual thinking, conceptual thinking, decision speed, and combinations thereof.

45. A mind exercise comprising exercises directed to reception, processing, and thinking mental processes in the context of multimedia graphics in an interactive interface whereby the ability of the mind to assimilate and process information quickly and accurately is enhanced.

46. The mind exercise of claim 45 further wherein the exercises comprise themed cognitive exercises that tax multiple cognitive skills.

47. The mind exercise of claim 46 further wherein the cognitive skills are selected from the group comprising cognitive attention skills, cognitive visual processing skills, cognitive sensory integration skills, cognitive auditory processing skills, cognitive memory skills, cognitive thinking skills, and combinations thereof.

48. The mind exercise of claim 45 further wherein the exercises comprise sequenced challenges that address a range of strengths and weaknesses to provide appropriate levels of challenge and intensity.

49. The mind exercise of claim 45 further wherein the exercises comprise multiple levels of exercises that become progressively more challenging.

50. The mind exercise of claim 45 further wherein the exercises comprise hierarchical nature human learning, progressing from simpler to more complex neurological processes.

51. The mind exercise of claim 45 further comprising immediate feedback to enable error correction, and faster, more accurate learning.

52. The mind exercise of claim 45 further wherein the exercises develop cognitive skills in concert.

53. The mind exercise of claim 45 further comprising themed multimedia graphics and animated characters.

54. The mind exercise of claim 53 further wherein the animated character stays with the player throughout use of the video game and grows up as the user progresses.

55. The mind exercise of claim 53 further wherein the multimedia graphics are jungle themed and the animated character comprises an animal.

56. The mind exercise of claim 45 further comprising self-pacing, by requiring more time and intensity for exercises that target skills that are weakest for a user.

57. The mind exercise of claim 45 further comprising a monitor of the time spent in the exercises and the progress made.

58. A mind exercise comprising increasing development of neuron branches within the brain by the practice of mental exercises in the context of multimedia graphics in an interactive interface whereby the ability of the mind to assimilate and process information quickly and accurately is enhanced.

59. The mind exercise of claim 58 further wherein the mental exercises comprise themed cognitive exercises that tax multiple cognitive skills.

60. The mind exercise of claim 59 further wherein the cognitive skills are selected from the group comprising cognitive attention skills, cognitive visual processing skills, cognitive sensory integration skills, cognitive auditory processing skills, cognitive memory skills, cognitive thinking skills, and combinations thereof.

61. The mind exercise of claim 58 further wherein the mental exercises comprise sequenced challenges that address a range of strengths and weaknesses to provide appropriate levels of challenge and intensity.

62. The mind exercise of claim 58 further wherein the mental exercises comprise multiple levels of mental exercises that become progressively more challenging.

63. The mind exercise of claim 58 further wherein the mental exercises comprise hierarchical nature human learning, progressing from simpler to more complex neurological processes.

64. The mind exercise of claim 58 further comprising immediate feedback to enable error correction, and faster, more accurate learning.

65. The mind exercise of claim 58 further wherein the mental exercises develop cognitive skills in concert.

66. The mind exercise of claim 58 further comprising themed multimedia graphics and animated characters.

67. The mind exercise of claim 66 further wherein the animated character stays with the player throughout use of the video game and grows up as the user progresses.

68. The mind exercise of claim 66 further wherein the multimedia graphics are jungle themed and the animated character comprises an animal.

69. The mind exercise of claim 58 further comprising self-pacing, by requiring more time and intensity for exercises that target skills that are weakest for a user.

70. The mind exercise of claim 58 further comprising a monitor of the time spent in the mental exercises and the progress made.

71. A mind exercise comprising exercises directed to comparing and sorting information to accomplish non-thinking tasks in the context of multimedia graphics in an interactive interface whereby the ability of the mind to assimilate and process information quickly and accurately is enhanced.

72. The mind exercise of claim 71 further wherein the exercises comprise themed cognitive exercises that tax multiple cognitive skills.

73. The mind exercise of claim 72 further wherein the cognitive skills are selected from the group comprising cognitive attention skills, cognitive visual processing skills, cognitive sensory integration skills, cognitive auditory processing skills, cognitive memory skills, cognitive thinking skills, and combinations thereof.

74. The mind exercise of claim 72 further wherein the exercises comprise sequenced challenges that address a range of strengths and weaknesses to provide appropriate levels of challenge and intensity.

75. The mind exercise of claim 71 further wherein the exercises comprise multiple levels of exercises that become progressively more challenging.

76. The mind exercise of claim 71 further wherein the exercises comprise hierarchical nature human learning, progressing from simpler to more complex neurological processes.

77. The mind exercise of claim 71 further comprising immediate feedback to enable error correction, and faster, more accurate learning.

78. The mind exercise of claim 71 further wherein the exercises develop cognitive skills in concert.

79. The mind exercise of claim 71 further comprising themed multimedia graphics and animated characters.

80. The mind exercise of claim 79 further wherein the animated character stays with the player throughout use of the video game and grows up as the user progresses.

81. The mind exercise of claim 79 further wherein the multimedia graphics are jungle themed and the animated character comprises an animal.

82. The mind exercise of claim 71 further comprising self-pacing, by requiring more time and intensity for exercises that target skills that are weakest for a user.

83. The mind exercise of claim 71 further comprising a monitor of the time spent in the exercises and the progress made.
